(19) United States
(12) Patent Application Publication
(10) Pub. No.: US 2015/0106623 A1
(43) Pub. Date: Apr. 16, 2015

(54) METHODS, SYSTEMS, AND DEVICES FOR HANDLING IMAGE DATA FROM CAPTURED IMAGES

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(21) Appl. No.: 14/055,471

(22) Filed: Oct. 16, 2013

Related U.S. Application Data
(63) Continuation-in-part of application No. 14/051,213, filed on Oct. 10, 2013.

(51) Int. Cl. H04L 29/06

(52) U.S. Cl. CPC H04L 63/0457
USPC 713/171

(57) ABSTRACT

Computationally implemented methods and systems include acquiring an image, wherein said image includes at least one representation of a feature of at least one entity, detecting a presence of a privacy beacon in the acquired image, wherein further image process operation on image data unrelated to detection of the presence of the privacy beacon is avoided prior to encryption of the acquired image data, said privacy beacon associated with the at least one entity, and encrypting the acquired image, through use of a unique device encryption key that is unique to a particular device. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 14/051,213, entitled METHODS, SYSTEMS, AND DEVICES FOR FACILITATING VIABLE DISTRIBUTION OF DATA COLLECTED BY WEARABLE COMPUTATION, naming Pablos Holman, Roderick A. Hyde, Royce A. Levien, Richard T. Lord, Robert W. Lord, and Mark A. Malamud as inventors, filed 10 Oct. 2013 with attorney docket no. 0213-003-060-000000, which is currently co-pending or is an application of which a currently co-pending application is entitled to the benefit of the filing date.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to the capture of images that may include personality rights.

### SUMMARY

Recently, there has been an increased popularity in wearable computers, e.g., computers that are placed in articles of clothing or clothing accessories, e.g., watches, eyeglasses, shoes, jewelry, accessories, shirts, pants, headbands, and the like. As technology allows electronic devices to become smaller and smaller, more and more items may be “smart” items, e.g., may contain a computer.

In addition, image capturing technology has also improved, allowing for high quality digital cameras that can capture pictures, audio, video, or a combination thereof. These digital cameras may be small enough to fit onto wearable computers, e.g., inside of eyeglasses. In some instances, the digital camera may blend into the eyeglasses mold, and may not be immediately recognizable as a camera. Such eyeglasses may be indistinguishable or somewhat distinguishable from standard eyeglasses that do not contain a camera and/or a computer.

Further, the cost of data storage has decreased dramatically, and it is not uncommon for an average person in a developed nation to have access to enough digital storage to store months' and/or years' worth of video and pictures. As the cost of data storage has decreased dramatically, so too has the cost of processors to process that data, meaning that automation may be able to take an entire day's worth of surreptitious recording, and isolate those portions of the recording that captured persons, either specific persons or persons in general.

Accordingly, with technology, it is possible for a person to “wear” a computer, in the form of eyeglasses, watches, shirts, hats, or through a pocket-sized device carried by a person, e.g., a cellular telephone device. This wearable computer may be used to record people, e.g., to capture pictures, audio, video, or a combination thereof a person, without their knowledge. Thus, conversations that a person may assume to be private, may be recorded and widely distributed. Moreover, a person may be surreptitiously recorded while they are in a locker room, in a bathroom, or in a telephone booth. It may be difficult or impossible to tell when a person is being recorded. Further, once proliferation of these wearable computers with digital cameras becomes widespread, people must assume that they are under surveillance 100% of the time that they are not in their house.

Therefore, a need has arisen to provide systems that attempt to limit the capture and distribution of a person's personality rights. The present invention is directed to devices, methods, and systems that attempt to limit the capture and distribution of captured images of persons. Specifically, the present invention is directed to devices, methods, and systems that attempt to limit the capture and distribution of captured images of persons, implemented at a device that carries out the capturing of the image. In some embodiments, this device may be a wearable computer, but in other embodiments, any image capturing device or any device that has an image capturing device incorporated into its functionality may implement the devices, methods, and systems described herein.

The instant application is directed to devices, methods, and systems that have a capability to capture images, and in which the capture of those images may include capturing images of a person, persons, or portion(s) of a person for which a privacy beacon may be associated. The privacy beacon may be optical, digital, or other form (e.g., radio, electromagnetic, biomechanic, quantum-state, and the like), and may be detected through digital or optical operations, as discussed herein. The instant application describes devices, methods and systems that may interface with other parts of a larger system, which may be described in detail in this or other applications.

In one or more various aspects, a method includes but is not limited to acquiring an image, wherein said image includes at least one representation of a feature of at least one entity, detecting a presence of a privacy beacon in the acquired image, wherein further image process operation on image data unrelated to detection of the presence of the privacy beacon is avoided prior to encryption of the acquired image data, said privacy beacon associated with the at least one entity, encrypting the acquired image, through use of a unique device encryption key that is unique to a particular device, and facilitating transmission of the encrypted image and privacy beacon data associated with the privacy beacon to a location configured to perform one or more processes on one or more of the encrypted image and the privacy beacon data. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for carrying out the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for acquiring an image, wherein said image includes at least one representation of a feature of at least one entity, means for detecting a presence of a privacy beacon in the acquired image, wherein further image process operation on image data unrelated to detection of the presence of the privacy beacon is avoided prior to encryption of the acquired image data, said privacy beacon associated with the at least one entity, means for encrypting the acquired image, through use of a unique device encryption key that is unique to a particular device, and means for facilitating transmission of the encrypted image and privacy beacon data associated with the privacy beacon to a location configured to perform one or more processes on one or more of the encrypted image and the privacy beacon data. In addition to the foregoing, other system aspects are described in the claims, drawings, and text forming a part of the disclosure set forth herein.

In one or more various aspects, a system includes, but is not limited to, circuitry for acquiring an image, wherein said image includes at least one representation of a feature of at least one entity, circuitry for detecting a presence of a privacy beacon in the acquired image, wherein further image process operation on image data unrelated to detection of the presence of the privacy beacon is avoided prior to encryption of the acquired image data, said privacy beacon associated with the at least one entity, circuitry for encrypting the acquired image, through use of a unique device encryption key that is unique to a particular device, and facilitating transmission of the encrypted image and privacy beacon data associated with the privacy beacon to a location configured to perform one or more processes on one or more of the encrypted image and the privacy beacon data. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for acquiring an image, wherein said image includes at least one representation of a feature of at least one entity, one or more instructions for detecting a presence of a privacy beacon in the acquired image, wherein further image process operation on image data unrelated to detection of the presence of the privacy beacon is avoided prior to encryption of the acquired image data, said privacy beacon associated with the at least one entity, one or more instructions for encrypting the acquired image, through use of a unique device encryption key that is unique to a particular device, and one or more instructions for facilitating transmission of the encrypted image and privacy beacon data associated with the privacy beacon to a location configured to perform one or more processes on one or more of the encrypted image and the privacy beacon data. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for acquiring an image, wherein said image includes at least one representation of a feature of at least one entity, one or more interchained physical machines ordered for detecting a presence of a privacy beacon in the acquired image, wherein further image process operation on image data unrelated to detection of the presence of the privacy beacon is avoided prior to encryption of the acquired image data, said privacy beacon associated with the at least one entity, one or more interchained physical machines ordered for encrypting the acquired image, through use of a unique device encryption key that is unique to a particular device, and one or more interchained physical machines ordered for facilitating transmission of the encrypted image and privacy beacon data associated with the privacy beacon to a location configured to perform one or more processes on one or more of the encrypted image and the privacy beacon data.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1-A through 1-T, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1-A through 1-T are stitched together in the manner shown in FIG. 1-P, which is reproduced below in table format.

TABLE 1
Table showing alignment of enclosed drawings to form partial schematic of one
or more environments.

| | | | | |
|---|---|---|---|---|
| (1, 1) - FIG. 1-A | (1, 2) - FIG. 1-B | (1, 3) - FIG. 1-C | (1, 4) - FIG. 1-D | (1, 5) - FIG. 1-E |
| (2, 1) - FIG. 1-F | (2, 2) - FIG. 1-G | (2, 3) - FIG. 1-H | (2, 4) - FIG. 1-I | (2, 5) - FIG. 1-J |
| (3, 1) - FIG. 1-K | (3, 2) - FIG. 1-L | (3, 3) - FIG. 1-M | (3, 4) - FIG. 1-N | (3, 5) - FIG. 1-O |
| (4, 1) - FIG. 1-P | (4, 2) - FIG. 1-Q | (4, 3) - FIG. 1-R | (4, 4) - FIG. 1-S | (4, 5) - FIG. 1-T |

FIG. 1-A, when placed at position (1,1), forms at least a portion of a partially schematic diagram of an environment(s) and/or an implementation(s) of technologies described herein.

FIG. 1-B, when placed at position (1,2), forms at least a portion of a partially schematic diagram of an environment(s) and/or an implementation(s) of technologies described herein.

FIG. 1-C, when placed at position (1,3), forms at least a portion of a partially schematic diagram of an environment(s) and/or an implementation(s) of technologies described herein.

FIG. 1-D, when placed at position (1,4), forms at least a portion of a partially schematic diagram of an environment(s) and/or an implementation(s) of technologies described herein.

FIG. 1-E, when placed at position (1,5), forms at least a portion of a partially schematic diagram of an environment(s) and/or an implementation(s) of technologies described herein.

FIG. 1-F, when placed at position (2,1), forms at least a portion of a partially schematic diagram of an environment(s) and/or an implementation(s) of technologies described herein.

FIG. 1-G, when placed at position (2,2), forms at least a portion of a partially schematic diagram of an environment(s) and/or an implementation(s) of technologies described herein.

FIG. 1-H, when placed at position (2,3), forms at least a portion of a partially schematic diagram of an environment(s) and/or an implementation(s) of technologies described herein.

FIG. 1-I, when placed at position (2,4), forms at least a portion of a partially schematic diagram of an environment(s) and/or an implementation(s) of technologies described herein.

FIG. 1-J, when placed at position (2,5), forms at least a portion of a partially schematic diagram of an environment(s) and/or an implementation(s) of technologies described herein.

FIG. 1-K, when placed at position (3,1), forms at least a portion of a partially schematic diagram of an environment(s) and/or an implementation(s) of technologies described herein.

FIG. 1-L, when placed at position (3,2), forms at least a portion of a partially schematic diagram of an environment(s) and/or an implementation(s) of technologies described herein.

FIG. 1-M, when placed at position (3,3), forms at least a portion of a partially schematic diagram of an environment(s) and/or an implementation(s) of technologies described herein.

FIG. 1-N, when placed at position (3,4), forms at least a portion of a partially schematic diagram of an environment(s) and/or an implementation(s) of technologies described herein.

FIG. 1-O, when placed at position (3,5), forms at least a portion of a partially schematic diagram of an environment(s) and/or an implementation(s) of technologies described herein.

FIG. 1-P, when placed at position (4,1), forms at least a portion of a partially schematic diagram of an environment(s) and/or an implementation(s) of technologies described herein.

FIG. 1-Q, when placed at position (4,2), forms at least a portion of a partially schematic diagram of an environment(s) and/or an implementation(s) of technologies described herein.

FIG. 1-R, when placed at position (4,3), forms at least a portion of a partially schematic diagram of an environment(s) and/or an implementation(s) of technologies described herein.

FIG. 1-S, when placed at position (4,4), forms at least a portion of a partially schematic diagram of an environment(s) and/or an implementation(s) of technologies described herein.

FIG. 1-T, when placed at position (4,5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of a computing device, e.g., an image capturing device 220 operating in an exemplary environment 200, according to one or more embodiments.

FIG. 3 shows a high-level block diagram of an exemplary image capturing device 300, according to one or more embodiments.

FIG. 4 shows a high-level block diagram of an exemplary image capturing device 400, according to one or more embodiments.

FIG. 5 shows a high-level block diagram of an exemplary image capturing device 500, according to one or more embodiments.

FIG. 6 shows a high-level block diagram of an exemplary image capturing device 600, according to one or more embodiments.

FIG. 7 shows a high-level block diagram of an exemplary image capturing device 700, according to one or more embodiments.

FIG. 8, including FIGS. 8A-8B, shows a particular perspective of an image that includes at least one representation of a feature of at least one entity obtaining module 252 of processing module 250 of computing device 220 of FIG. 2B, according to an embodiment.

FIG. 9, including FIGS. 9A-9G, shows a particular perspective of a privacy beacon associated with the at least one entity within the obtained image detecting module that avoids further image process operation on obtained image data prior to encryption of the acquired image data 254 of processing module 250 of computing device 220 of FIG. 2B, according to an embodiment.

FIG. 10, including FIGS. 10A-10C, shows a particular perspective of an acquired image encrypting through use of a unique device encryption key associated with a device that captured the acquired image module 256 of processing module 250 of computing device 220 of FIG. 2B, according to an embodiment.

FIG. 11, including FIGS. 11A-11C, shows a particular perspective of a transmission of the encrypted image and privacy beacon data associated with the privacy beacon to a location configured to perform one or more processes on one or more of the encrypted image and the privacy beacon data facilitating module 258 of processing module 250 of computing device 220 of FIG. 2B, according to an embodiment.

FIG. 12 is a high-level logic flowchart of a process, e.g., operational flow 1200, according to an embodiment.

FIG. 13A is a high-level logic flow chart of a process depicting alternate implementations of an acquiring an image operation 1202, according to one or more embodiments.

FIG. 13B is a high-level logic flow chart of a process depicting alternate implementations of an acquiring an image operation 1202, according to one or more embodiments.

FIG. 14A is a high-level logic flow chart of a process depicting alternate implementations of a detecting a presence of a privacy beacon in the acquired image operation 1204, according to one or more embodiments.

FIG. 14B is a high-level logic flow chart of a process depicting alternate implementations of a detecting a presence of a privacy beacon in the acquired image operation 1204, according to one or more embodiments.

FIG. 14C is a high-level logic flow chart of a process depicting alternate implementations of a detecting a presence of a privacy beacon in the acquired image operation 1204, according to one or more embodiments.

FIG. 14D is a high-level logic flow chart of a process depicting alternate implementations of a detecting a presence of a privacy beacon in the acquired image operation 1204, according to one or more embodiments.

FIG. 14E is a high-level logic flow chart of a process depicting alternate implementations of a detecting a presence of a privacy beacon in the acquired image operation 1204, according to one or more embodiments.

FIG. 14F is a high-level logic flow chart of a process depicting alternate implementations of a detecting a presence of a privacy beacon in the acquired image operation 1204, according to one or more embodiments.

FIG. 14G is a high-level logic flow chart of a process depicting alternate implementations of a detecting a presence of a privacy beacon in the acquired image operation 1204, according to one or more embodiments.

FIG. 15A is a high-level logic flow chart of a process depicting alternate implementations of a detecting a presence of an encrypting the acquired image operation 1206, according to one or more embodiments.

FIG. 15B is a high-level logic flow chart of a process depicting alternate implementations of a detecting a presence of an encrypting the acquired image operation 1206, according to one or more embodiments.

FIG. 15C is a high-level logic flow chart of a process depicting alternate implementations of a detecting a presence of an encrypting the acquired image operation 1206, according to one or more embodiments.

FIG. 16A is a high-level logic flow chart of a process depicting alternate implementations of a facilitating transmission of the encrypted image and privacy beacon data 1 operation 1208, according to one or more embodiments.

FIG. 16B is a high-level logic flow chart of a process depicting alternate implementations of a facilitating transmission of the encrypted image and privacy beacon data 1 operation 1208, according to one or more embodiments.

FIG. 16C is a high-level logic flow chart of a process depicting alternate implementations of a facilitating transmission of the encrypted image and privacy beacon data 1 operation 1208, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for acquiring an image, wherein said image includes at least one representation of a feature of at least one entity, detecting a presence of a privacy beacon in the acquired image, wherein further image process operation on image data unrelated to detection of the presence of the privacy beacon is avoided prior to encryption of the acquired image data, said privacy beacon associated with the at least one entity, encrypting the acquired image, through use of a unique device encryption key that is unique to a particular device, and facilitating transmission of the encrypted image and privacy beacon data associated with the privacy beacon to a location configured to perform one or more processes on one or more of the encrypted image and the privacy beacon data.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software (e.g., a high-level computer program serving as a hardware specification)).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language should not be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

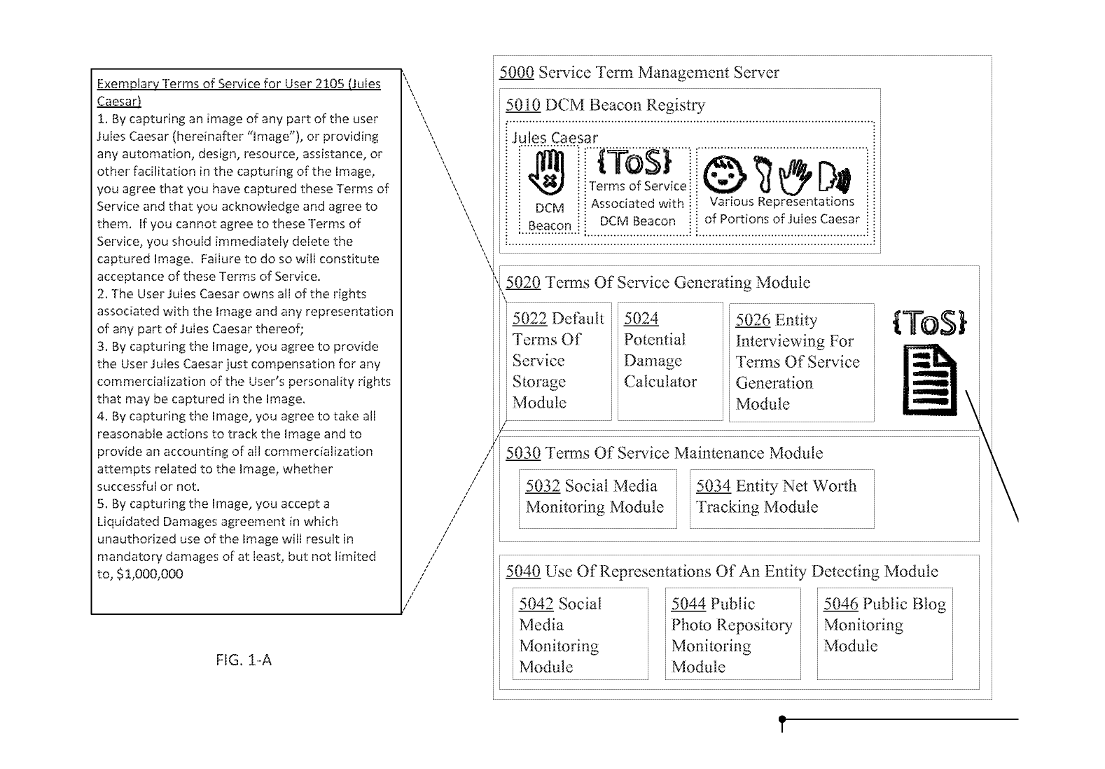

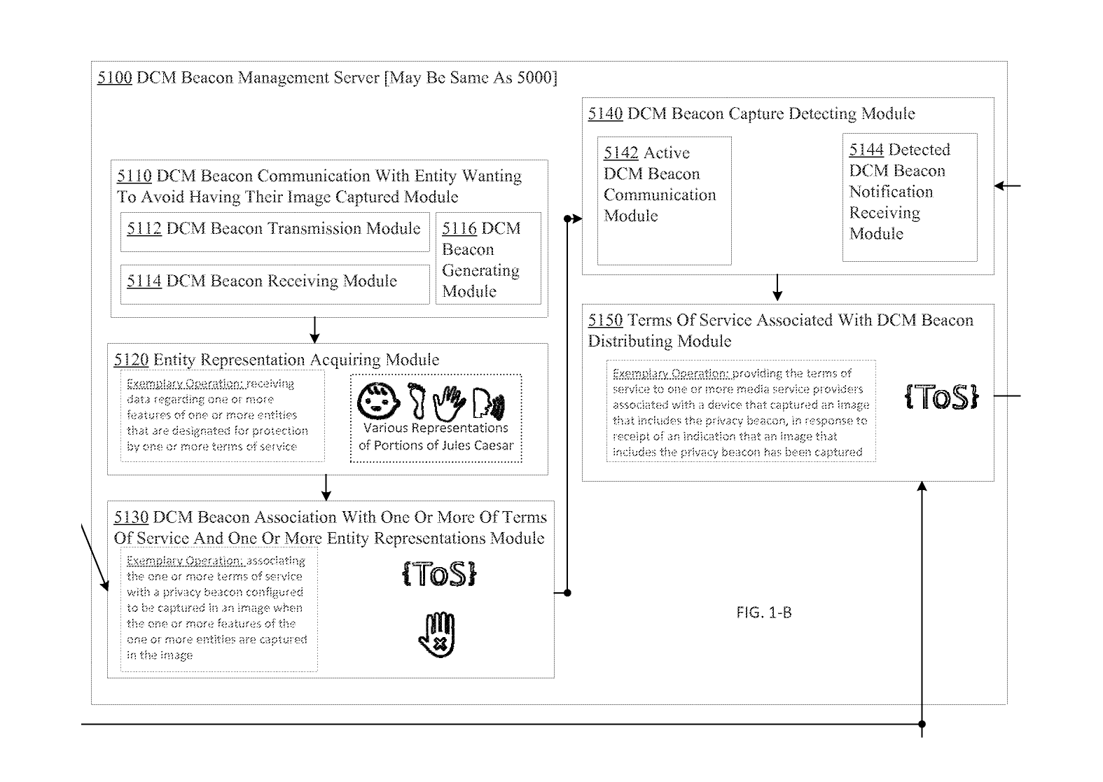

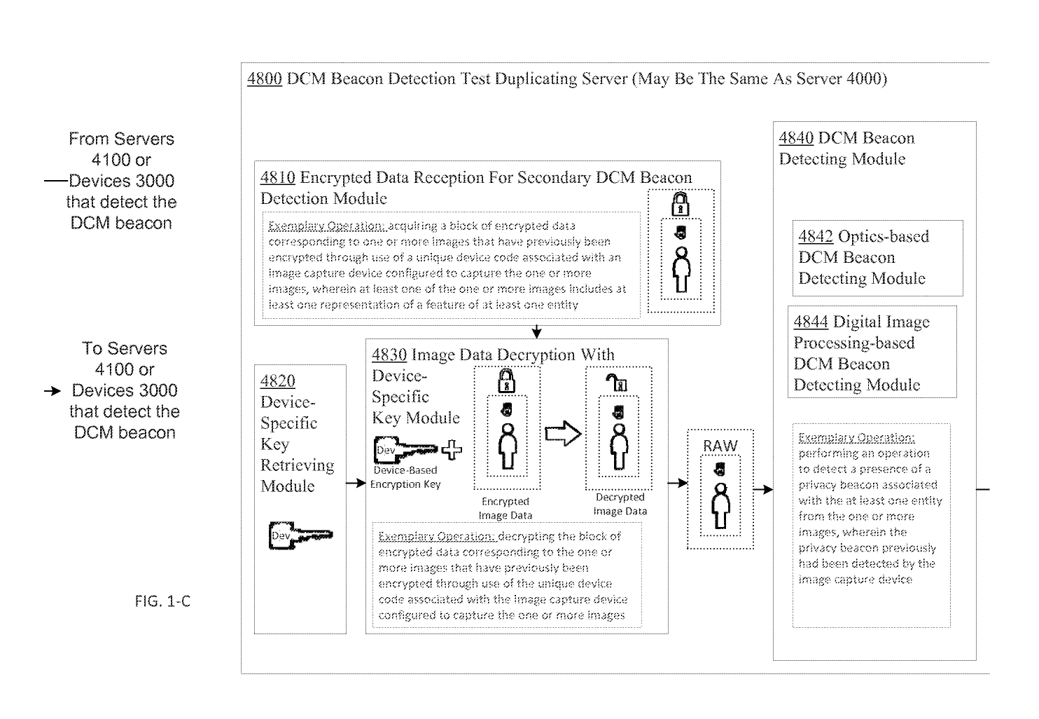

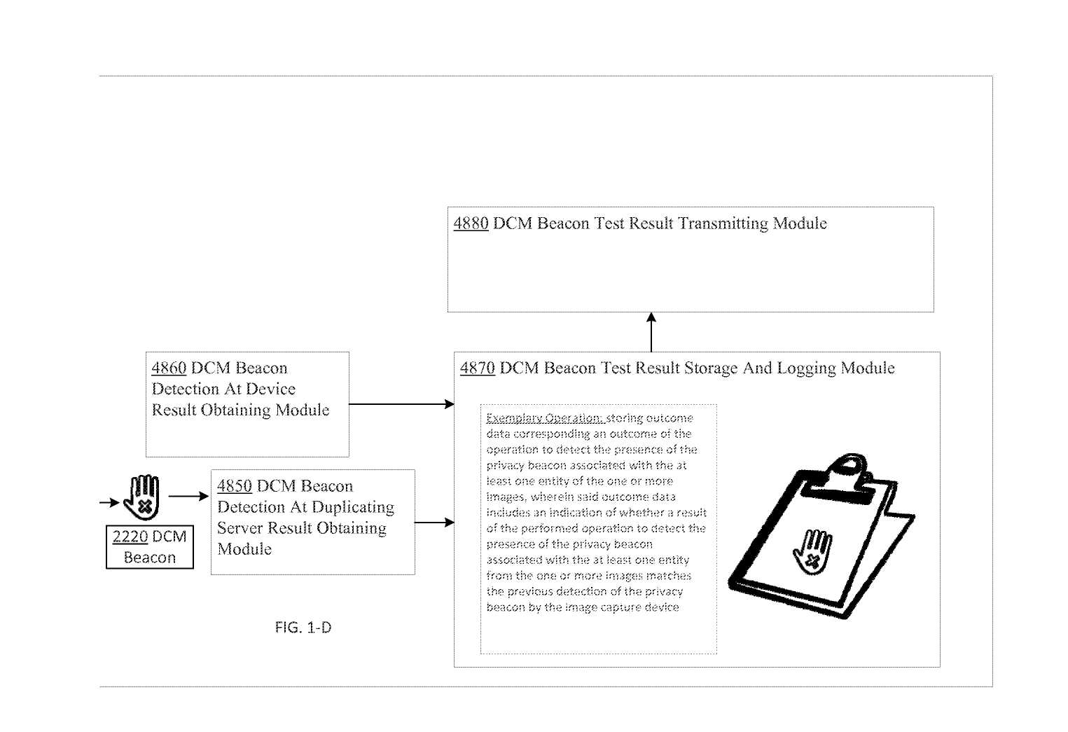

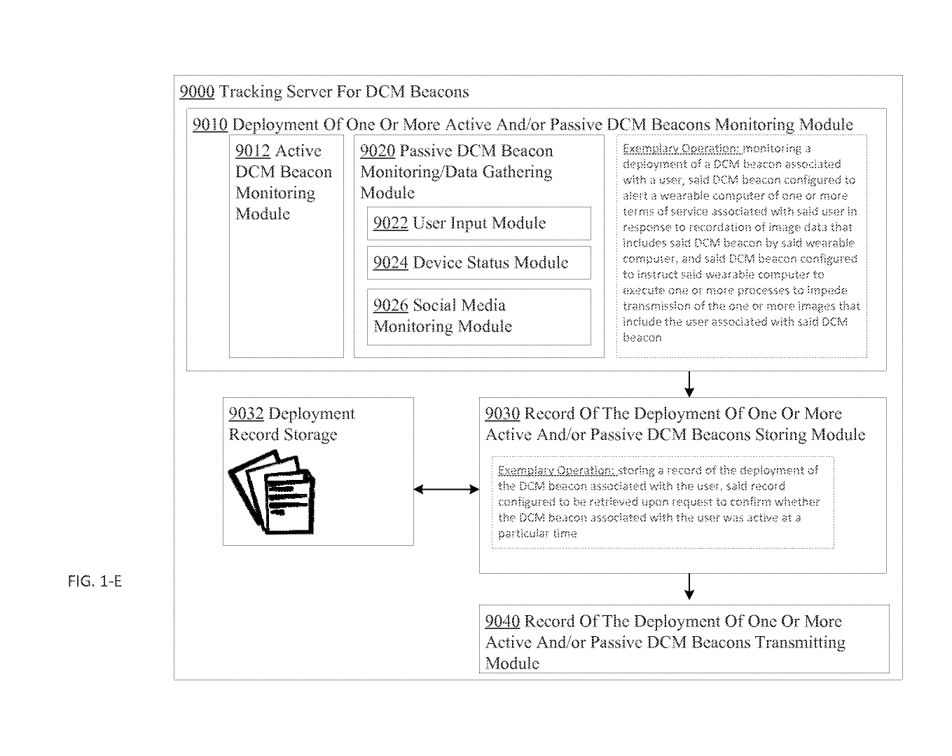

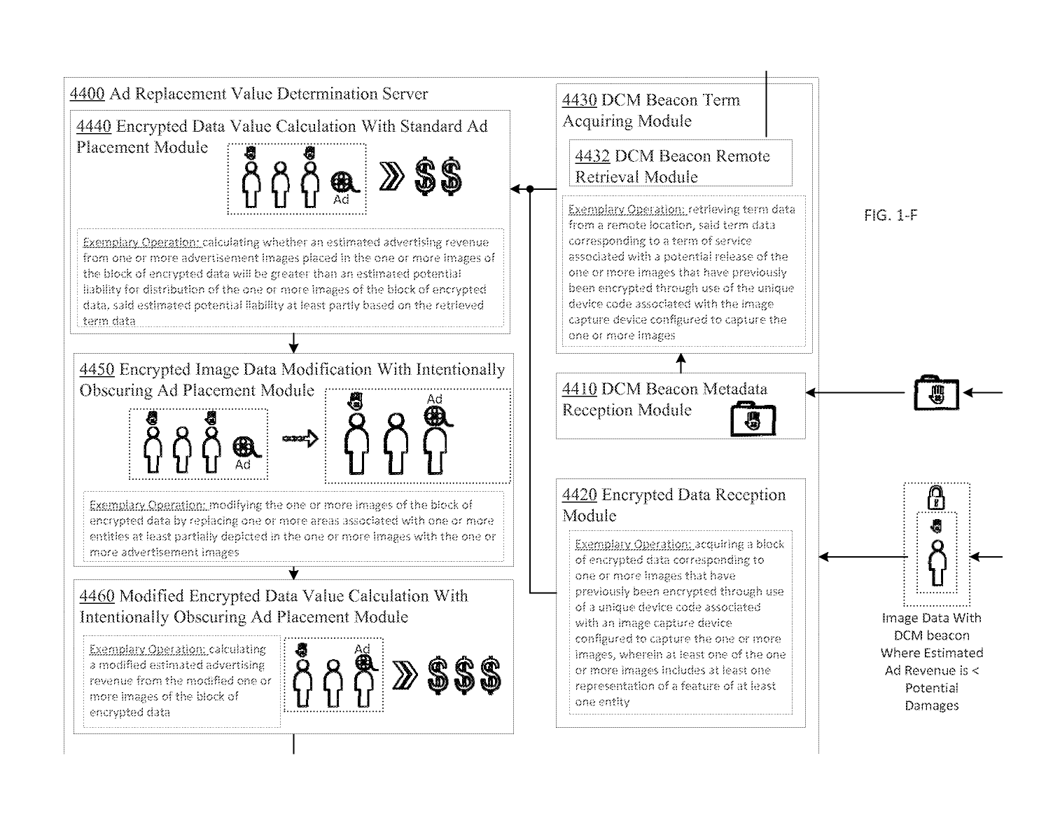

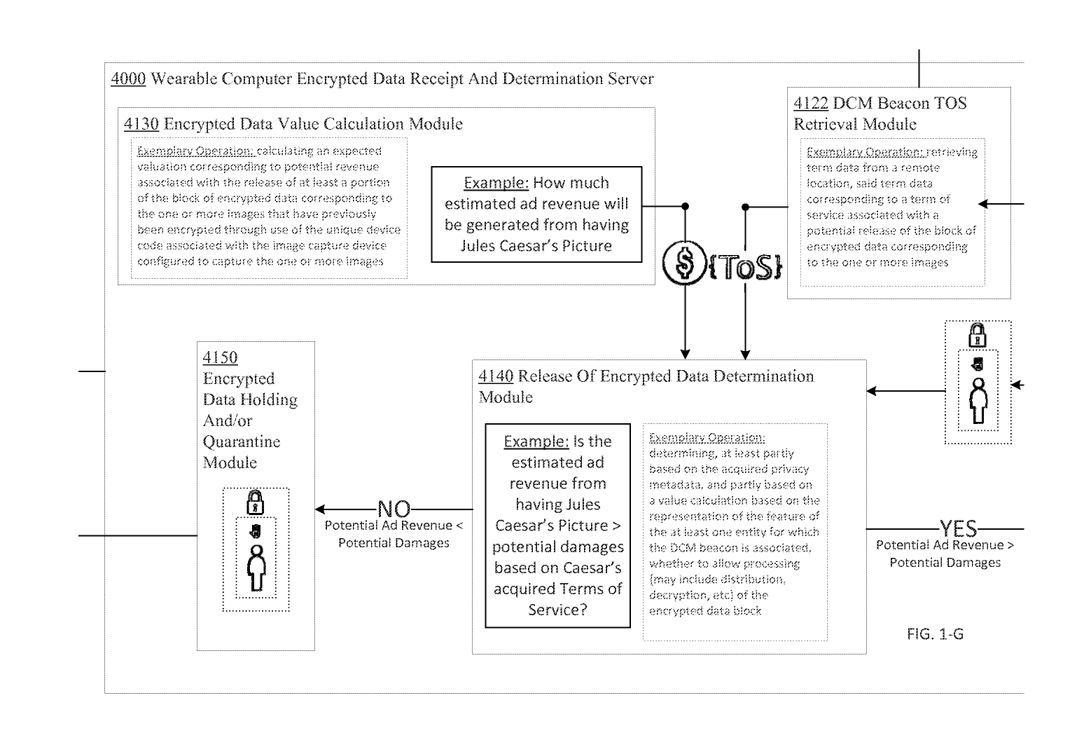

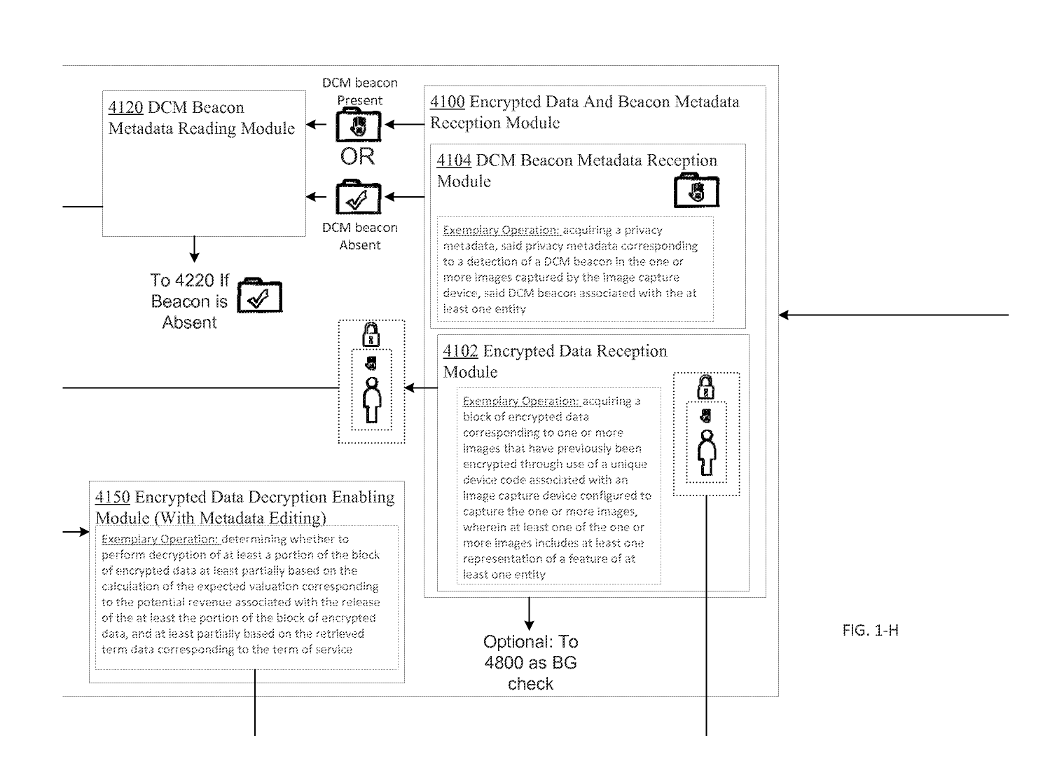

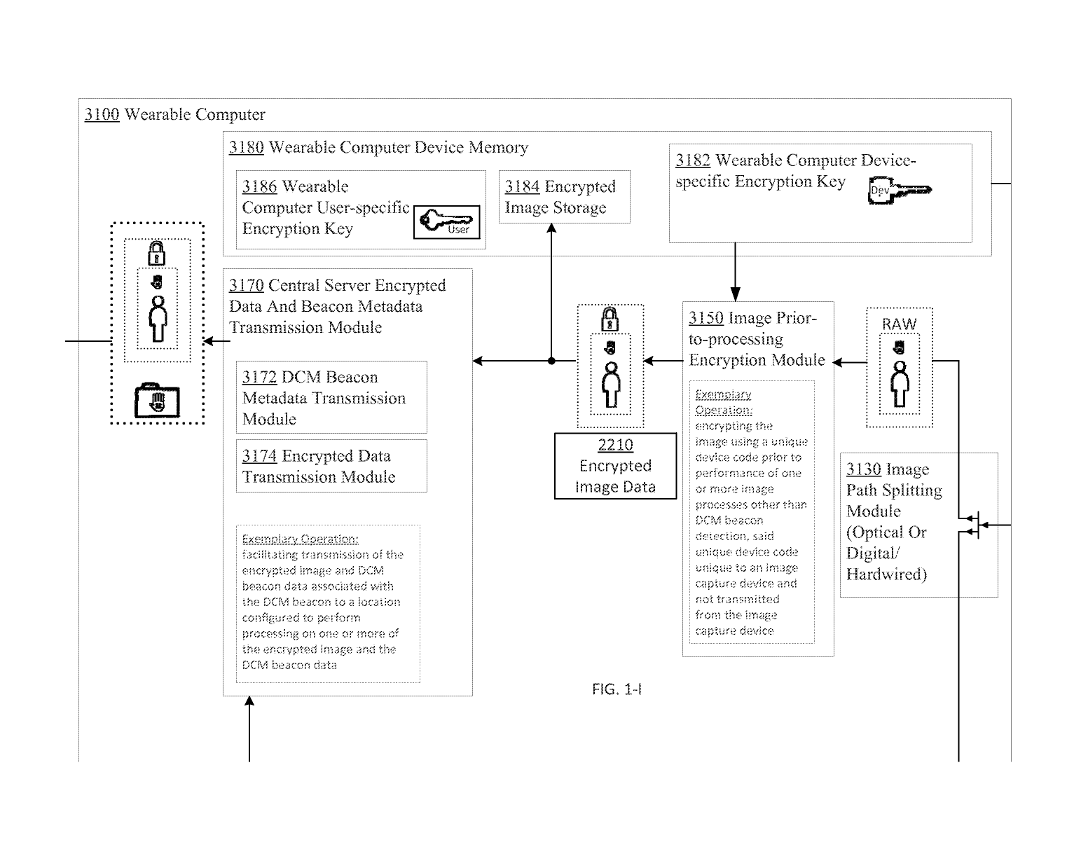

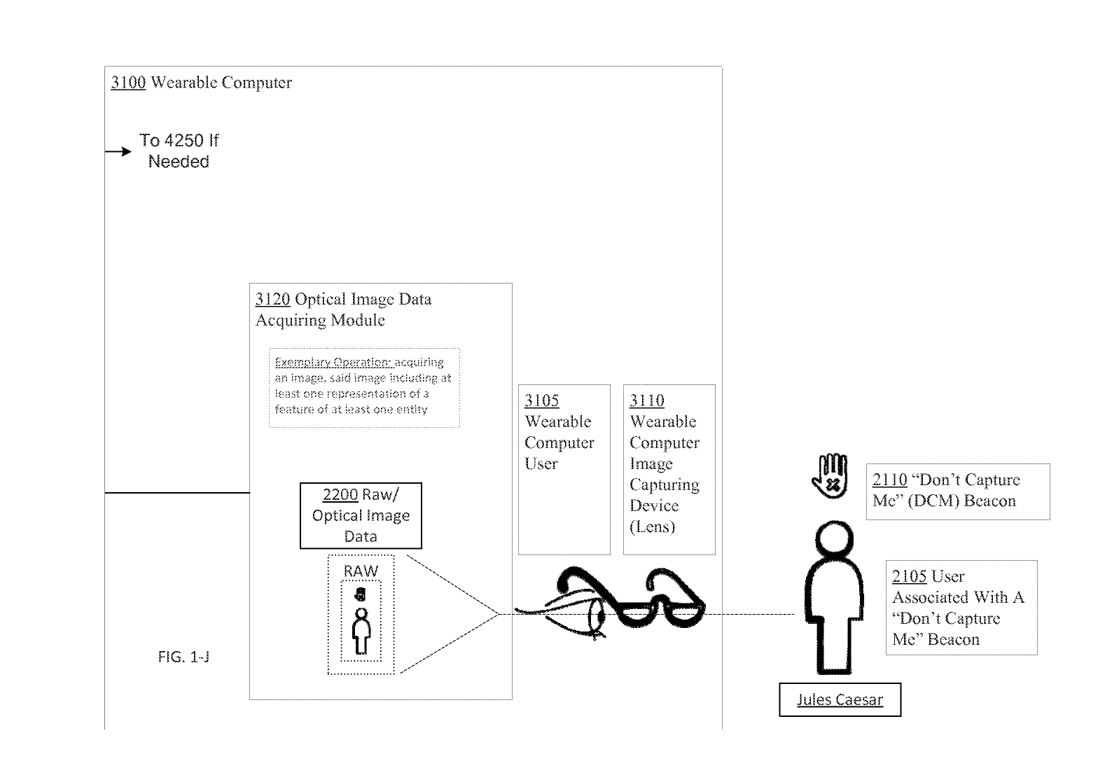

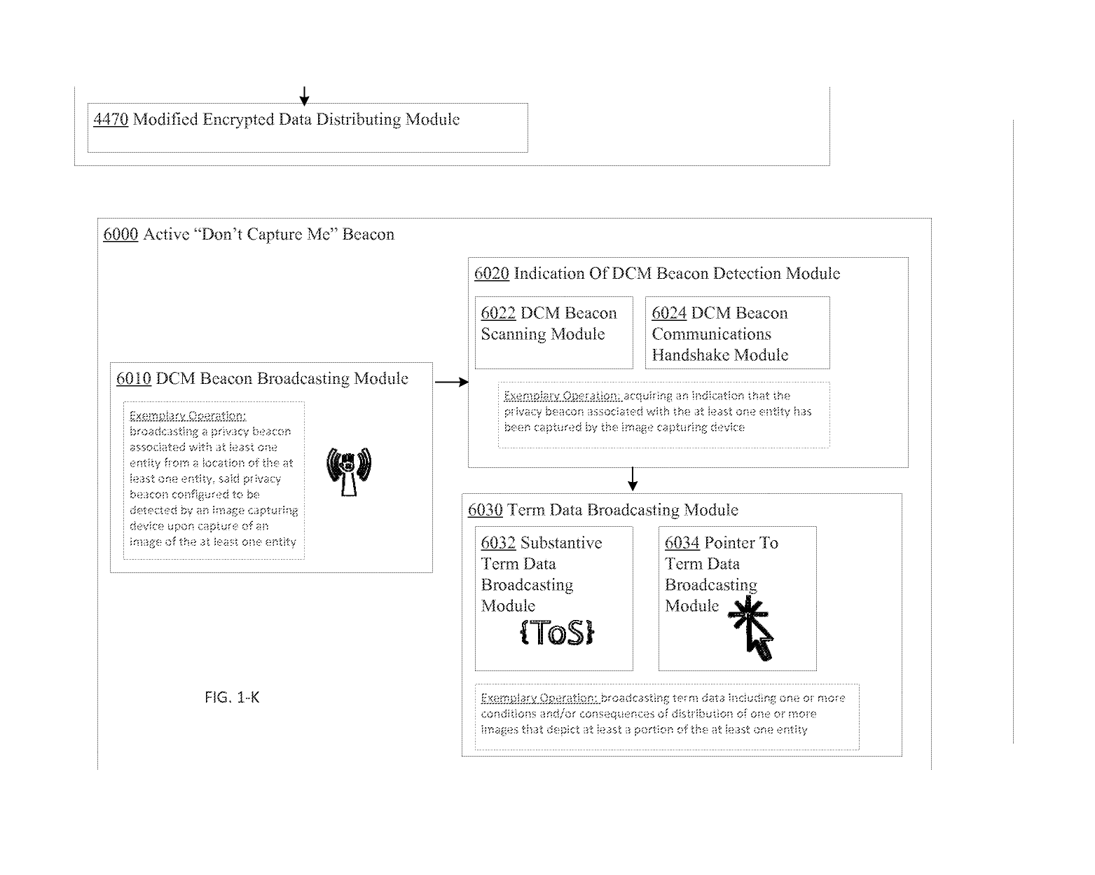

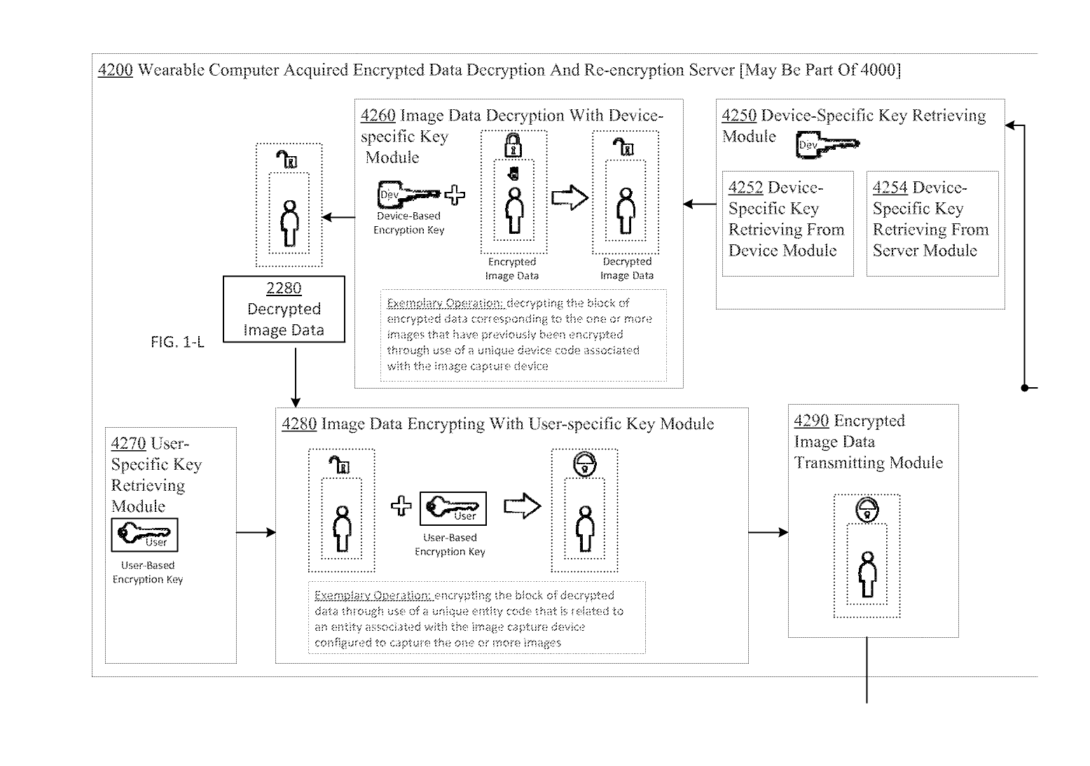

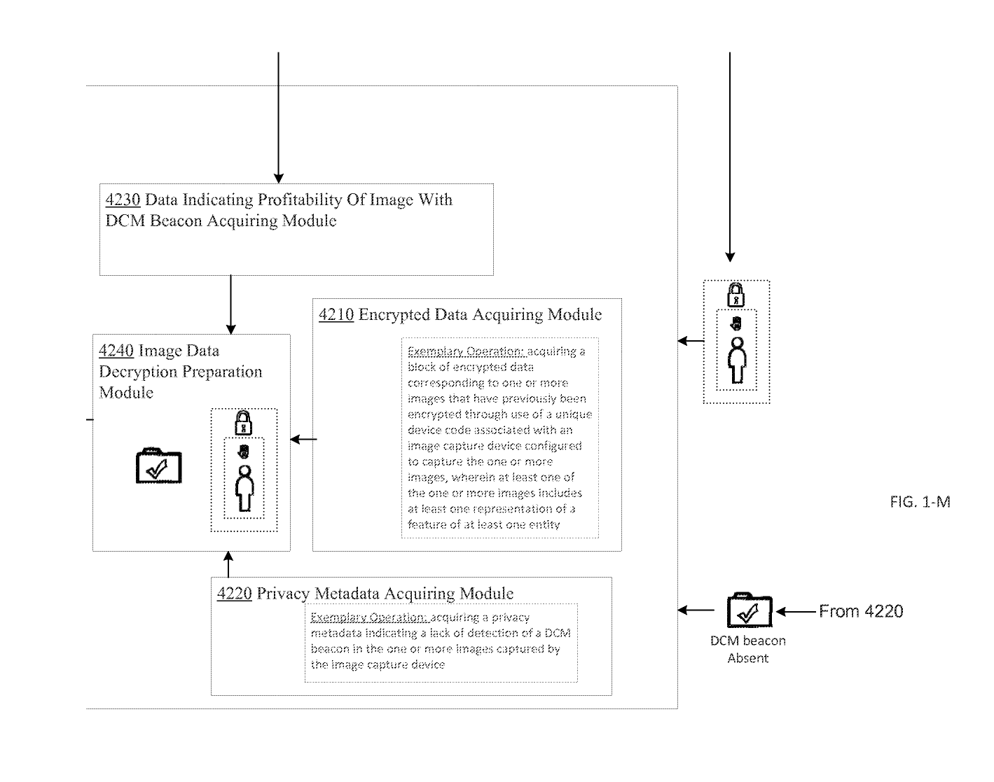

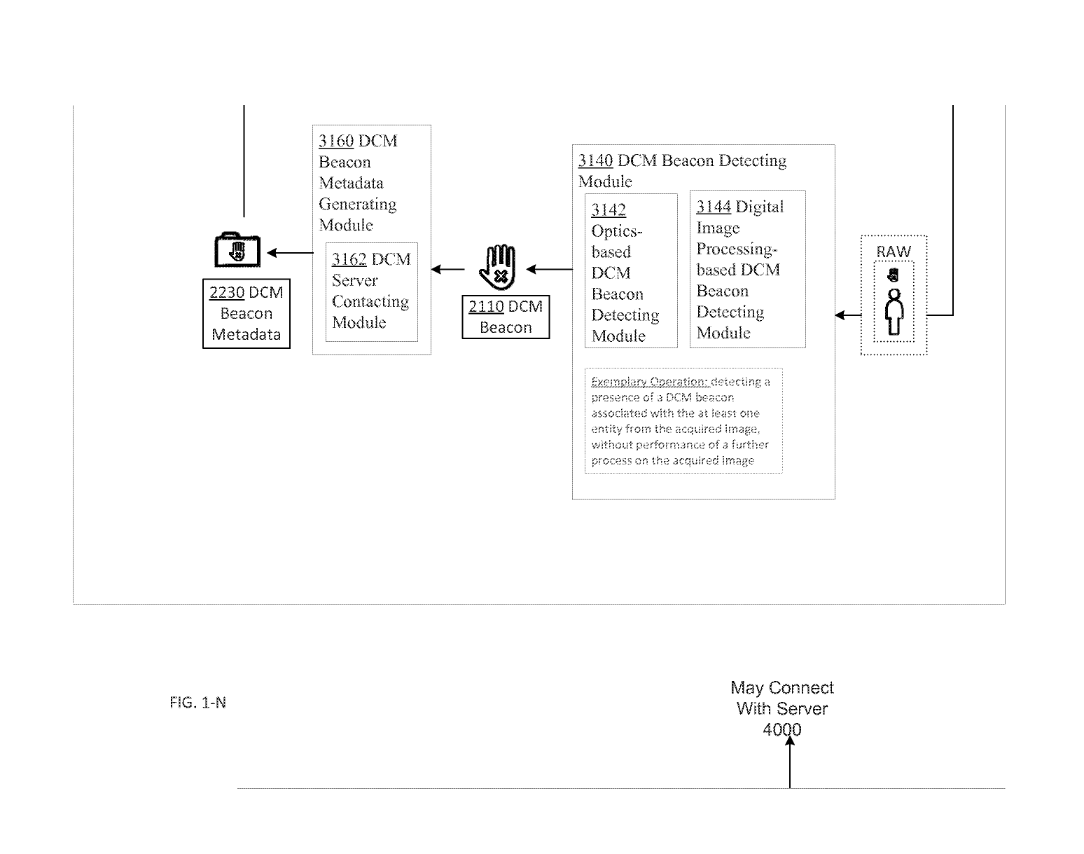

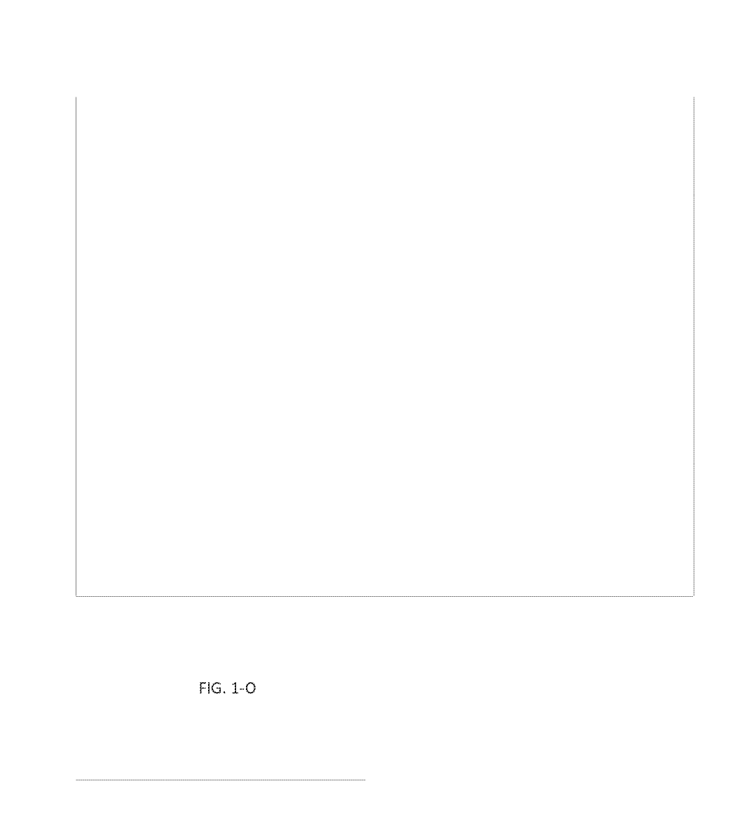

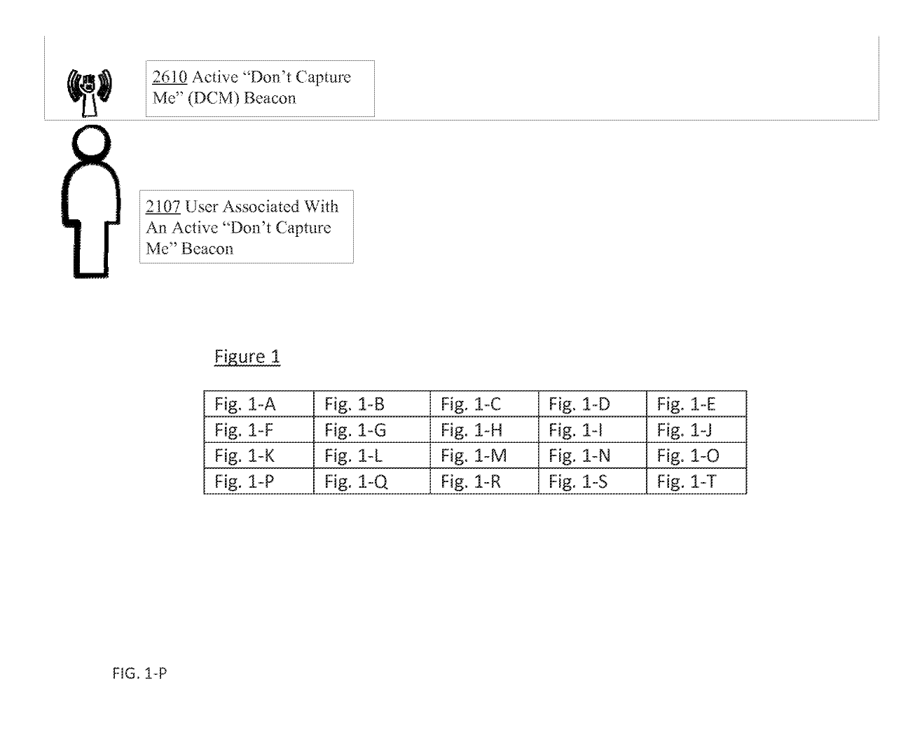

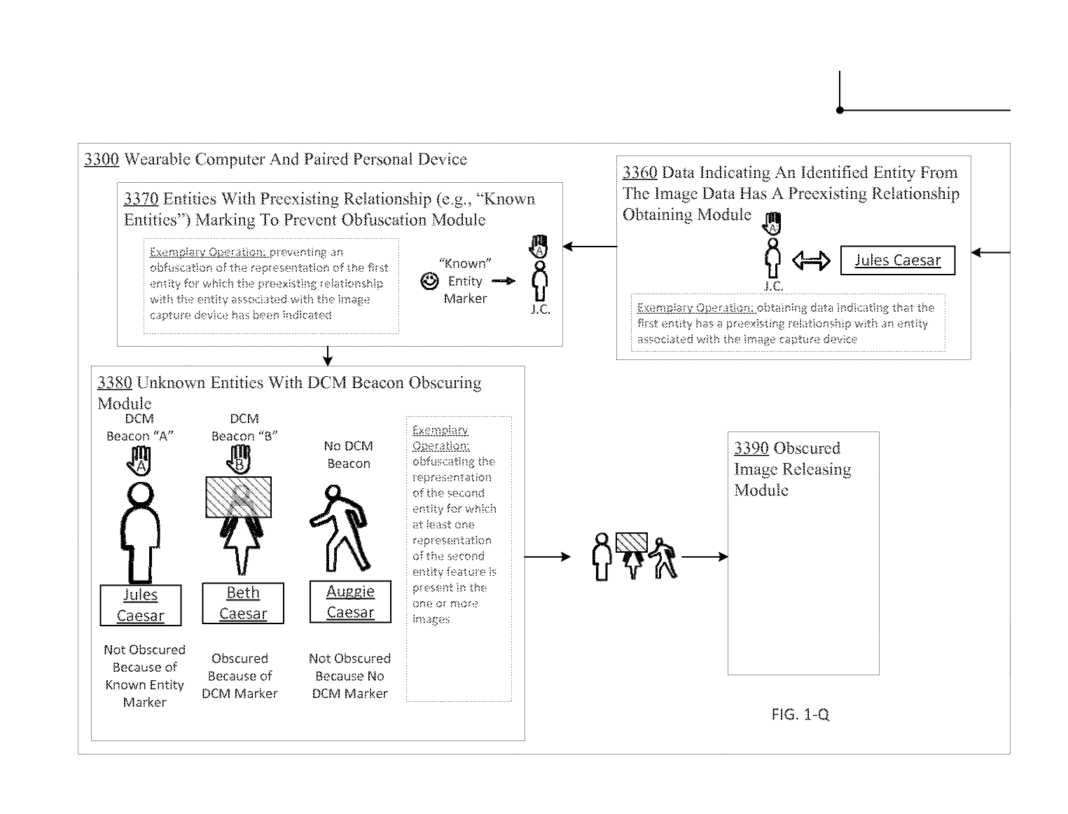

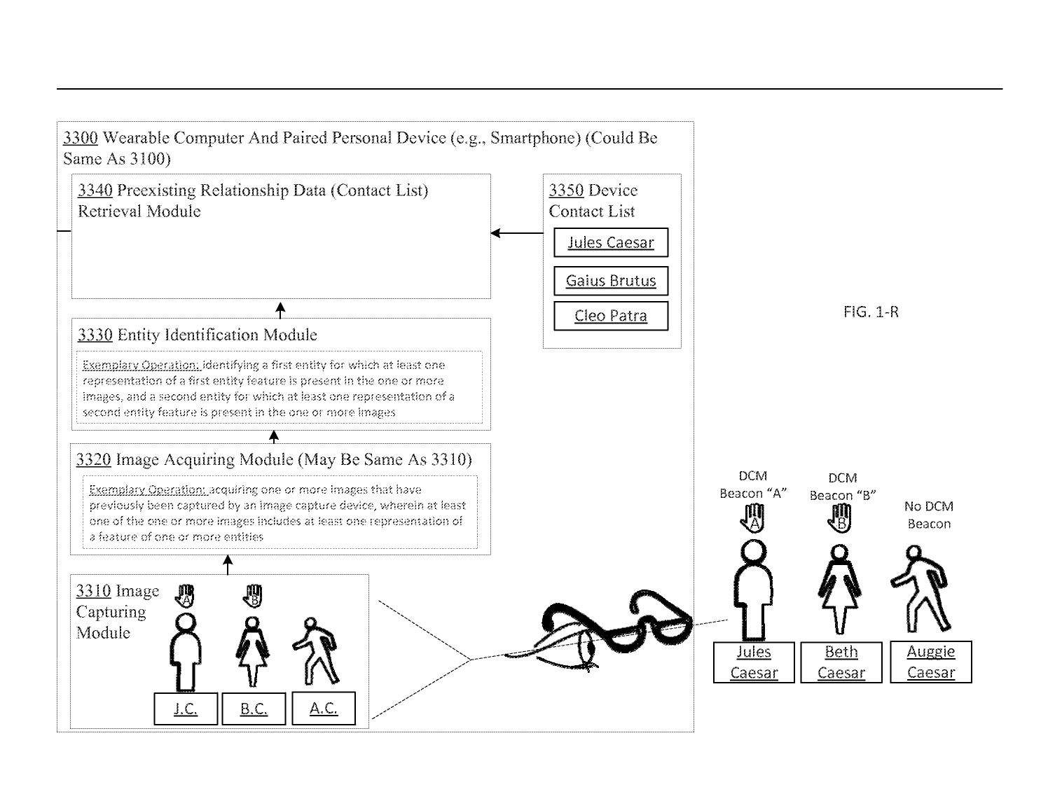

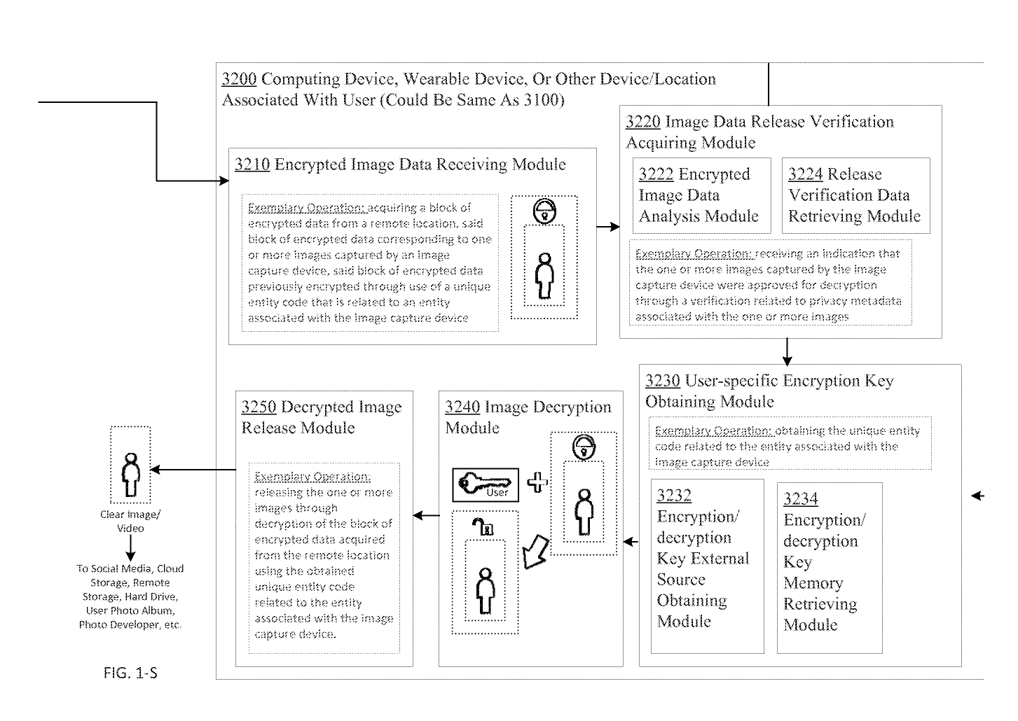

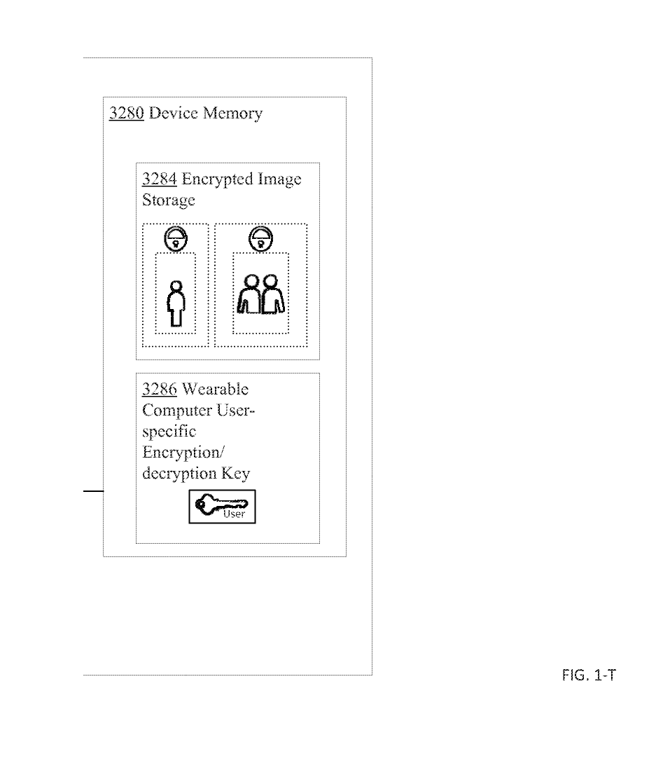

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

It is noted that “wearable computer” is used throughout this specification, and in the examples given, it is generally a wearable computer that captures images. However, this is merely for exemplary purposes. The same systems may apply to conventional digital cameras, and any other camera, including security cameras, surveillance cameras, motor vehicle mounted cameras, road/traffic cameras, cameras at automated teller machines, and the like.

Referring now to FIG. 1, in an embodiment, an entity, e.g., a user of a privacy beacon, e.g., user 2105, e.g., a person, e.g., “Jules Caesar,” may be associated with a “Don't Capture Me” (hereinafter “DCM”) privacy beacon, e.g., DCM Beacon 2110. In an embodiment, a DCM beacon may be active, e.g., may contain circuitry and be an active unit, e.g., something wearable, e.g., on a piece of clothing, or on a ring, or on a drone associated with the user. In an embodiment, the DCM beacon may be passive, e.g., it may be something that can be detected in the electromagnetic spectrum, or can be otherwise detected but does not contain any circuitry or advanced logic gates of its own. In an embodiment, the DCM beacon may be a combination of the two.

In an embodiment, a DCM beacon may be detectable by a machine or a human being (e.g., a stop sign painted on a user's forehead may be a DCM beacon). In an embodiment, a DCM beacon may be detectable by a particular type of machine, structure, or filter, and may be otherwise undetectable or difficult to detect through human senses. For example, in an embodiment, a DCM beacon may be seen using ultraviolet or infrared light, or a DCM beacon may emit light outside the visible spectrum. In an embodiment, a DCM beacon may be visible or detectable after a filter is applied, e.g., a DCM beacon may be visible after a red filter is applied, or after a transformation is applied to a captured image, e.g., a Fourier transformation.

In an embodiment, a DCM beacon may be detected optically. In another embodiment, a DCM beacon may be detected by sensing a different kind of wave emitted by a DCM beacon, e.g., a wave in the nonvisible electromagnetic spectrum, a sound wave, an electromagnetic wave, and the like. In an embodiment, a DCM beacon may use quantum entanglement (e.g., through use of an entanglement-based protocol, among others).

In an embodiment, a DCM beacon may transmit data, e.g., a terms of service for the user (e.g., user 2105) for which the DCM beacon (e.g., DCM beacon 2110) is associated or linked. In an embodiment, a DCM beacon may be encoded with a location of data, e.g., a web address of a server where terms of service for the user (e.g., user 2105) for which the DCM beacon (e.g., DCM beacon 2110) is associated.

In an embodiment, a DCM beacon may be provided by a drone, of any size, e.g., nanometers to full-sized aircraft, that is associated with the user.

In an embodiment, a DCM beacon may be provided by a piece of electronics that a user carries, e.g., a cellular telephone, tablet, watch, wearable computer, or otherwise.

In an embodiment, a DCM beacon may be embedded in the user, ingested by the user, implanted in the user, taped to the skin of the user, or may be engineered to grow organically in the user's body.

In an embodiment, a DCM beacon may be controlled by a magnetic field or other field emitted by a user, either through a user's regular electromagnetic field or through a field generated by a device, local or remote, associated with the user.

Referring again to FIG. 1, in an embodiment, a different user, e.g., a wearable computer user 3105, may have a wearable computer 3100. A wearable computer may be a pair of eyeglasses, a watch, jewelry, clothing, shoes, a piece of tape placed on the user's skin, it may be ingested by the user or otherwise embedded into the user's body. Wearable computer 3100 may be a piece of electronics carried by a user 3105. Wearable computer 3100 may not be a “wearable” computer in a traditional sense, but may be a laptop computer, tablet device, or smartphone carried by a user. In an embodiment, wearable computer 3100 may not be associated with a user at all, but may simply be a part of a surveillance system, e.g., a security camera, or a camera at an Automated Teller Machine (“ATM”).

Wearable Computer That Captures the Image (FIGS. 1-I; 1-J, 1-N, 1-O).

Referring now to FIG. 1, e.g., FIG. 1-J, wearable computer 3100 may include a wearable computer image capturing device 3110, e.g., a lens. Wearable computer image capturing device 3110 may include functionality to capture images, e.g., an image sensor, e.g., a charge-coupled device (“CCM”) or a complementary metal-oxide semiconductor (“CMOS”), an analog-to digital converter, and/or any other equipment used to convert light into electrons. Wearable computer image capturing device 3110 may capture the optical data, which may remain as light data, or may be converted into electrons through an image sensor, as raw data. This raw data, e.g., raw data 2200 may be captured by the optical image data acquiring module 3120 of wearable computer 3100. Optical image data acquiring module 3120 may be configured to acquire an image, e.g., an image of user 2105. As described above, a DCM beacon 2110 may be associated with user 2105. In an embodiment, at this point in the operation of wearable computer 3100, no processing has been performed on the raw image data 2200.

Although not pictured here, wearable computer image capturing device 3110 may also include circuitry to detect audio (e.g., a microphone) and/or video (e.g., the ability to capture frames above a certain rate of frames per second). This circuitry and its related explanation have been omitted to maintain simplicity of the drawing, however, through this application, “raw image data 2200” should be considered to also possibly include still pictures, video, and audio, in some embodiments.

Referring now to FIG. 1-I, in an embodiment, wearable computer 3100 then may transfer the raw/optical image data 2200 to an image path splitting module 3130. This splitting path may be optical, e.g., a set of mirrors/lenses, for the case in which raw image data 2200 is still in optical form, or digital, e.g., through use of known electrical signal splitters. Image path splitting module 3130 may be implemented as hardware, software, or a combination thereof.

Referring again to FIG. 1, e.g., FIG. 1-I, in an embodiment, the north (upper) branch, as illustrated in FIG. 1, transmits the raw image data 2200 to an image prior-to-processing encryption module 3150. Image prior-to-processing encryption module 3150 may receive the raw image data 2200. From there, image prior-to-processing encryption module 3150 may acquire an encryption key that is device-specific, e.g., wearable computer device specific encryption key 3182. In an embodiment, wearable computer device-specific encryption key 3182 may be stored in wearable computer device memory 3180, which also may include encrypted image storage 3184, and a wearable computer user-specific encryption key 3186. In another embodiment, device-specific encryption key 3182 may be retrieved from elsewhere, e.g., cloud storage. In another embodiment, device-specific encryption key 3182 may be generated in real time by the device. In another embodiment, device-specific encryption key 3182 may be generated in real time by the device based on random user input (e.g., the last five words spoken by the device and recorded).

In an embodiment, image prior-to-processing encryption module 3150 may generate encrypted image data 2210. Encrypted image data 2210 may be stored in encrypted image storage 3184 of wearable computer device memory 3180. In an embodiment, encrypted image data 2210 also may be transmitted to central server encrypted data and beacon metadata transmission module 3170.

Referring again to FIG. 1-I and FIG. 1-N, in an embodiment, the south (lower) branch, as illustrated in FIG. 1, may transmit the raw image data 2200 to a DCM beacon detecting module 3140. In an embodiment, DCM beacon detecting module 3140 may include one or more of optics-based DCM beacon detecting module 3142, which may be configured to detect the DCM beacon in an optical signal (e.g., light). In an embodiment, DCM beacon detecting module 3140 may include digital image processing-based DCM beacon detecting module 3144, which may be configured to detect the DCM beacon in a converted electron signal (e.g., data signal). In an embodiment, DCM beacon detecting module 3140 is configured to detect a presence or an absence of a DCM beacon, e.g., DCM beacon 2110, associated with the entity (e.g., user 2105, e.g., “Jules Caesar”), without performing any additional processing on the image, or releasing the image for other portions of wearable computer 3100 to use. In an embodiment, for example, raw image data 2200 is not stored in device memory of wearable computer 3100 in a form that is accessible to other applications and/or programs available to wearable computer 3100 or other computing devices that may communicate with wearable computer 3100. For example, a user 3105 of wearable computer 3100 may not, at this stage in processing, capture the raw data 2200 and upload it to a social networking site, e.g., Facebook. In an embodiment, DCM beacon detecting module 3140 may be implemented in hardware, which may prevent users or third parties from bypassing the DCM beacon detecting module 3140, without disassembling the device and physically altering the circuit/logic.

Referring now to FIG. 1-N, in an embodiment, the DCM beacon detecting module 3140 may detect the DCM beacon 2110. For example, in the exemplary embodiment shown in FIG. 1, DCM beacon detecting module 3140 may detect the DCM beacon 2110 that is associated with user 2105, e.g., Jules Caesar. Thus, DCM beacon detecting module 3140 now knows to lock the image data and prevent unencrypted image data from being accessed on the device. Although not shown in this example, if the DCM beacon had not been found, then in an embodiment, the image data 2200 would have been released for use by the device, e.g., for uploading to social network or cloud storage, for example.

In an embodiment, the detected DCM beacon 2110 associated with Jules Caesar may be transmitted to DCM beacon metadata generating module 3160. DCM beacon metadata generating module 3160 may generate metadata based on the detection of the beacon. The metadata may be as simple as “the image data contains a privacy beacon,” e.g., Boolean data. In an embodiment, the metadata may be more complex, and may identify the user associated with the privacy beacon, e.g., the metadata may describe “A privacy beacon associated with Jules Caesar has been found in the image data.” In another embodiment, the metadata may include the terms of service associated with the personality rights of Jules Caesar, an example of which terms of service will be provided in more detail herein.

In an embodiment, the detected DCM beacon 2110 may be very simple (e.g., optically detectable), and to obtain/generate metadata associated with the detected DCM beacon 2110, DCM beacon metadata generating module 3160 may include a DCM server contacting module 3162, which may contact one or more entities to obtain more information regarding the DCM beacon 2110. The DCM beacon metadata generating module 3160 may, in some embodiments, transmit the DCM beacon, or the image in which the DCM beacon was captured, to the external entity, in order to obtain more accurate data. For example, the DCM server contacting module 3162 may contact service term management server 5000, which may have DCM beacon registry 5010, which will be discussed in more detail further herein.

In an embodiment, DCM beacon metadata generating module 3160 may generate the DCM beacon metadata 2230, and transfer DCM beacon metadata 2230 to central server encrypted data and beacon metadata transmission module 3170.

Referring again to FIG. 1, e.g., FIG. 1-I, central server encrypted data and beacon metadata transmission module 3170 may receive the encrypted image data 2210 and the DCM beacon metadata 2230 (e.g., see FIG. 1-N). In an embodiment, central server encrypted data and beacon metadata transmission module 3170 may facilitate the transmission of encrypted image data 2210 and DCM beacon metadata 2230 to a server, e.g., wearable computer encrypted data receipt and determination server 4000, which will be discussed in more detail herein. In an embodiment, central server encrypted data and beacon metadata transmission module 3170 may include one or more of DCM beacon metadata transmission module 3172, which may be configured to transmit the DCM beacon metadata 2230, and encrypted data transmission module 3174, which may be configured to transmit the encrypted image data 2210.

Wearable Computer Server (FIGS. 1-H, 1-G)

Referring again to FIG. 1, e.g., FIG. 1-H, in an embodiment, a system may include a wearable computer server, e.g., wearable computer encrypted data receipt and determination server 4000. In an embodiment, a wearable computer server may be provided by a manufacturer of the wearable device 3100. In an embodiment, a wearable computer server may be provided by a developer of one or more software applications for the wearable device 3100. In an embodiment, wearable computer server 4000 may not have a direct relationship with wearable device 3100 prior to receiving the encrypted image data and the DCM beacon metadata 2230, as will be discussed in more detail herein. In an embodiment, a wearable computer server 4000 may be implemented at a home computer of a user, for example, and may communicate only with wearable devices that are associated with that user. In another embodiment, a wearable computer server 4000 may communicate with many wearable devices 3100, which may or may not have some relationship. In an embodiment, wearable computer server 4000 may communicate with one or more wearable devices 3100 through use of a communication network, which may use any known form of device communication. In an embodiment, wearable computer server 4000 may be chosen by wearable device 3100, either due to proximity or due to one or more properties or characteristics of wearable computer server 4000. In an embodiment, wearable computer server 4000 may be free to agree or disagree to process DCM beacon and image data received from various wearable devices 3100. In an embodiment, wearable computer server 4000 may be distributed across many computers and/or servers.

In an embodiment, wearable computer encrypted data receipt and determination server 4000 may include an encrypted data and beacon metadata reception module 4100. Encrypted data and beacon metadata reception module 4100 may receive encrypted image data 2210 and DCM beacon metadata 2230 from wearable computer 3100, e.g., central server encrypted data and beacon metadata transmission module 3170. In an embodiment, encrypted data and beacon metadata reception module 4100 may include a DCM beacon metadata reception module 4104. DCM beacon metadata reception module 4104 may be configured to acquire a privacy metadata, e.g., DCM beacon metadata 2230, corresponding to a detection of a DCM beacon, e.g., DCM beacon 2110, in the one or more images captured by the image capture device, e.g., wearable computer 3100. In an embodiment, encrypted data and beacon metadata reception module 4100 may include encrypted data reception module 4102. In an embodiment, encrypted data reception module 4102 may be configured to acquire one or more of a block of encrypted data corresponding to one or more images that previously have been encrypted, e.g., encrypted image data 2210. In an embodiment, encrypted data module 4102 may transmit, or facilitate the transmission of, encrypted image data 2210 to an entity that will perform a secondary detection of the privacy beacon, e.g., DCM beacon detection test duplicating server 4800, which will be discussed in more detail further herein.

Referring again to FIG. 1-H, in an embodiment, encrypted data and beacon metadata reception module 4100 may transmit the received DCM beacon metadata to DCM beacon metadata reading module 4120. If the DCM beacon metadata 2230 indicates that a DCM beacon was not found, then, in an embodiment, processing may transfer to module 4220, which will be discussed in more detail further herein. In the example shown in FIG. 1, the DCM beacon 2110 associated with Jules Caesar was found, and the DCM beacon metadata 2230 indicates this state to DCM beacon metadata reading module 4120.

Referring now to FIG. 1-G, in an embodiment, when the presence of the DCM beacon 2110 is determined through the DCM beacon metadata, e.g., DCM beacon metadata 2230, then a DCM beacon TOS retrieval module 4122 may retrieve term data from a location, which may be a remote location, e.g., a DCM beacon management server 5100, which will be discussed in more detail further herein. In an embodiment, DCM beacon TOS retrieval module 4122 may retrieve term data that includes a terms of service that specifies one or more conditions in which the image containing the DCM beacon 2110 may be used. In an embodiment, the TOS may also specify one or more penalties for using the personality rights that may be associated with the image, without acquiring permission or paying a licensing fee prior to releasing or utilizing the image. In an embodiment, the TOS also may include language forcing the entity that viewed the privacy beacon to accept the TOS upon viewing of the beacon. The TOS will be described in more detail with respect to modules 5000 and 5100.

Referring again to FIG. 1-G, in an embodiment, wearable computer encrypted data receipt and determination server 4000 also may include an encrypted data value calculation module 4130. Encrypted data value calculation module 4130 may use one or more algorithms or other methods of inducing or deducing an estimate regarding how much advertising or other revenue may be garnered by using the images containing the entity associated with the privacy beacon. For example, in an embodiment, encrypted data value calculation module 4130 may include a facial recognition program to recognize the person or persons associated with the beacon. In another embodiment, however, this may not be necessary, because the DCM beacon metadata and/or the ToS may identify the person. In an embodiment, encrypted data value calculation module 4130 may use various heuristics to calculate ad revenue, e.g., based on models used by popular advertising methods, or based on prior releases of images of the person associated with the DCM beacon 2110. In an embodiment, module 4130 may use social networking to acquire a focus group and test the image on the focus group, in order to assist in revenue determination. For example, in the example shown in FIG. 1, the image in question is of Jules Caesar, who is the reclusive leader of the Roman Empire, and so the ad revenue generated from having an actual picture of Jules Caesar, or a video of Jules Caesar drinking a mead-and-tonic, may have high net value.

Referring again to FIG. 1-G, in an embodiment, the ToS acquired from DCM beacon TOS retrieval module 4122, and the encrypted data valuation calculated from encrypted data value calculation module 4130 may be sent to release of encrypted data determination module 4140. Release of encrypted data determination module 4140 may make a determination, at least partly based on the acquired metadata, and at least partly based on a value calculation based on the representation of the feature of the person associated with the DCM beacon 2110 (e.g., Jules Caesar drinking a mead-and-tonic). That determination may be regarding whether to allow an action, e.g., processing, decryption, distribution, editing, releasing, sharing, saving, posting to a social network, and the like, of the image. In an embodiment, the decision may be based on whether the potential advertising revenue outweighs the potential damages retrieved from the terms of service. In an embodiment, this calculation may be a strict number comparison (e.g., is “revenue” greater than “damages”). In an embodiment, the calculation may include more complex factors, e.g., likelihood of success on a damages claim, likelihood that revenues will increase, secondary revenue factors from increased traffic and/or brand awareness, and the like. In addition, in an embodiment, the comparison may not be strictly less than/greater than, e.g., in a risk adverse algorithm, if the numbers are close, then the determination may be to not release the encrypted data, even if the potential ad revenue is calculated as larger than the potential damages by a small amount.

Referring again to FIG. 1-G, if the determination made by release of encrypted data determination module 4140 is “NO,” e.g., the potential revenue is less than the potential damages, then the encrypted data 2210 is moved to an encrypted data holding and/or quarantine module 4150. In an embodiment, the data from encrypted data holding and/or quarantine module 4150 is deleted after a predetermined time period, e.g., seven days. In an embodiment, the data is simply stored, encrypted and locked away. In an embodiment, the encrypted image data 2210 may be transmitted to an ad replacement value determination server 4400, shown in FIG. 1-F, which will be discussed in more detail herein.

Referring again to FIG. 1-G, if the determination made by release of encrypted data determination module 4140 is “YES,” e.g., the potential revenue is more than the potential damages, then the encrypted data 2210 is transferred to encrypted data decryption enabling module 4152, shown in FIG. 1-H. In an embodiment, encrypted data decryption enabling module 4152 may be configured to determine whether to perform decryption of at least a portion of the encrypted data 2210 based on the result from module 4140 by transmitting the encrypted image data 2210 to wearable computer acquired encrypted data decryption and re-encryption server 4200, which will be discussed in more detail.

Wearable Computer Acquired Encrypted Data Decryption and Re-Encryption Server 4200 (FIGS. 1-L and 1-M)

Referring now to FIG. 1-M, in an embodiment, the system may include wearable computer acquired encrypted data decryption and re-encryption server 4200. In an embodiment, wearable computer acquired encrypted data decryption and re-encryption server 4200 may be a portion of wearable computer server 4000. In an embodiment, however, wearable computer acquired encrypted data decryption and re-encryption server 4200 may be a different server than wearable computer server 4000, and may be controlled by a different entity. For example, in an embodiment, the owner of the wearable computer 3100 hardware may control wearable computer server 4000. After the decision is made to decrypt the data at the wearable computer server 4000, control may be handed off to a different server in control of software on the wearable computer, e.g., software that handles pictures taken by the wearable computer 3100. In another embodiment, wearable computer acquired encrypted data decryption and re-encryption server 4200 may be controlled by a social networking/media site, e.g., Facebook, who may have an agreement to acquire the image data at the same time as the device.

Referring again to FIG. 1-M, in an embodiment, wearable computer acquired encrypted data decryption and re-encryption server 4200 may include encrypted data acquiring module 4210, which may acquire the encrypted image data 2210 from the wearable computer server 4000. In an embodiment, wearable computer acquired encrypted data decryption and re-encryption server 4200 may include a privacy metadata acquiring module 4220, which may acquire privacy metadata from module 4120, if the DCM beacon was never detected and the image is free to be used. For example, in an embodiment, image data with no DCM beacon may be treated similarly to image data with a DCM beacon, but that has been determined to have an advertising value greater than a potential damages value. For example, in an embodiment, image data with no DCM beacon may be treated as image data with potential damages value of zero.

Referring again to FIG. 1-M, in an embodiment, wearable computer acquired encrypted data decryption and re-encryption server 4200 may include data indicating profitability of image with DCM beacon acquiring module 4230, which may receive data from module 4150 of wearable computer server 4000 indicating that the image should be decrypted regardless of the DCM beacon because of its potential profitability.

Referring again to FIG. 1-M, in an embodiment, wearable computer acquired encrypted data decryption and re-encryption server 4200 may include image data decryption preparation module 4240, which may receive data from one or more of data indicating profitability of image with DCM beacon acquiring module 4230, encrypted data acquiring module 4210, and privacy metadata acquiring module 4220. In an embodiment, module 4240 may prepare the image or images for decryption, e.g., perform pre-processing, check image integrity, reconfirm the privacy beacon calculations, and the like.

Referring now to FIG. 1-L, wearable computer acquired encrypted data decryption and re-encryption server 4200 may include device-specific key retrieving module 4250 which may retrieve the device-specific key used to encrypt/decrypt the encrypted image data 2210. In an embodiment, device-specific key retrieving module 4250 may include a device-specific key retrieving from device module 4252, which may be configured to retrieve the device-specific key directly from the device that encrypted the image, e.g., wearable computing device 3100. In an embodiment, device-specific key retrieving module 4250 may include a device-specific key retrieving from server module 4254, which may be configured to retrieve the device-specific key from a server, e.g., from wearable computer encrypted data receipt and determination server 400, or from DCM beacon detection test duplicating server 4800, or from another server not depicted in FIG. 1.

Referring again to FIG. 1-L, in an embodiment, image data decryption with device-specific key module 4260 may take the device-specific key retrieved from module 4250, and apply it to the encrypted image data 2210 to generate decrypted image data 2280, as shown by the icon with the unlocked lock in FIG. 1-L.

Referring again to FIG. 1-L, the image data has been decrypted. However, to protect security, in some embodiments, the data may be re-encrypted with a key that is not tied to a specific device, but may be tied to a specific user of the device, e.g., the key may be related to user 3105, rather than wearable device 3100. This embodiment will be described in more detail herein. This embodiment allows the re-encrypted data to be securely sent to a different device belonging to the user, e.g., a smart TV, a home computer, a video game system, or another portable electronic device, e.g., a cellular smartphone. In an embodiment, the re-encryption with a user specific key may be omitted.

In an embodiment, wearable computer acquired encrypted data decryption and re-encryption server 4200 may include a user-specific key retrieving module 4270, that may be configured to obtain, through generation, acquisition, reception, or retrieval, of a user-specific encryption key. The user-specific encryption key may be delivered to image data encrypting with user-specific key module 4280, which, in an embodiment, also may receive the decrypted image data 2280.

Referring again to FIG. 1-L, in an embodiment, image data encrypting with user-specific key module 4280 may be configured to encrypt the block of decrypted data through use of a unique user code that is related to the user 3105 of the wearable device 3100. The again-encrypted image data then may be transferred to encrypted image data transmitting module 4290. In an embodiment, encrypted image data transmitting module 4290 may transmit the image data that has been encrypted with a user-specific key to one or more other devices, which will be discussed in more detail herein.

Computing Device that Receives the Image Data (FIGS. 1-S and 1-T).

Referring now to FIG. 1-S, in an embodiment, the system may include a computing device 3200, which may be a wearable computer or other device. In an embodiment, computing device 3200 may be the same as wearable computer 3100, but it does not necessarily have to be the same. In an embodiment, computing device 3200 receives the image data. In an embodiment, as described above, the received image data has been encrypted with a user-specific code. Thus, in such an embodiment, computing device 3200 may be associated with user 3105 of the wearable computing device 3100. For example, a user 3105 may have a wearable computing device 3100 that captures images of people. After processing those images at the server 4000, for example, the images, which, in some embodiments, now may be encrypted with a user-specific code, may be transmitted to computing device 3200, which may be the user 3105's home media center back at her house. In another embodiment, computing device 3200 may be user 3105's laptop device, or user 3105's smartphone or tablet device. And, as previously mentioned, in another embodiment, computing device 3200 may simply be the user 3105's wearable computing device 3100 that captured the images originally.

In an embodiment, the computing device 3200 and the wearable computing device 3100 pictured in FIG. 1 are the same device. In an embodiment, the encryption, transmission to a server, decryption, and transmission back, may occur invisibly to the user 3105, e.g., to the user 3105 of the wearable computing device 3100, the images are available to her after they are recorded and saved, with a delay that is not specified. In some embodiments, the user 3105 may not be informed of the path taken by the captured image data.

In an embodiment, wearable computing device 3100 may include an encrypted image data receiving module 3210 configured to acquire the data encrypted by the user-specific key code from encrypted image data transmitting module 4290 of wearable computer 4200. In an embodiment, computing device 3200 may include image data release verification acquiring module 3220, which may be configured to determine that the images received from the encrypted image data transmitting module 4290 of wearable computer 4200 have been approved for release and/or use. In an embodiment, the determination may be made based on the ground that the images are encrypted with a user-specific key rather than a device specific key, if it is possible to tell from the encrypted information (e.g., in some embodiments, different types of encryption that may leave a different “signature” may be used). In an embodiment, the determination may be made by again analyzing the image data. In an embodiment, image data release verification acquiring module 3220 may include encrypted image data analysis module 3222 which may perform analysis on the encrypted image data, including, but not limited to, reading metadata attached to the encrypted image data, to verify that the received encrypted image data is approved for release and/or processing. In an embodiment, image data release verification acquiring module 3220 may include release verification data retrieving module 3224, which may be configured to obtain release verification data from the device that performed the verification, e.g., server 4000, or from a different device.

Referring now to FIG. 1-T, in an embodiment, computing device 3200 may include device memory 3280. Device memory 3280 may store the wearable computer user-specific encryption/decryption key 3286, which may be used to decrypt the received encrypted image data. In an embodiment, device memory 3280 also may include encrypted image storage 3284, which may include one or more image data, which may be encrypted.

Referring again to FIG. 1-S, in an embodiment, computing device 3200 may include user-specific decryption key obtaining module 3230, which may obtain the user-specific encryption/decryption key. In an embodiment, user-specific decryption key obtaining module 3230 may include encryption/decryption key external source obtaining module 3232, which may be configured to obtain the encryption/decryption key from an external source, e.g., server 4000. In an embodiment, user-specific decryption key obtaining module may include encryption/decryption key memory retrieving module 3234, which may be configured to retrieve the encryption/decryption key from device memory 3280 of computing device 3200.

Referring again to FIG. 1-S, in an embodiment, computing device 3200 may include image decryption module 3240, which may use the user-specific encryption/decryption key to decrypt the image data. In an embodiment, the decrypted image data then may be sent to decrypted image release module 3250, where the clear image data may be accessed by the device, and transmitted to other locations, posted to social networking or cloud storage, be shared, manipulated, saved, edited, and otherwise have open access to the decrypted image data.

Ad Replacement Value Determination Server (FIG. 1-F).

Referring back to FIG. 1-G, as discussed briefly above, release of encrypted data determination module 4140 may determine not to release the encrypted data, which may be stored in an encrypted data holding and/or quarantine module 4150. In an embodiment, the encrypted data and the DCM beacon may be transmitted to an ad replacement value determination server, as shown in FIG. 1-F.

Referring now to FIG. 1-F, in an embodiment, the system may include an ad replacement value determination server 4400. Ad replacement value determination server 4400 may take the encrypted image data and determine if there is a way to monetize the images such that the monetization may outweigh the potential damages. For example, ad replacement value determination server 4400 may calculate potential earnings and limited damages liability, if, for example, an entity with the DCM beacon, e.g., Jules Caesar, is instead shown with an advertisement where his head would normally be. In an embodiment, ad replacement value server may be controlled by a different entity than server 4000, and there may be an agreement in place for the ad replacement value determination server 4400 to receive encrypted data for which the server 4000 decides it does not want to allow distribution. For example, ad replacement value server 4400 may be run by a smaller social networking site that cares less about potential damages because they have fewer assets, or are less risk-averse. In another embodiment, ad replacement value determination server 4400 may be part of server 4000, and it may be a practice of server 4000 to send an encrypted image for further analysis after the server 4000 determines that the image is not likely to be profitable without modification.

Referring again to FIG. 1-F, in an embodiment, ad replacement value determination server 4400 may include a DCM beacon metadata reception module 4410 configured to receive the DCM beacon metadata from the wearable computer encrypted data receipt and determination server 4000. In an embodiment, ad replacement value determination server 4400 may include an encrypted data reception module 4420 that may be configured to receive the encrypted data from the wearable computer encrypted data receipt and determination server 4000, e.g., from the encrypted data holding module 4150.

Referring again to FIG. 1-F, in an embodiment, ad replacement value determination server 4400 may include a DCM beacon term acquiring module 4430, which may acquire one or more terms of service from service term management server 5000 and/or DCM beacon management server 5100, similarly to DCM beacon terms-of-service retrieval module 4122 of wearable computer encrypted data receipt and determination server 4000. In an embodiment, DCM beacon term acquiring module may include DCM beacon remote retrieval module 4432. In an embodiment, DCM beacon term acquiring module may be configured to retrieve term data from a remote location, e.g., service term management server 5000, which term data may correspond to a term of service associated with a release of image data that includes the person with which the DCM beacon is associated, e.g., Jules Caesar.

Referring again to FIG. 1-F, in an embodiment, ad replacement value determination server 4400 may include an encrypted data value calculation with standard ad placement module 4440. In an embodiment, standard ad placement module 4440 may perform a similar calculation as encrypted data value calculation module 4130 of wearable computer encrypted data receipt and determination server 4000. In an embodiment, for example, encrypted data value calculation with standard ad placement module 4440 may calculate whether an estimated advertising revenue from one or more advertisement images placed in the encrypted image data will be greater than an estimated potential liability for distribution of the images. In an embodiment, the estimated potential liability is based at least in part on the terms of service which may be retrieved by the DCM beacon term acquiring module 4430.

Referring again to FIG. 1-F, in an embodiment, ad replacement value determination server 4400 may include encrypted image data modification with intentionally obscuring ad placement module 4450. In an embodiment, encrypted image data modification with intentionally obscuring ad placement module 4450 may be configured to modify the encrypted image data (e.g., which, in some embodiments, may require limited decryption and then re-encryption) by replacing one or more areas associated with the entity related to the DCM beacon, e.g., Jules Caesar's face (e.g., or in another embodiment, Jules Caesar's genitalia, if, e.g., it was a naked picture of Jules Caesar), with one or more advertisement images.

Referring again to FIG. 1-F, in an embodiment, ad replacement value determination server 4400 may include modified encrypted data value calculation with intentionally obscuring ad placement module 4460. In an embodiment, modified encrypted data value calculation with intentionally obscuring ad placement module 4460 may be configured to calculate an estimated advertising revenue from the modified image data. In an embodiment, the modified image data then may be distributed through modified encrypted data distributing module 4470.

Tracking Server (FIG. 1-E).

Referring now to FIG. 1-E, in an embodiment, a system may include tracking server 9000. Tracking server 9000 may be configured to log use of a “Don't Capture Me” (hereinafter “DCM”) beacon by one or multiple users. In an embodiment, tracking server 9000 may track active DCM beacons, e.g., beacon 2110, through communication with said one or more beacons. In an embodiment, tracking server may track DCM beacons through other means, e.g., social networking and the like. The DCM beacon does not need to be an active DCM beacon in order to be tracked by tracking server 9000.

In an embodiment, tracking server 9000 may include deployment of one or more active and/or passive DCM beacons monitoring module 9010. Deployment of one or more active and/or passive DCM beacons monitoring module 9010 may include one or more of active DCM beacon monitoring module 9012 and passive DCM beacon monitoring/data gathering module 9020. In an embodiment, passive DCM beacon monitoring/data gathering module 9020 may gather data about the passive DCM beacon by observing it, e.g., through satellite video capture, through other image capturing devices, e.g., phone cameras, security cameras, laptop webcams, and the like, or through other means. In an embodiment, passive DCM beacon monitoring/data gathering module 9020 may include user input module 9022, which may receive an indication from a user, e.g., a switch flipped on a user's cell phone, indicating that the user is using the DCM beacon. In an embodiment, passive DCM beacon monitoring/data gathering module 9020 may include a device status module which tracks a device with which the passive DCM beacon is associated, e.g., a wearable computer that is a shirt, or a cellular phone device in the pocket. In an embodiment, passive DCM beacon monitoring/data gathering module 9020 may include a social media monitoring module that monitors posts on social networking sites to determine if the DCM beacon is being used, and a location of the user.

Referring again to FIG. 1-E, in an embodiment, tracking server 9000 may include a record of the deployment of the one or more active and/or passive DCM beacons storing module 9030, which may be configured to store a record of usage and/or detection logs of the DCM beacons that are monitored. In an embodiment, record of the deployment of the one or more active and/or passive DCM beacons storing module 9030 may store a record of the deployment in deployment record storage 9032. In an embodiment, record of the deployment of the one or more active and/or passive DCM beacons storing module 9030 may transmit all or portions of the recorded record through record of the deployment of one or more active and/or passive DCM beacons transmitting module 9040.

Service Term Management Server 5000 (FIG. 1-A)

Referring now to FIG. 1-A, in an embodiment, the system may include service term management server 5000, which may manage terms of service that are associated with a DCM beacon and/or a person. In an embodiment, service term management server 5000 may include a DCM beacon registry 5010. In an embodiment, the DCM beacon registry 5010 may include one or more of a user's name, e.g., Jules Caesar, a terms of service associated with Jules Caesar, which may be custom to Jules Caesar, or may be a generic terms of service that is used for many persons, and various representations of portions of Jules Caesar, e.g., likeness, handprint, footprint, voiceprint, pictures of private areas, and the like.

Referring again to FIG. 1-A, in an embodiment, the system may include a terms of service generating module 5020. Terms of service generating module 5020 may create a terms of service for the user Jules Caesar. A sample Terms of Service is shown in FIG. 1-A and is reproduced here. It is noted that this is a condensed Terms of Service meant to illustrate an exemplary operation of the system in the environment, and accordingly, several necessary legal portions may be omitted. Accordingly, the example Terms of Service should not be considered as a binding, legal document, but rather a representation of what the binding, legal document would look like, that would enable one skilled in the art to create a full Terms of Service.

Exemplary Terms of Service for User 2105 (Jules Caesar)

1. By capturing an image of any part of the user Jules Caesar (hereinafter “Image”), or providing any automation, design, resource, assistance, or other facilitation in the capturing of the Image, you agree that you have captured these Terms of Service and that you acknowledge and agree to them. If you cannot agree to these Terms of Service, you should immediately delete the captured Image. Failure to do so will constitute acceptance of these Terms of Service.

2. The User Jules Caesar owns all of the rights associated with the Image and any representation of any part of Jules Caesar thereof;

3. By capturing the Image, you agree to provide the User Jules Caesar just compensation for any commercialization of the User's personality rights that may be captured in the Image.

4. By capturing the Image, you agree to take all reasonable actions to track the Image and to provide an accounting of all commercialization attempts related to the Image, whether successful or not.

5. By capturing the Image, you accept a Liquidated Damages agreement in which unauthorized use of the Image will result in mandatory damages of at least, but not limited to, $1,000,000.

In an embodiment, terms of service generating module may include one or more of a default terms of service storage module 5022, a potential damage calculator 5024, and an entity interviewing for terms of service generation module. In an embodiment, default terms of service storage module 5022 may store the default terms of service that are used as a template for a new user, e.g., when Jules Caesar signs up for the service, this is the terms of service that is available to him. In an embodiment, potential damage calculator 5024 may determine an estimate of how much in damages that Jules Caesar could collect for a breach of his personality rights. In an embodiment, for example, potential damage calculator may search the internet to determine how much Jules Caesar appears on social media, blogs, and microblog (e.g., Twitter) accounts. In an embodiment, entity interviewing for terms of service generation module 5026 may create an online questionnaire/interview for Jules Caesar to fill out, which will be used to calculate potential damages to Jules Caesar, e.g., through determining Jules Caesar's net worth, for example.

In an embodiment, service term management server 5000 may include terms of service maintenance module 5030, which may maintain the terms of service and modify them if, for example, the user becomes more popular, or gains a larger online or other presence. In an embodiment, terms of service maintenance module 5030 may include one or more of a social media monitoring module 5042, that may search social networking sites, and an entity net worth tracking module 5034 that may have access to the entity's online bank accounts, brokerage accounts, property indexes, etc., and monitor the entity's wealth.

In an embodiment, serviced term management server 5000 may include a use of representations of an entity detecting module 5040. In an embodiment, use of representations of an entity detecting module 5040 may include one or more of a social media monitoring module 5042, a public photo repository monitoring module 5044, and a public blog monitoring module 5046. In an embodiment, use of representations of an entity detecting module 5040 may track uses of representations, e.g., images, of the user Jules Caesar, to try to detect violations of the terms of service, in various forums.

DCM Beacon Management Server 5100 (FIG. 1-C)

Referring now to FIG. 1-C, in an embodiment, the system may include a DCM beacon management server 5100, which may be configured to manage the DCM beacon associated with a user, e.g., DCM beacon 2110 for user 2105, e.g., Jules Caesar. In an embodiment, DCM beacon management server 5100 and service term management server 5000 may be the same server. In another embodiment, DCM beacon management server 5100 and service term management server 5000 may be hosted by different entities. For example, a specialized entity may handle the terms of service generation, e.g., a valuation company that may be able to determine a net “social network” worth of a user, e.g., Jules Caesar, and use that to fashion the terms of service.

Referring again to FIG. 1-C, in an embodiment, DCM beacon management server 5100 may include DCM beacon communication with entity wanting to avoid having their image captured module 5110. DCM beacon communication with entity wanting to avoid having their image captured module 5110 may be configured to communicate with a user, e.g., user 2105, e.g., Jules Caesar, and may handle the creation, generation, maintenance, and providing of the DCM beacon 2110 to Jules Caesar, whether through electronic delivery or through conventional delivery systems (e.g., mail, pickup at a store, etc.). In an embodiment, DCM beacon communication with entity wanting to avoid having their image captured module 5110 may include one or more of DCM beacon transmission module 5112, DCM beacon receiving module 5114, and DCM beacon generating module 5116.

In an embodiment, DCM beacon management server 5100 may include entity representation acquiring module 5120. Entity representation acquiring module 5100 may be configured to receive data regarding one or more features of the user that will be associated with the DCM beacon. For example, the user might upload pictures of his body, face, private parts, footprint, handprint, voice recording, hairstyle, silhouette, or any other representation that may be captured and/or may be deemed relevant.

In an embodiment, DCM beacon management server 5100 may include DCM beacon association with one or more terms of service and one or more entity representations module 5130. In an embodiment, DCM beacon association with one or more terms of service and one or more entity representations module 5130 may be configured to, after generation of a DCM beacon, obtain a terms of service to be associated with that DCM beacon. In an embodiment, the terms of service may be received from service term management server 5000.

In an embodiment, DCM beacon management server 5100 may include a DCM beacon capture detecting module 5140. DCM beacon capture detection module 5140 may detect when a DCM beacon is captured, e.g., if it is an active beacon, or it may receive a notification from various servers (e.g., server 4000) and/or wearable devices (e.g., wearable device 3100) that a beacon has been detected, if it is a passive DCM beacon.

In an embodiment, when a DCM beacon is detected, DCM beacon management server 5100 may include terms of service associated with DCM beacon distributing module, which may be configured to provide the terms of service associated with the DCM beacon to an entity that captured the image including the DCM beacon, e.g., to module 4122 of wearable computer encrypted data receipt and determination server 4000, or DCM beacon remote retrieval module 4430 of ad replacement value determination server 4400, for example.

Wearable Computer with Optional Paired Personal Device 3300 (FIGS. 1-Q and 1-R)

Referring now to FIG. 1-R, in an embodiment, the system may include a wearable computer 3300. Wearable computer 3300 may have additional functionality beyond capturing images, e.g., it may also store a user's contact list for emails, phone calls, and the like. In another embodiment, wearable computer 3300 may be paired with another device carried by a user, e.g., the user's smartphone device, which stores the user's contact list. As will be described in more detail herein, wearable computer 3300 operates similarly to wearable computer 3100, except that entities with DCM beacons are obscured, unless they have a preexisting relationship with the user. It is noted that DCM beacon detection and encryption may operate similarly in wearable computer 3300 as in wearable computer 3100, and so substantially duplicated parts have been omitted.

Referring again to FIG. 1-R, in an embodiment, wearable computer 3300 may include an image capturing module 3310, which may capture an image of Jules Caesar, who has DCM beacon “A”, Beth Caesar, who has DCM beacon “B”, and Auggie Caesar, who has no DCM beacon. In an embodiment, wearable computer 3300 may include an image acquiring module 3320, which may be part of image capturing module 3310, to acquire one or more images captured by an image capture device, e.g., the image of Jules Caesar, Beth Caesar, and Auggie Caesar.

In an embodiment, wearable computer 3300 may include an entity identification module 3330, which may perform one or more recognition algorithms on the image in order to identify persons in the image. Entity identification module may use known facial recognition algorithms, for example, or may ask the user for input, or may search the internet for similar images that have been identified, for example.

Referring again to FIG. 1-R, in an embodiment, wearable computer 3300 may include preexisting relationship data retrieval module 3340, which may retrieve names of known persons, e.g., from a device contact list, e.g., device contact list 3350. In the example shown in FIG. 1, Jules Caesar is in the contact list of the device 3300. It is noted that the device contact list 3350 may be stored on a different device, e.g., the user's cellular telephone.

Referring now to FIG. 1-Q, in an embodiment, wearable computer 3300 may include data indicating an identified entity from the image data has a preexisting relationship obtaining module 3360, which, in an embodiment, may obtain data indicating that one of the entities recorded in the image data (e.g., Jules Caesar) is in the user's contact list.

Referring again to FIG. 1-Q, in an embodiment, wearable computer 3300 may include entities with preexisting relationship marking to prevent obfuscation module 3370. In an embodiment, entities with preexisting relationship marking to prevent obfuscation module 3370 may attach a marker to the image, e.g., a real marker on the image or a metadata attachment to the image, or another type of marker, that prevents obfuscation of that person, regardless of DCM beacon status, because they are in the user's contact list.

Referring again to FIG. 1-Q, in an embodiment, wearable computer 3300 may include unknown entities with DCM beacon obscuring module 3380, which may obfuscate any of the entities in the image data that have a DCM beacon and are not in the contact list. For example, in the example shown in FIG. 1, Beth Caesar's image is obscured, e.g., blurred, blacked out, covered with advertisements, or the like, because she has a DCM beacon associated with her image, and because she is not in the user's contact list. Jules Caesar, on the other hand, is not obscured because a known entity marker was attached to his image at module 3370, because Jules Caesar is in the contact list of an associated device of the user. Auggie Caesar is not obscured regardless of contact list status, because there is no DCM beacon associated with Auggie Caesar.

Referring again to FIG. 1-Q, after the image is obscured, obscured image 3390 of wearable computer 3300 may release the image to the rest of the device for processing, or to another device, the Internet, or cloud storage, for further operations on the image data.

Active DCM Beacon 6000 (FIGS. 1-P and 1-K).

Referring now to FIG. 1-P, in an embodiment, a user 2107 may be associated with an active DCM beacon 2610, which will be discussed in more detail herein. The word “Active” in this context merely means that the DCM beacon has some form of circuitry or emitter.

Referring now to FIG. 1-K, in an embodiment, the system may include an active DCM beacon 6000, which may show an active DCM beacon, e.g., active DCM beacon 2610, in more detail. In an embodiment, beacon 6000 may include DCM beacon broadcasting module 6010. In an embodiment, DCM beacon broadcasting module 6010 may broadcast a privacy beacon associated with at least one user, e.g., user 2107, from at or near the location of user 2107. The beacon may be detected by an image capturing device when the user is captured in an image.

Referring again to FIG. 1-K, in an embodiment, the beacon 6000 may include an indication of DCM beacon detection module 6020, which may detect, be informed of, or otherwise acquire an indication that the active DCM beacon has been captured by an image capturing device. In an embodiment, indication of DCM beacon detection module 6020 may include one or more of DCM beacon scanning module 6022, which may scan nearby devices to see if they have detected the beacon, and DCM beacon communications handshake module 6024, which may establish communication with one or more nearby devices to determine if they have captured the beacon.

Referring again to FIG. 1-K, in an embodiment, beacon 6000 may include term data broadcasting module 6030, which may broadcast, or which may order to be broadcasted, term data, which may include the terms of service. In an embodiment, term data broadcasting module 6030 may include one or more of a substantive term data broadcasting module 6032, which may broadcast the actual terms of service, and pointer to term data broadcasting module 6034, which may broadcast a pointer to the terms of service data that a capturing device may use to retrieve the terms of service from a particular location.

DCM Beacon Test Duplicating Sever 4800 (FIGS. 1-C and 1-D)

Referring now to FIG. 1-C, in an embodiment, the system may include a DCM beacon test duplicating server 4800. In an embodiment, the DCM beacon test duplicating server 4800 may take the image data, and perform the test for capturing the beacon again, as a redundancy, as a verification, or as a protection for wearable computer server 4000. In an embodiment, DCM beacon test duplicating server 4800 may be a part of wearable computer server 4000. In another embodiment, DCM beacon test duplicating server 4800 may be separate from wearable computer server 4000, and may be controlled by a different entity, e.g., a watchdog entity, or an independent auditing agency.

Referring again to FIG. 1-C, in an embodiment, DCM beacon test duplicating server 4800 may include encrypted data reception for secondary DCM beacon detection module 4810, which may acquire the encrypted image data containing the user, e.g., user 2105, e.g., Jules Caesar, and the associated DCM beacon, e.g., DCM beacon 2110.

Referring again to FIG. 1-C, in an embodiment, DCM beacon test duplicating server 4800 may include a device-specific key retrieving module 4820, which may retrieve the device-specific key, e.g., from wearable computer device 3100, or from wearable computer server 4000. In an embodiment, DCM beacon test duplicating server 4800 may include image data decryption with device-specific key module 4830, which may apply the device-specific key obtained by device-specific key retrieving module 4820, and apply it to the encrypted image data, to generate decrypted image data.

Referring again to FIG. 1-C, in an embodiment, the unencrypted image data may be sent to DCM beacon detecting module 4840 of DCM beacon test duplicating server 4800. If the raw image data was optical in its original form, then it may be reconverted to optical (e.g., light) data. In an embodiment, DCM beacon detecting module 4840 may perform a detection for the DCM beacon, as previously described. In an embodiment, DCM beacon detecting module 4840 may include one or more of an optics-based DCM beacon detecting module 4842 and a digital image processing-based DCM beacon detecting module 4844.

Referring now to FIG. 1-D, after the test for detecting the DCM beacon 2220 (which may be the same as the DCM beacon 2210, but is detected at a different place, so a different number has been assigned), DCM beacon detection at duplicating sever result obtaining module 4850 may obtain the result of the detection performed at DCM beacon test duplicating server 4800. Similarly, DCM beacon detection at device result obtaining module 4860 may obtain the result from the DCM beacon detection performed at wearable computer device 3100. The results from module 4850 and 4860 may be stored at DCM beacon test result storage and logging module 4870 of DCM beacon test duplicating server 4800.

Referring again to FIG. 1-D, the test results from DCM beacon test duplicating server 4800 and from wearable computer 3100 may be stored at DCM beacon test result storage and logging module 4870, and such results may be kept for a predetermined length of time. In an embodiment, the results may be transmitted to a requesting party using DCM beacon test result transmitting module 4880.

Referring again to the system, in an embodiment, a computationally-implemented method may include acquiring an image, said image including at least one representation of a feature of at least one entity, detecting a presence of a privacy beacon associated with the at least one entity from the acquired image, without performance of a further process on the acquired image, encrypting the image using a unique device code prior to performance of one or more image processes other than privacy beacon detection, said unique device code unique to an image capture device and not transmitted from the image capture device, and facilitating transmission of the encrypted image and privacy beacon data associated with the privacy beacon to a location configured to perform processing on one or more of the encrypted image and the privacy beacon data.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata, said privacy metadata corresponding to a detection of a privacy beacon in the one or more images captured by the image capture device, said privacy beacon associated with the at least one entity, and determining, at least partly based on the acquired privacy metadata, and partly based on a value calculation based on the representation of the feature of the at least one entity for which the privacy beacon is associated, whether to allow processing, which may include distribution, decryption, etc., of the encrypted data block.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata indicating detection of a privacy beacon in the one or more images captured by the image capture device, said privacy beacon associated with the at least one entity, retrieving term data from a remote location, said term data corresponding to a term of service associated with a potential release of the block of encrypted data corresponding to the one or more images that have previously been encrypted through use of the unique device code associated with the image capture device configured to capture the one or more images, calculating an expected valuation corresponding to potential revenue associated with the release of at least a portion of the block of encrypted data corresponding to the one or more images that have previously been encrypted through use of the unique device code associated with the image capture device configured to capture the one or more images, and determining whether to perform decryption of at least a portion of the block of encrypted data at least partially based on the calculation of the expected valuation corresponding to the potential revenue associated with the release of the at least the portion of the block of encrypted data, and at least partially based on the retrieved term data corresponding to the term of service.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, acquiring a privacy metadata indicating a lack of detection of a privacy beacon in the one or more images captured by the image capture device, decrypting the block of encrypted data corresponding to the one or more images that have previously been encrypted through use of a unique device code associated with the image capture device, and encrypting the block of decrypted data through use of a unique entity code that is related to an entity associated with the image capture device configured to capture the one or more images. Referring again to the system, in an embodiment, a computationally-implemented method may include acquiring a block of encrypted data from a remote location, said block of encrypted data corresponding to one or more images captured by an image capture device, said block of encrypted data previously encrypted through use of a unique entity code that is related to an entity associated with the image capture device, receiving an indication that the one or more images captured by the image capture device were approved for decryption through a verification related to privacy metadata associated with the one or more images, obtaining the unique entity code related to the entity associated with the image capture device, and releasing the one or more images through decryption of the block of encrypted data acquired from the remote location using the obtained unique entity code related to the entity associated with the image capture device.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, retrieving term data from a remote location, said term data corresponding to a term of service associated with a potential release of the one or more images that have previously been encrypted through use of the unique device code associated with the image capture device configured to capture the one or more images, calculating whether an estimated advertising revenue from one or more advertisement images placed in the one or more images of the block of encrypted data will be greater than an estimated potential liability for distribution of the one or more images of the block of encrypted data, said estimated potential liability at least partly based on the retrieved term data, modifying the one or more images of the block of encrypted data by replacing one or more areas associated with one or more entities at least partially depicted in the one or more images with the one or more advertisement images, and calculating a modified estimated advertising revenue from the modified one or more images of the block of encrypted data.

Referring again to the system, in an embodiment, a computationally-implemented method may include monitoring a deployment of a privacy beacon associated with a user, said privacy beacon configured to alert a wearable computer of one or more terms of service associated with said user in response to recordation of image data that includes said privacy beacon by said wearable computer, and said privacy beacon configured to instruct said wearable computer to execute one or more processes to impede transmission of the one or more images that include the user associated with said privacy beacon, and storing a record of the deployment of the privacy beacon associated with the user, said record configured to be retrieved upon request to confirm whether the privacy beacon associated with the user was active at a particular time.

Referring again to the system, in an embodiment, a computationally-implemented method may include receiving data regarding one or more features of one or more entities that are designated for protection by one or more terms of service, associating the one or more terms of service with a privacy beacon configured to be captured in an image when the one or more features of the one or more entities are captured in the image, and providing the terms of service to one or more media service providers associated with a device that captured an image that includes the privacy beacon, in response to receipt of an indication that an image that includes the privacy beacon has been captured.

Referring again to the system, in an embodiment, a computationally-implemented method may include acquiring one or more images that have previously been captured by an image capture device, wherein at least one of the one or more images includes at least one representation of a feature of one or more entities, identifying a first entity for which at least one representation of a first entity feature is present in the one or more images, and a second entity for which at least one representation of a second entity feature is present in the one or more images, obtaining data indicating that the first entity has a preexisting relationship with an entity associated with the image capture device, e.g., in a contact list, preventing an obfuscation of the representation of the first entity for which the preexisting relationship with the entity associated with the image capture device has been indicated, and obfuscating the representation of the second entity for which at least one representation of the second entity feature is present in the one or more images.

Referring again to the system, in an embodiment, a computationally-implemented method may include broadcasting a privacy beacon associated with at least one entity from a location of the at least one entity, said privacy beacon configured to be detected by an image capturing device upon capture of an image of the at least one entity, acquiring an indication that the privacy beacon associated with the at least one entity has been captured by the image capturing device, and broadcasting term data including one or more conditions and/or consequences of distribution of one or more images that depict at least a portion of the at least one entity.

Referring again to the system, in an embodiment, a computationally-implemented method may include acquiring a block of encrypted data corresponding to one or more images that have previously been encrypted through use of a unique device code associated with an image capture device configured to capture the one or more images, wherein at least one of the one or more images includes at least one representation of a feature of at least one entity, decrypting the block of encrypted data corresponding to the one or more images that have previously been encrypted through use of the unique device code associated with the image capture device configured to capture the one or more images, performing an operation to detect a presence of a privacy beacon associated with the at least one entity from the one or more images, wherein the privacy beacon previously had been detected by the image capture device, and storing outcome data corresponding an outcome of the operation to detect the presence of the privacy beacon associated with the at least one entity of the one or more images, wherein said outcome data includes an indication of whether a result of the performed operation to detect the presence of the privacy beacon associated with the at least one entity from the one or more images matches the previous detection of the privacy beacon by the image capture device.

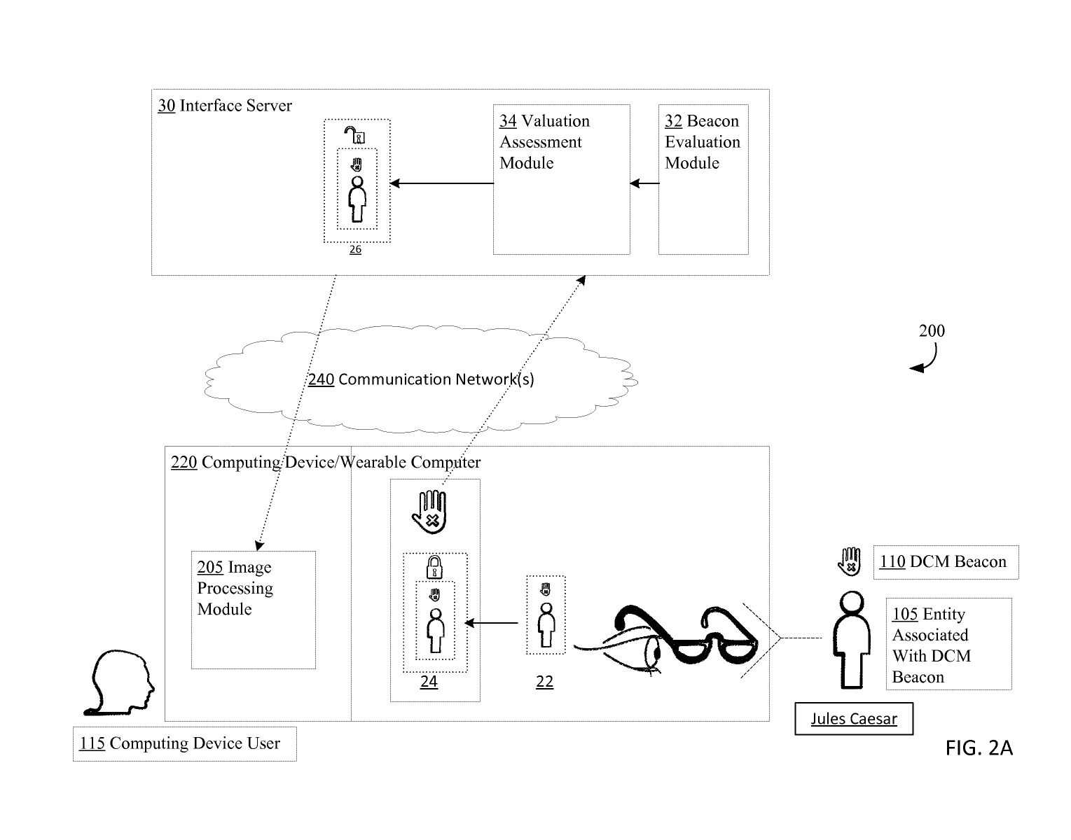

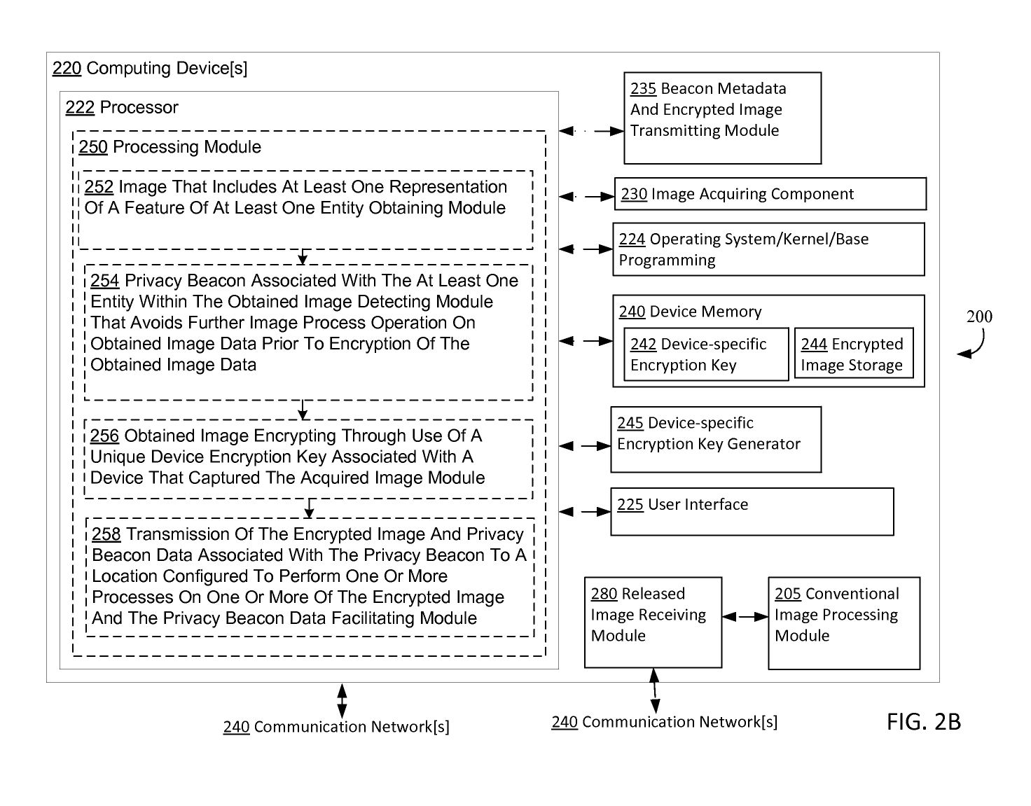

Referring now to FIG. 2, e.g., FIG. 2A, FIG. 2A illustrates an example environment 200 in which the methods, systems, circuitry, articles of manufacture, and computer program products and architecture, in accordance with various embodiments, may be implemented by one or more computing devices 220. As shown in FIG. 2A, one or more computing devices 220 may capture images. For example, computing device 220 may capture an image of an entity 105 associated with a privacy beacon, e.g., a DCM (“Don't Capture Me”) beacon 110. In this and some other examples, the captured entity is named “Jules Caesar.”

Referring again to FIG. 2A, computing device 220 may capture the image data as image data 22, which may be optical data, e.g., light data, digital data, e.g., a digital signal, or data in another form. In a process that will be discussed in more detail herein according to various embodiments, image data 22 may be encrypted using a device-specific code, shown here as encrypted image data 24. Encrypted image data 24 may be transmitted to an interface server 30, which may be a simplified example of wearable computer server 3000 shown in FIG. 1.

In an embodiment, interface server 30 may include a beacon evaluation module 32, which may analyze the DCM beacon 110. In an embodiment, such analysis may include obtaining term data, e.g., a terms of service associated with the user 105, e.g., Jules Caesar. In an embodiment, server 30 may include a valuation assessment module 34, which may determine a potential value of the captured image data 22, e.g., through advertisements, e.g., context-sensitive advertisements, or other advertisements, that may be shown and viewers drawn to the advertisements through use of the image data 22. In an embodiment, valuation assessment module 34 also may determine a potential risk in the form of liability for violation of personality rights associated with the image. In an embodiment, depending upon the result of valuation assessment module 34, the image data 22 may be decrypted into image data 26, and transmitted back to computing device 220. When the image data is transmitted back to computing device 220, it may then be accessed by other modules of the device, e.g., image processing module 205, and/or a user of the computing device 220.

In an embodiment, prior to encryption, transmission to the interface server 30, and receipt of the decrypted data 26, access to the captured image data 22 may be restricted. For example, in an embodiment, no other operations on the captured image data 22 are allowed. In another embodiment, some operations are allowed (e.g., viewing the image, editing the image), and some operations may be disallowed (e.g., saving the image, posting the image to a social network, e.g., Facebook).

Computing device 220 may be any electronic device, portable or not, that may be operated by or associated with one or more users. Computing device 220 is shown as interacting with a user 115. As set forth above, user 115 may be a person, or a group of people, or another entity that mimics the operations of a user. In an embodiment, user 115 may be a computer or a computer-controlled device. Computing device 220 may be, but is not limited to, a wearable computer. Computing device 220 may be any device that is equipped with an image capturing component, including, but not limited to, a cellular phone, a network phone, a smartphone, a tablet, a music player, a walkie-talkie, a radio, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

Referring now to FIG. 2B, FIG. 2B shows a detailed description of computing device 220, in an embodiment. It is noted that the components shown in FIG. 2B represent merely one embodiment of computing device 220, and any or all components other than processor 222 may be omitted, substituted, or modified, in various embodiments.

Referring again to FIG. 2B, user device 220 may include an image acquiring component 230. The image acquiring component 230 may be optical, digital, or a combination. Image acquiring component 230 may include one or more of a charge-coupled device (“CCD”), a complementary metal-oxide-semiconductor (“CMOS”) sensor, a hybrid infrared focal plane array (“IRFPA”), a passive-pixel sensor, an active-pixel sensor, an N-channel metal-oxide-semiconductor field-effect transistor (“MOSFET”) imager, a thin-film transistor (“TFT”) sensor, a planar Fourier capture array (“PFCA”), an oversampled binary image sensor, a photodiode, a colorimeter, a contact image sensor (“CIS”), an infrared sensor, a light-addressable potentiometric sensor, a fiber optic sensor, a photodetector, a phototransistor, a visible light photon counter, a wavefront sensor, a lens, a prism, a mirror, an analog image processor, and the like.

Referring again to FIG. 2B, computing device 220 may include an operating system/kernel/base programming 224. In this context, operating system 224 refers to any hardware, software, firmware, and combination thereof which is considered at the core or baseline of a device. For example, applications that interact directly with hardware may be considered to be part of an operating system. In an embodiment, operating system 224 may be an FPGA, printed circuit board, or other wired device. In an embodiment, operating system 224 may include one or more of Google's Android, Apple's iOS, Microsoft's Windows, various implementations of Linux, and the like. In an embodiment, operating system 224 may include a root menu for one or more televisions, stereo systems, media players, and the like. In an embodiment, operating system 224 may be a “home” or base screen of a device.

Referring again to FIG. 2B, computing device 220 may include a device memory 240. The device memory 240, in some embodiments, may store the device-specific encryption key 242, or data related to the device-specific encryption key. In an embodiment, there may be a set of device-specific encryption keys 242. In an embodiment, there may be a new device-specific encryption key 242 generated each time image data is captured, and that device-specific encryption key 242 may be stored in device memory 240. In an embodiment, device memory 240 may store the encrypted image in encrypted image storage 244. In another embodiment, the encrypted image may not be stored in memory 246.

In an embodiment, device memory 240 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 240 may be separated from the device, e.g., available on a different device on a network, or over the air. For example, in a networked system, there may be many computing devices 220 whose device memory 240 is located at a central server that may be a few feet away or located across an ocean. In an embodiment, computing device 220 may include a device memory 240. In an embodiment, memory 240 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 240 may be located at a single network site. In an embodiment, memory 240 may be located at multiple network sites, including sites that are distant from each other.

Referring again to FIG. 2B, in an embodiment, computing device 220 may include a device-specific encryption key generator 245. In an embodiment, device-specific encryption key generator 245 may generate one or more device-specific encryption keys 242. In an embodiment, a device-specific encryption key 242 may be generated based on received seed data that is randomized or pseudo-randomized (e.g., a calculation of the barometric pressure raised to an exponent of the temperature at the current time). In an embodiment, a device specific encryption key 242 may be generated each time image data is captured. In an embodiment, a device specific encryption key 242 may be generated using a portion of the image data as seed data for generating the device-specific encryption key 242. In an embodiment, device-specific encryption key generator 245 generates only one device-specific encryption key 242. In an embodiment, device-specific encryption key generator 245 may generate a device-specific encryption key 242 at least partly based on a device characteristic (e.g., a MAC address of the device).

Referring again to FIG. 2B, in an embodiment, computing device 220 may include a user interface 225. User interface 225 may include any hardware, software, firmware, and combination thereof that allow a user 115 to interact with a computing device 220, e.g., to supply an instruction to capture image data, and for the computing device 220 to interact with the user 115. In an embodiment, user interface 225 may include one or more of a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 2B, FIG. 2B shows a more detailed description of computing device 220. In an embodiment, computing device 220 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is shown as a single processor that is part of a single computing device 220, processor 222 may be multiple processors distributed over one or many computing devices 220, which may or may not be configured to operate together.

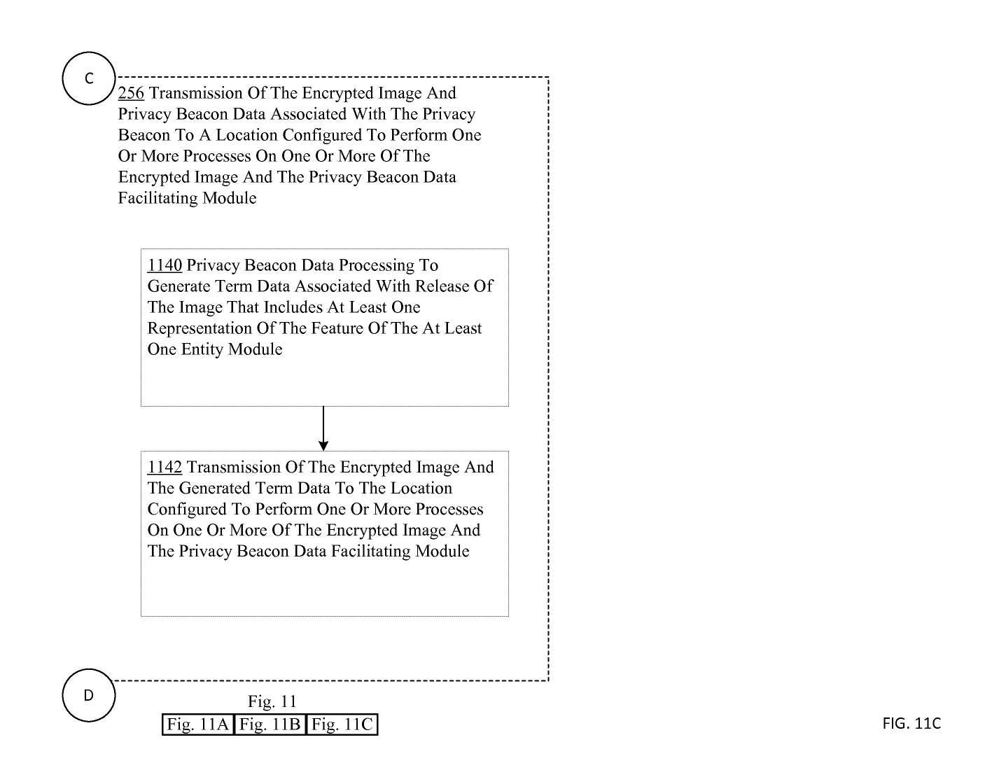

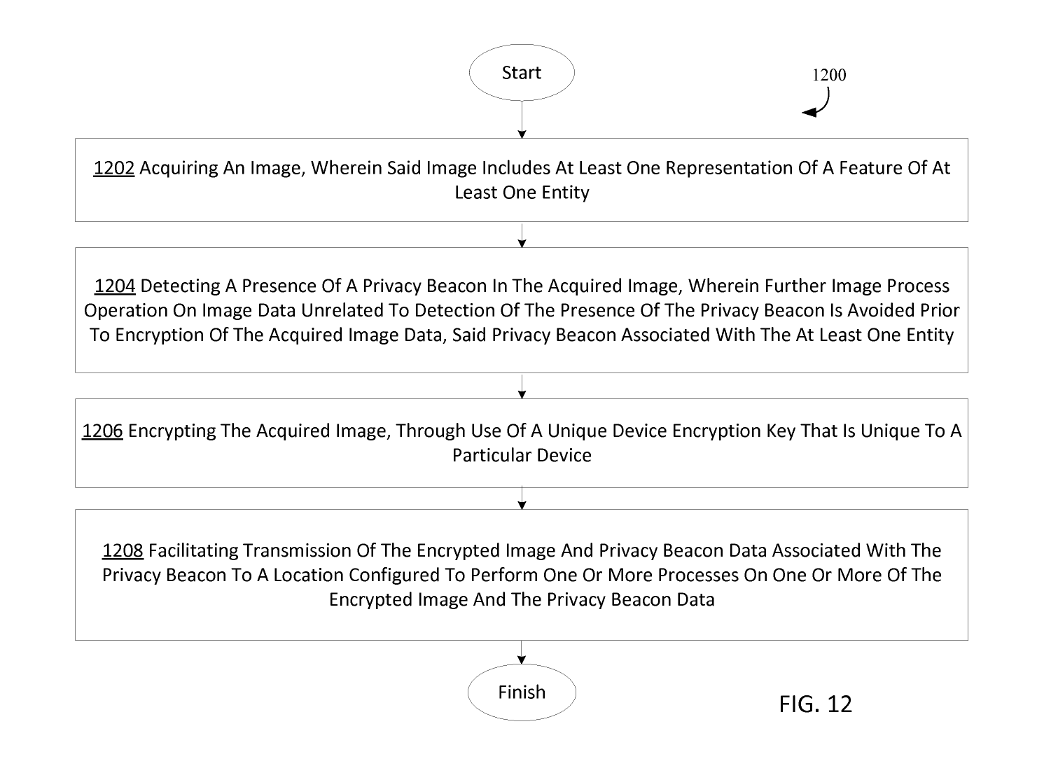

Processor 222 is illustrated as being configured to execute computer readable instructions in order to execute one or more operations described above, and as illustrated in FIGS. 12, 13A-13B, 14A-14G, 15A-15C, and 16A-16Q. In an embodiment, processor 222 is designed to be configured to operate as processing module 250, which may include one or more of image that includes at least one representation of a feature of at least one entity obtaining module 252, privacy beacon associated with the at least one entity within the obtained image detecting module that avoids further image process operation on obtained image data prior to encryption of the acquired image data 254, acquired image encrypting through use of a unique device encryption key associated with a device that captured the acquired image module 256, and transmission of the encrypted image and privacy beacon data associated with the privacy beacon to a location configured to perform one or more processes on one or more of the encrypted image and the privacy beacon data facilitating module 258.

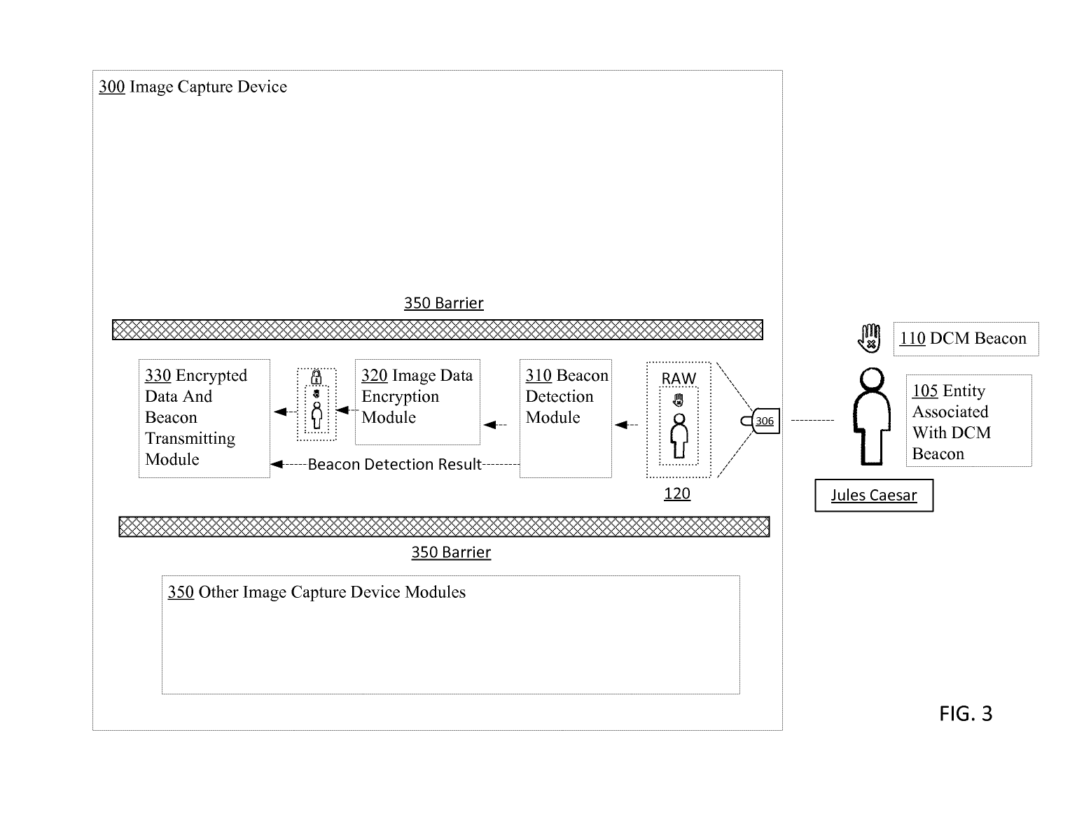

FIGS. 3-7 refer to an “image capture device,” which is defined as any device that is equipped with the ability to capture images, and not necessarily a wearable computer or a device designed specifically to capture images.

Referring now to FIG. 3, FIG. 3 shows an exemplary embodiment of a computing device 220 as image capture device 300. In an embodiment, image capture device 300 may include an image capture component, e.g., a lens 306. Image capture component 306 may capture an image including the user 105 and the DCM beacon 110, and capture that image as raw (optical or digital) data 120. In an embodiment, image capture device 300 may include beacon detection module 310 that is configured to detect DCM beacon 110, either optically, digitally, or other, depending on the embodiment. After detection of the beacon, the image data may be sent to an image data encryption module 320 to encrypt the image. In an embodiment, if the beacon is not detected, the image data is released past barrier 350 and the other image capture device modules 350 may operate on the image data 120. In an embodiment, the encrypted data, and data associated with the DCM beacon 110 (although not necessarily the beacon itself) may be transmitted to encrypted data and beacon transmitting module 330, which may transmit the encrypted data and beacon data to an external source, e.g., server 3000 as described in FIG. 1. It is noted that beacon detection module 310, image data encryption module 320, and encrypted data and beacon transmitting module 330 may be separated from other image capture device modules 350 by barrier 350.

In an embodiment, barrier 350 may be a physical barrier, e.g., beacon detection module 310, lens 306, image data encryption module 320, and encrypted data and beacon transmitting module 330 may be hard-wired to each other and electrically excluded from other image capture device modules 350. In another embodiment, barrier 350 may be implemented as a programmed barrier, e.g., the image data 120 is not transmitted to modules other than beacon detection module 310, lens 306, image data encryption module 320, and encrypted data and beacon transmitting module 330. In another embodiment, barrier 350 may be implemented as a data access barrier, e.g., the captured image data 120 may be protected, e.g., with an access or clearance level, so that only beacon detection 310, lens 306, image data encryption module 320, and encrypted data and beacon transmitting module 330 may read or operate on the image data 120. In another embodiment, barrier 350 may not be a complete barrier, e.g., barrier 350 may allow “read” access to the image data, but not “copy” or “write” access. In another embodiment, barrier 350 may be a barrier to transmission, e.g., the image may be viewed locally at the device, but may be barred from being saved to a removable memory, or uploaded to a cloud storage or social networking site/social media site.

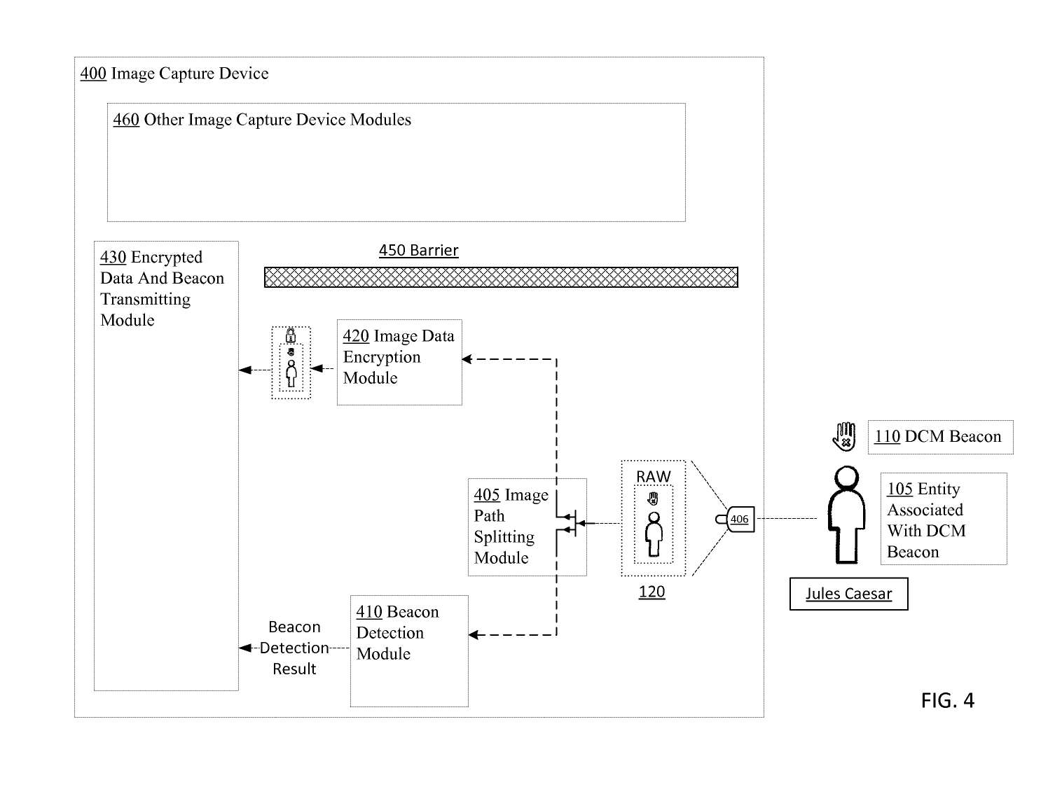

Referring now to FIG. 4, FIG. 4 shows an embodiment of a computing device 220 as image capture device 400. In an embodiment, image capture device 400 may include an image capture component, e.g., a lens and sensor 406. Image capture component 406 may capture an image including the user 105 and the DCM beacon 110, and capture that image as raw (optical or digital) data 120. In an embodiment, image capture device 400 may include image path splitting module 405 that may receive the raw data as a signal, e.g., optical or digital, and split the signal into two branches. As shown in FIG. 4, one branch, e.g., the north branch, sends the raw signal to image data encryption module 420, which may encrypt the image. In an embodiment, the other branch, e.g., the south branch, may send the signal to a beacon detection module 410, which may detect the DCM beacon 110. In an embodiment, if the DCM beacon 110 is detected, then the unencrypted image data that arrived at beacon detection module 410 is destroyed. In an embodiment, if the DCM beacon 110 is not detected, then the encrypted image data from image data encryption module 420 is destroyed, and the unencrypted image data at beacon detection module 410 is allowed to pass to other image capture device modules 460. In an embodiment, the beacon detection result and the encrypted image data are transmitted to the encrypted data and beacon transmitting module 430. In an embodiment, barrier 450 may separate image path splitting module 405, beacon detection module 410, image data encryption module 420, and encrypted data and beacon transmitting module 430 from other image capture device modules 460.

In an embodiment, barrier 450 may be a physical barrier, e.g., beacon detection module 410, lens 406, image data encryption module 420, and encrypted data and beacon transmitting module 430 may be hard-wired to each other and electrically excluded from other image capture device modules 450. In another embodiment, barrier 450 may be implemented as a programmed barrier, e.g., the image data 120 is not transmitted to modules other than image path splitting module 405, beacon detection 410, lens 406, image data encryption module 420, and encrypted data and beacon transmitting module 430. In another embodiment, barrier 450 may be implemented as a data access barrier, e.g., the captured image data may be protected, e.g., with an access or clearance level, so that only beacon detection 410, lens 306, image data encryption module 420, and encrypted data and beacon transmitting module 430 may read or operate on the image data 120 In another embodiment, barrier 450 may not be a complete barrier, e.g., barrier 450 may allow “read” access to the image data, but not “copy” or “write” access. In another embodiment, barrier 450 may be a barrier to transmission, e.g., the image may be viewed locally at the device, but may be barred from being saved to a removable memory, or uploaded to a cloud storage or social networking site/social media site.

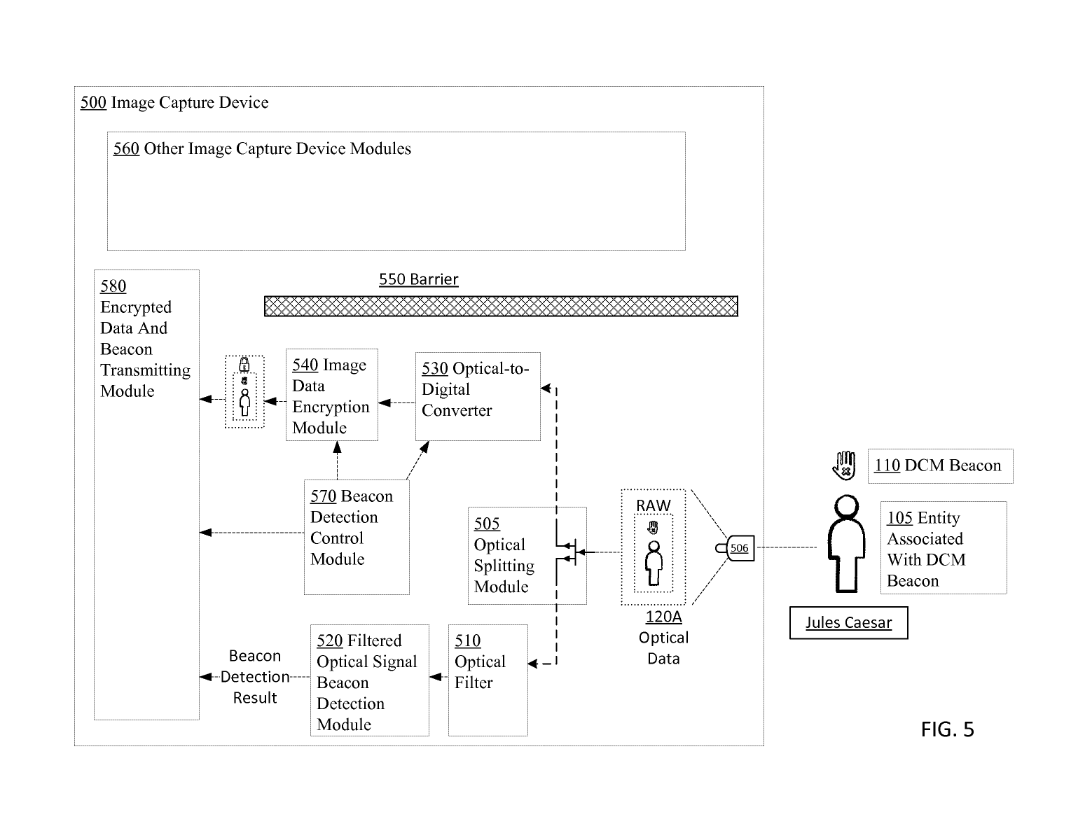

Referring now to FIG. 5, FIG. 5 shows an embodiment of a computing device 220 implemented as image capture device 500. In an embodiment, image capture device 500 may include an image capture component 506 that captures optical data 120A. In an embodiment, optical data 120A may be sent to optical splitting module 505, which may split the optical signal, e.g., the light, into two paths. Referring to FIG. 5, the “south” path may transmit the light to an optical filter 510, which may filter the light for a specific characteristic, e.g., a wavelength or an object, according to known optical filtration techniques. In an embodiment, the filtered optical signal may then be transmitted to a filtered optical signal beacon detection module 520, which may detect the beacon 110 in the optical data 120A.

Referring again to FIG. 5, the “north” path from optical splitting module 505 may transmit the optical image data to an optical-to-digital converter 530, e.g., a CMOS or CCD sensor. In an embodiment, the digital signal then may be transmitted to image data encryption module 540, and the encrypted data transmitted to encrypted data and beacon transmitting module 580, along with the beacon detection result, for transmission to an external source, e.g., server 3000 as shown in FIG. 1. In an embodiment, barrier 550 may prevent access to the unencrypted image data by other image capture device modules 560. In an embodiment, barrier 550 may function similarly to barrier 350 and 450, and the descriptions of those barriers and their possible implementations also may apply to barrier 550. In an embodiment, image data encryption module 540, encrypted data beacon and transmitting module 580, and optical-to-digital converter 530 may be controlled by beacon detection control module 570, which may be part of the processor of image capture device 500, or may be a separate processor. In an embodiment, beacon detection control module 570 may form part or all of processor 222 of computing device 220 of FIG. 2B.

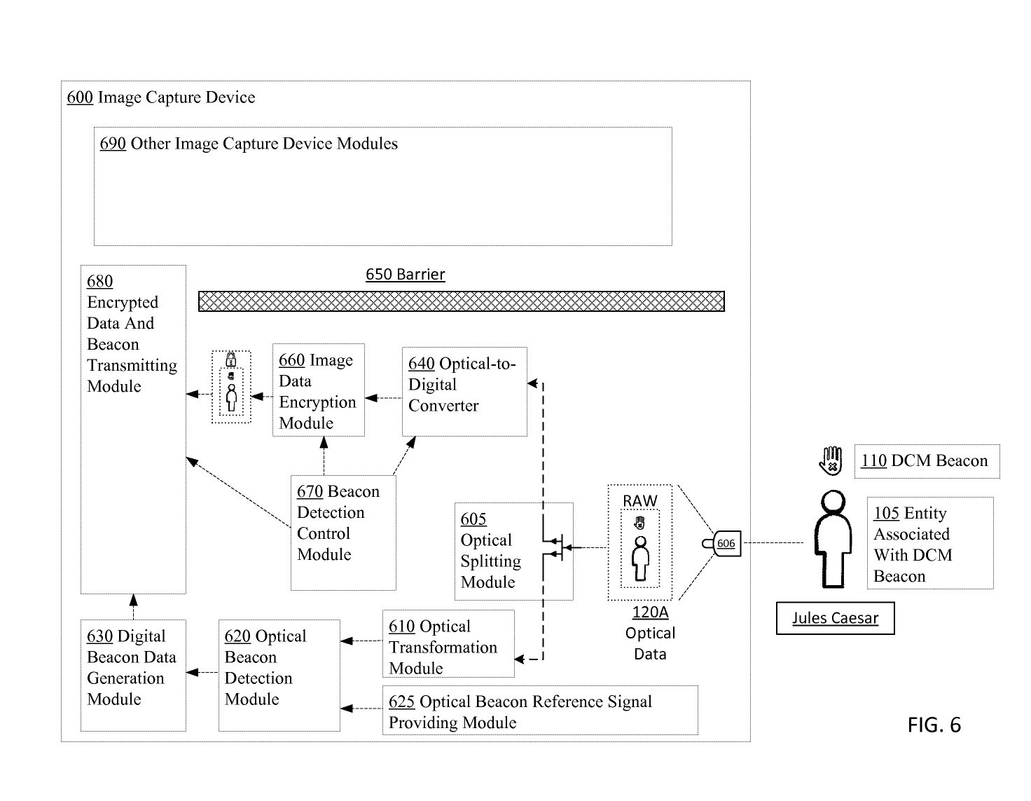

Referring now to FIG. 6, FIG. 6 shows an exemplary implementation of a computing device 220 implemented as image capture device 600, according to an embodiment. Image capture device 600 may include an optical image collector 606 that may capture an image including the user 105 and the DCM beacon 110, and capture that image as optical data 120A. Optical data 120A may then be sent to optical splitting module 605, which may split the optical signal, e.g., the light, into two paths. Referring to FIG. 6, the “south” path may transmit the light to an optical transformation module 610, which may apply a transformation, e.g., a Fourier transformation to the optical image data. The transformed optical data from module 610, as well as a reference image from optical beacon reference signal providing module 625 may be transmitted to optical beacon detection module 620. Optical beacon detection module 620 may be an optical component, e.g., a diffraction grating, one or more lenses and mirrors, or any combination thereof, which may be configured to optically detect the beacon using one or more wave transformations, e.g., one or more Fourier transformations and an optical correlator. The basic operation of performing optical image object detection is described in the publically-available (at the University of Michigan Online Library) paper “Report of Project MICHIGAN, SIGNAL DETECTION BY COMPLEX SPATIAL FILTERING,” by A. B. Vander Lugt, printed in July 1963 at the Radar Laboratory at the Institute of Science and Technology, the University of Michigan, which is hereby incorporated by reference in its entirety. Applicant's representative is including a copy of this paper with the filing of this application, for the convenience of the Examiner.

Referring again to FIG. 6, the “north” path from optical splitting module 605 may transmit the optical image data to an optical-to-digital converter 640, e.g., a CMOS or CCD sensor. In an embodiment, the digital signal then may be transmitted to image data encryption module 660, and the encrypted data transmitted to encrypted data and beacon transmitting module 680, along with the beacon detection result, for transmission to an external source, e.g., server 3000 as shown in FIG. 1. In an embodiment, barrier 650 may prevent access to the unencrypted image data by other image capture device modules 690. In an embodiment, barrier 650 may function similarly to barrier 350 and 450, and the descriptions of those barriers and their possible implementations also may apply to barrier 650. In an embodiment, image data encryption module 660, encrypted data and beacon transmitting module 680, and optical-to-digital converter 640 may be controlled by beacon detection control module 670, which may be part of the processor of image capture device 600, or may be a separate processor. In an embodiment, beacon detection control module 670 may form part or all of processor 222 of computing device 220 of FIG. 2B.

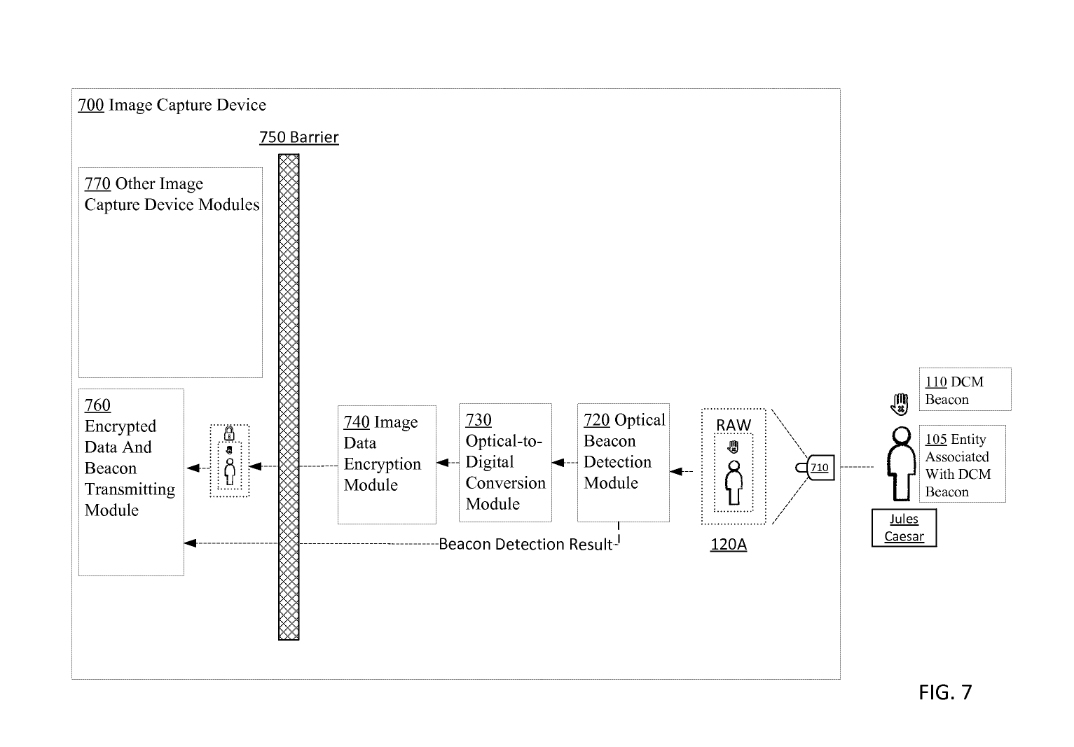

Referring now to FIG. 7, FIG. 7 shows an exemplary embodiment of an implementation of computing device 220 as image capture device 700. In an embodiment, image capture device 700 may include an optical image collector 710, e.g., a lens, which may collect the optical data 120A. Optical data 120A may be emitted to an optical beacon detection module 720, which may detect the DCM beacon 110 using one of the above-described optical detection methods. After detection of the beacon using optical techniques, the optical signal may be captured by an optical-to-digital conversion module 730, and converted to digital image data, which is transferred to image data encryption module 740 for encryption. In an embodiment, modules 710, 720, 730, and 740, are hard-wired to each other, and separated from encrypted data and beacon transmitting module 760 and other image capture device modules 770 by barrier 750 (which, in this embodiment, is shown for exemplary purposes only, because the physical construction of modules 710, 720, 730, and 740 removes the need for an actual barrier 750, whether implemented as hardware, programming, security, or access. In this embodiment, the image data is encrypted prior to interaction with the “main” portions of image capture device 700, and after the beacon data has been optically detected.

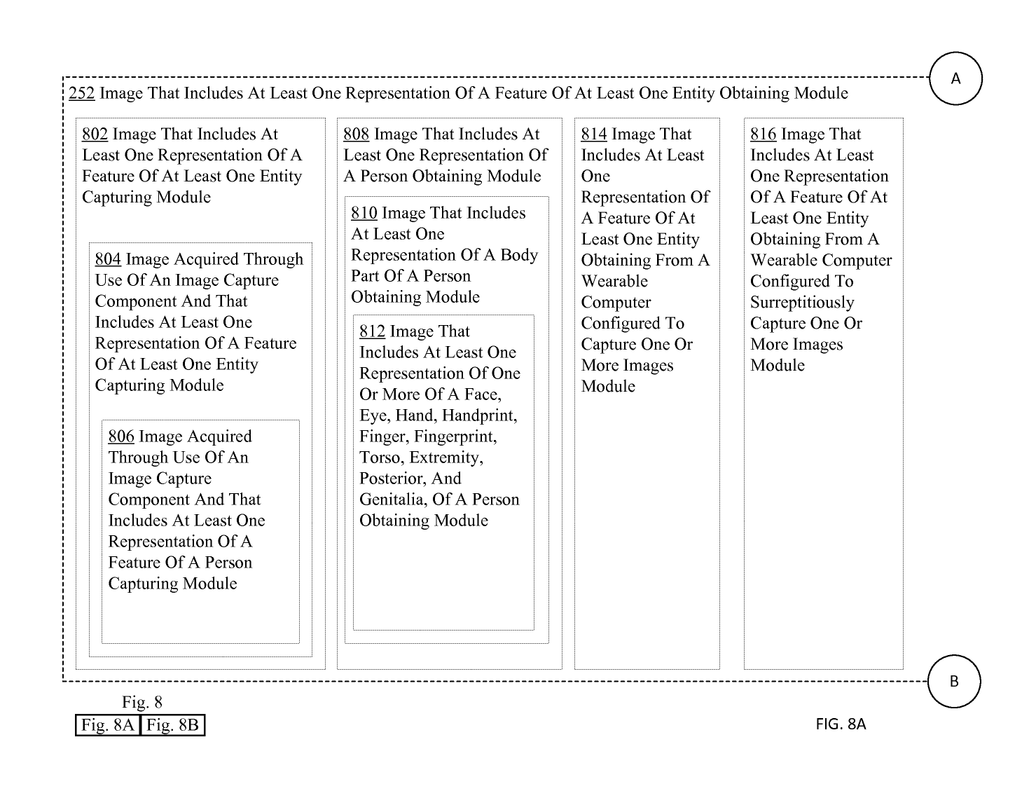

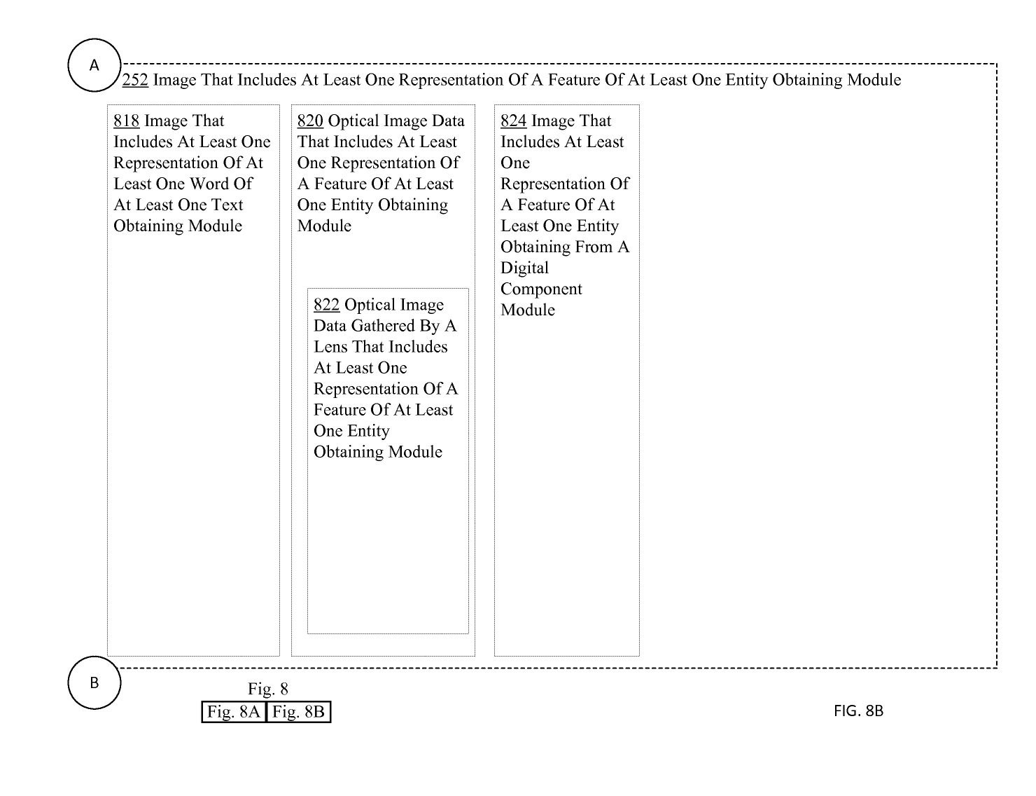

Referring now to FIG. 8, FIG. 8 illustrates an exemplary implementation of the image that includes at least one representation of a feature of at least one entity obtaining module 252. As illustrated in FIG. 8, the image that includes at least one representation of a feature of at least one entity obtaining module may include one or more sub-logic modules in various alternative implementations and embodiments. For example, as shown in FIG. 8, e.g., FIG. 8A, in an embodiment, module 252 may include one or more of image that includes at least one representation of a feature of at least one entity capturing module 802, image that includes at least one representation of a person obtaining module 808, image that includes at least one representation of a feature of at least one entity obtaining from a wearable computer configured to capture one or more images module 814, and image that includes at least one representation of a feature of at least one entity obtaining from a wearable computer configured to surreptitiously capture one or more images module 816. In an embodiment, module 802 may include image acquired through use of an image capture component and that includes at least one representation of a feature of at least one entity capturing module 804. In an embodiment, module 804 may include image acquired through use of an image capture component and that includes at least one representation of a feature of a person capturing module 806. In an embodiment, module 808 may include image that includes at least one representation of a body part of a person obtaining module 810. In an embodiment, module 810 may include image that includes at least one representation of one or more of a face, eye, hand, handprint, finger, fingerprint, torso, extremity, posterior, and genitalia, of a person obtaining module 812.

Referring again to FIG. 8, e.g., FIG. 8B, in an embodiment, module 252 may include one or more of image that includes at least one representation of at least one word of at least one text obtaining module 818, optical image data that includes at least one representation of a feature of at least one entity obtaining module 820, and image that includes at least one representation of a feature of at least one entity obtaining from a digital component module 824. In an embodiment, module 820 may include optical image data gathered by a lens that includes at least one representation of a feature of at least one entity obtaining module 822.

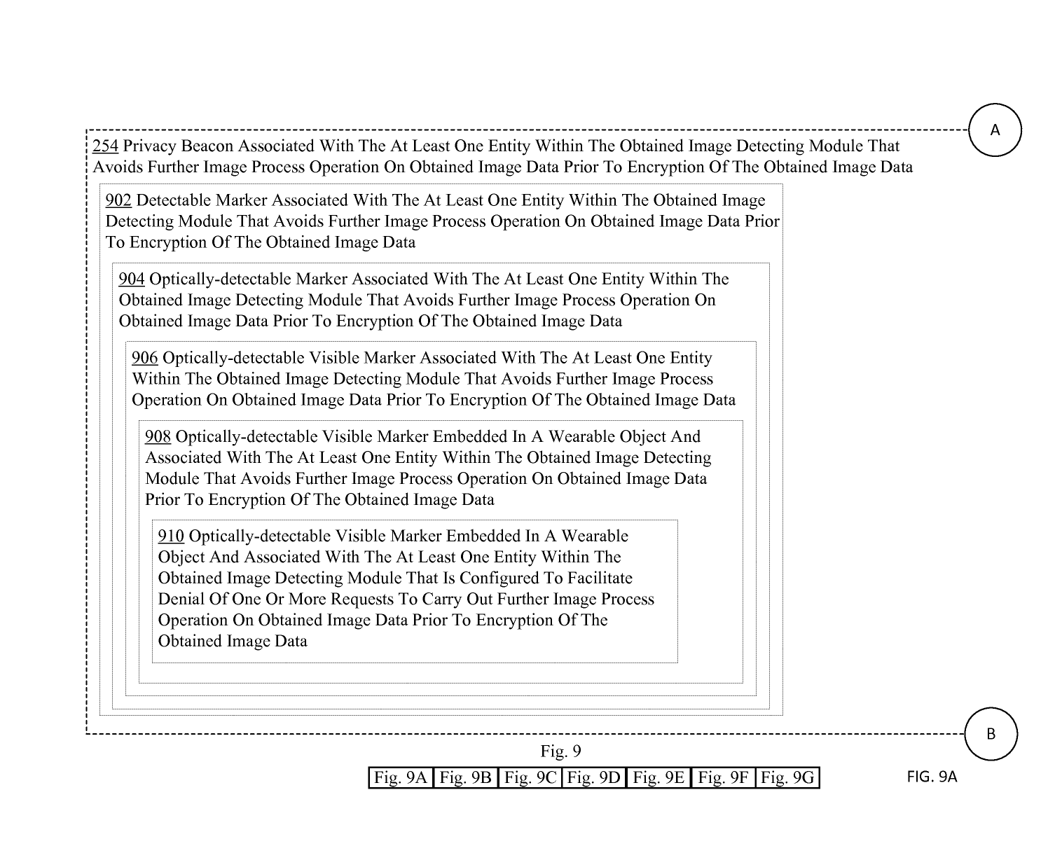

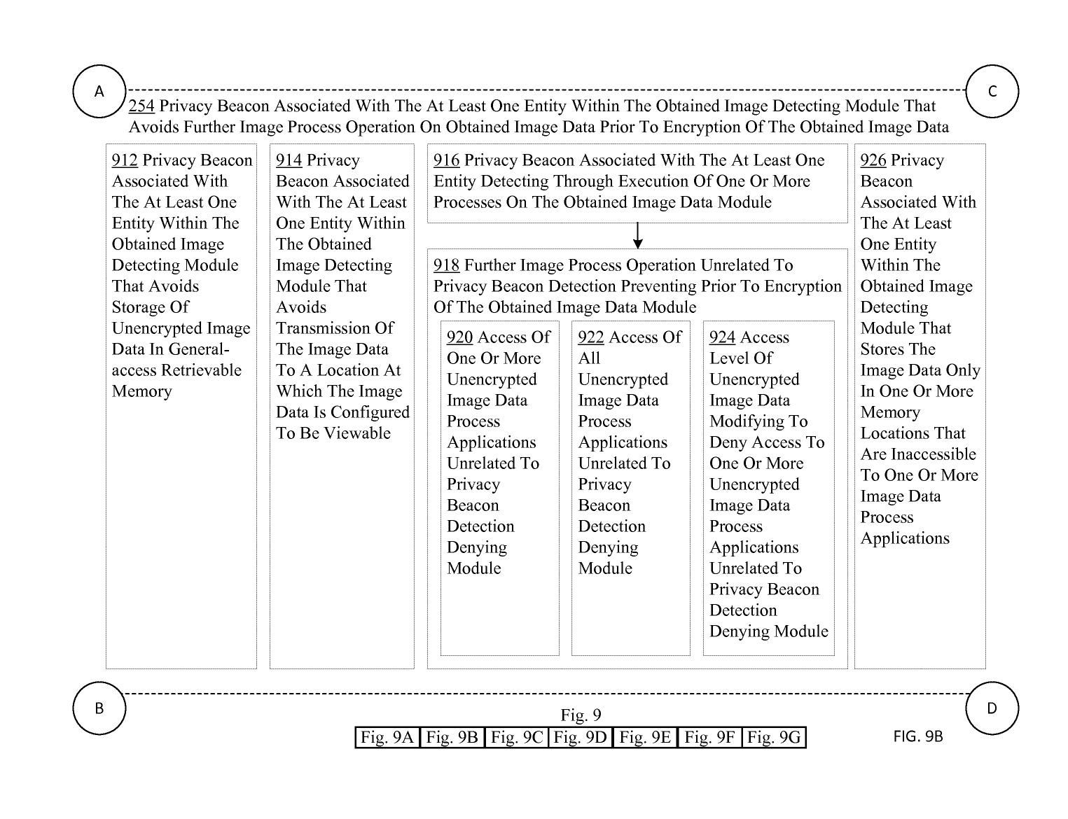

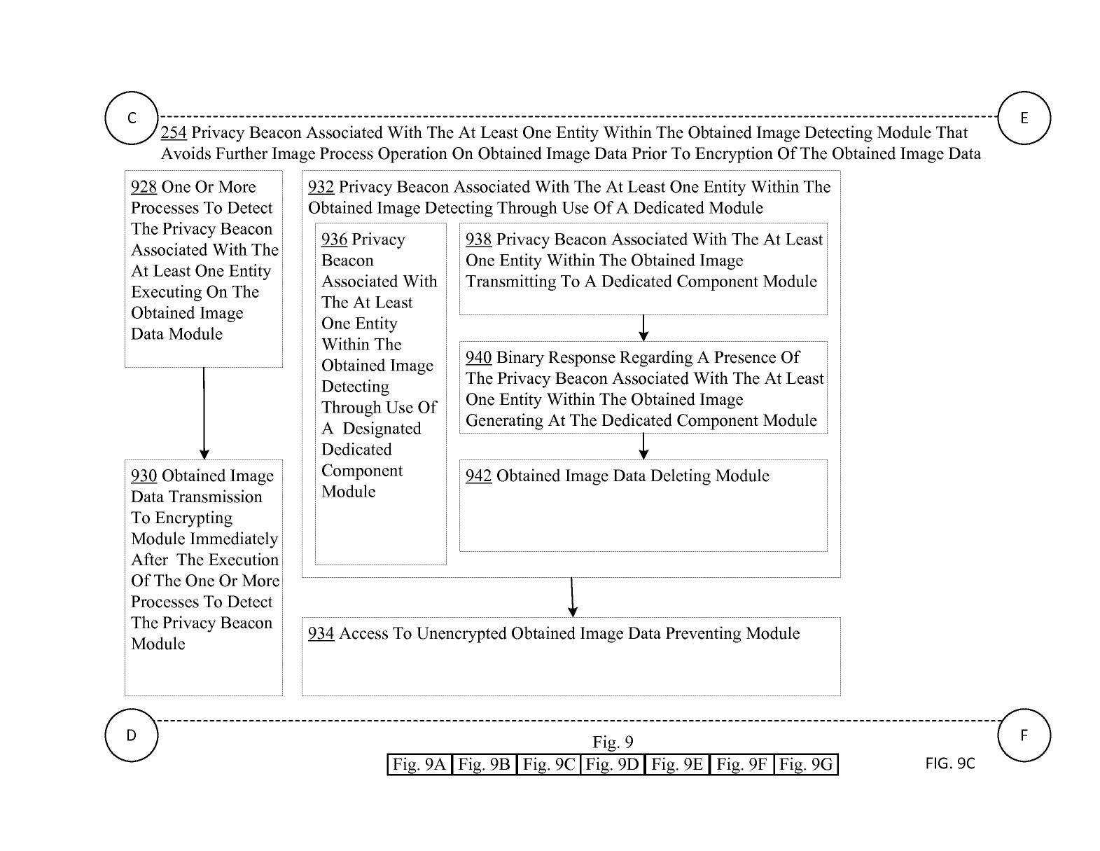

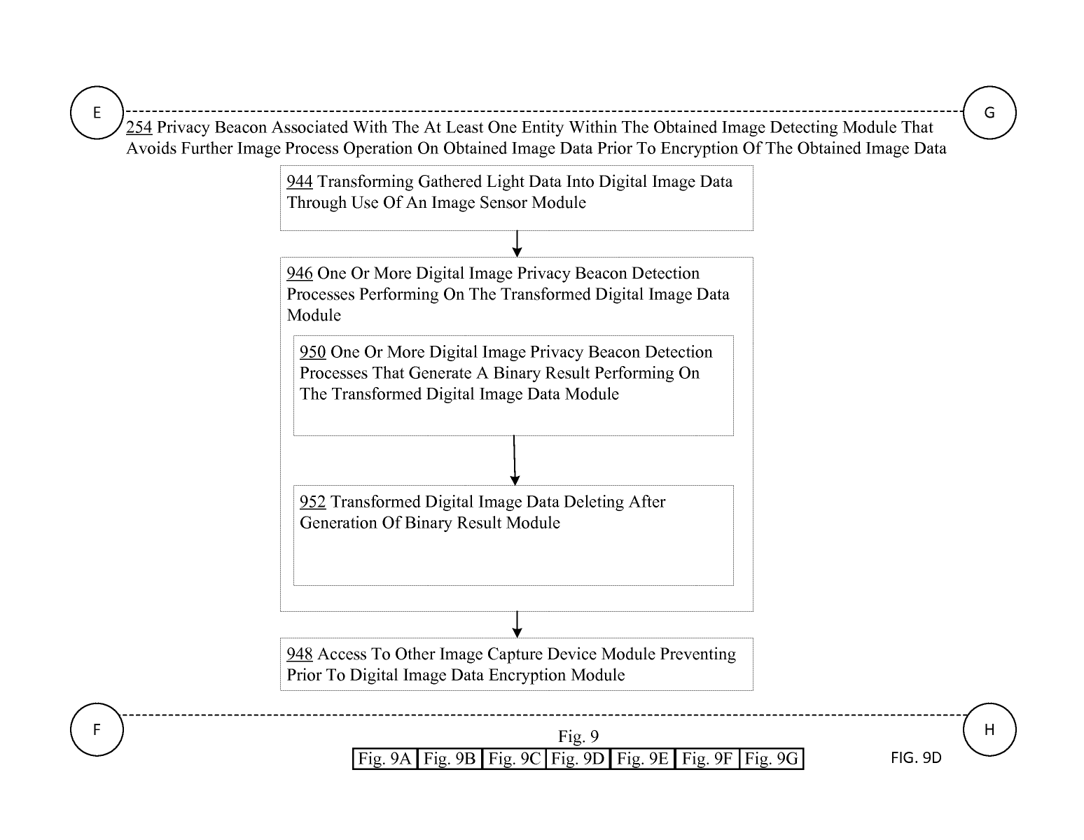

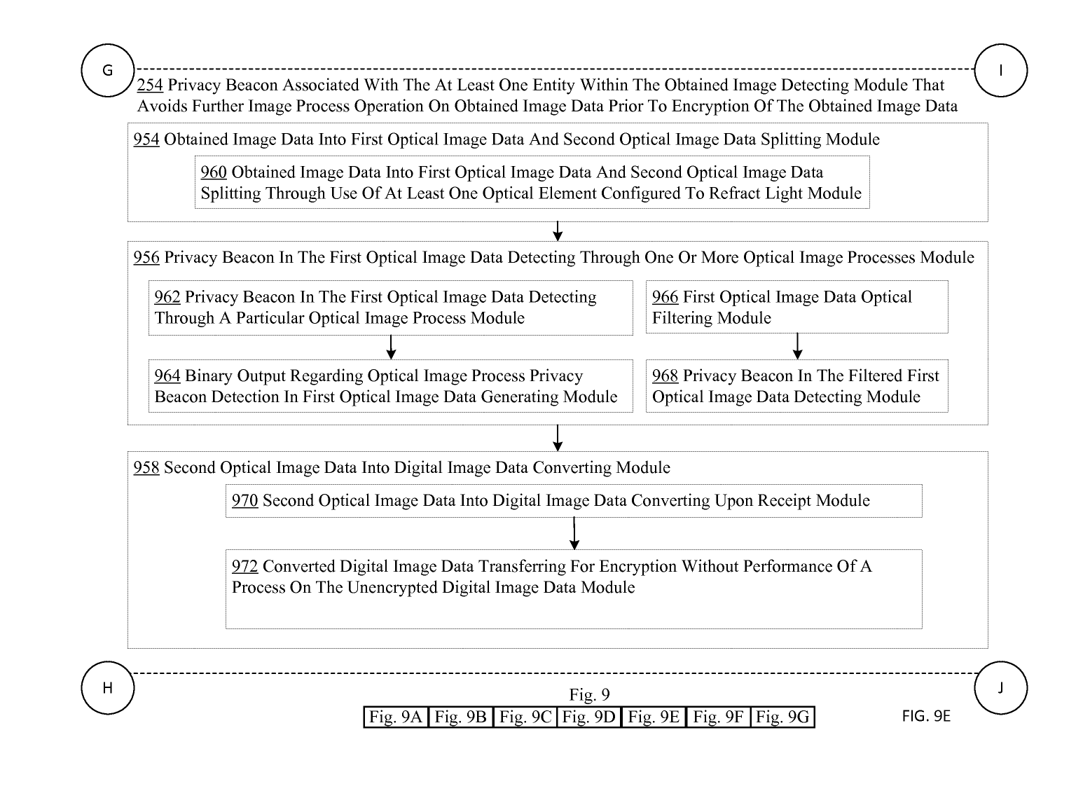

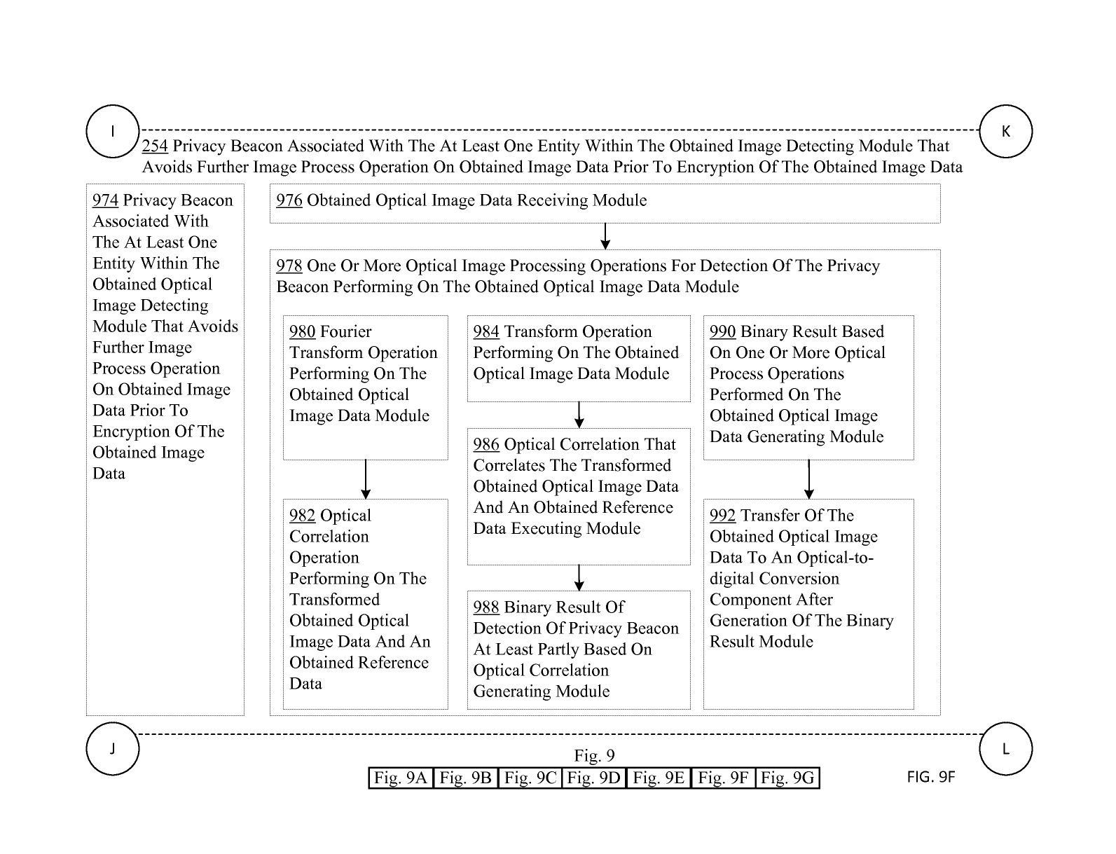

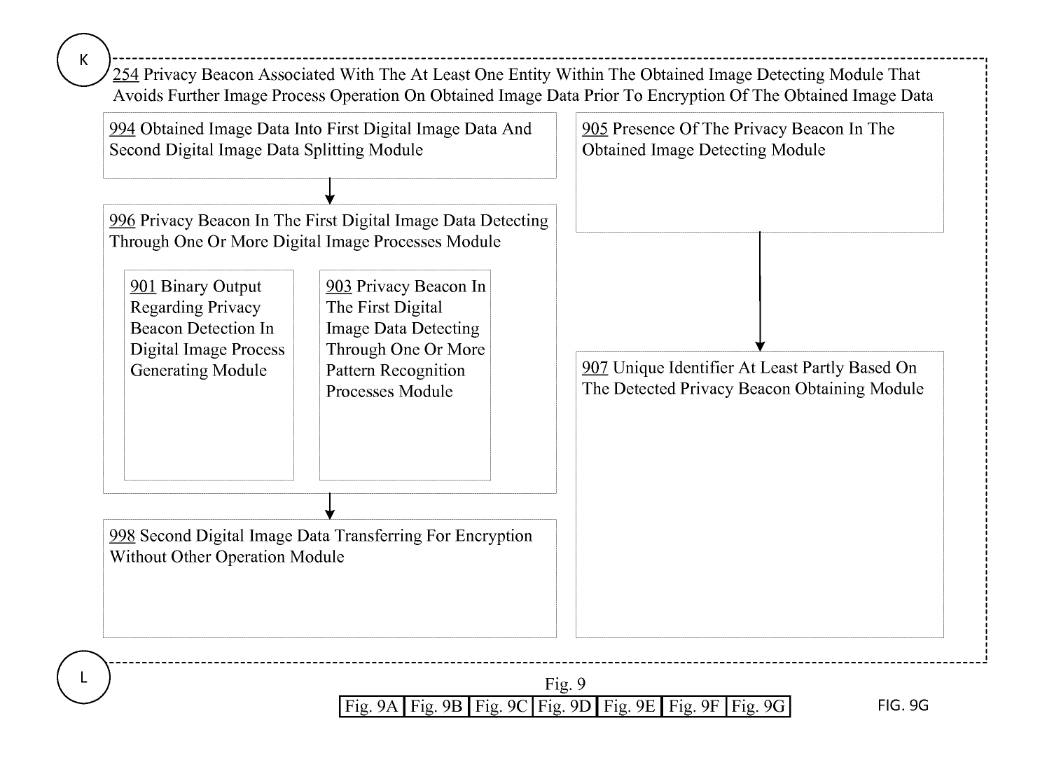

Referring now to FIG. 9, FIG. 9 illustrates an exemplary implementation of privacy beacon associated with the at least one entity within the obtained image detecting module that avoids further image process operation on obtained image data prior to encryption of the acquired image data 254. As illustrated in FIG. 9, the privacy beacon associated with the at least one entity within the obtained image detecting module that avoids further image process operation on obtained image data prior to encryption of the acquired image data 254 may include one or more sub-logic modules in various alternative implementations and embodiments. For example, as shown in FIG. 9, e.g., FIG. 9A, in an embodiment, module 254 may include detectable marker associated with the at least one entity within the obtained image detecting module that avoids further image process operation on obtained image data prior to encryption of the obtained image data 902. In an embodiment, module 902 may include optically-detectable marker associated with the at least one entity within the obtained image detecting module that avoids further image process operation on obtained image data prior to encryption of the obtained image data 904. In an embodiment, module 904 may include optically-detectable visible marker associated with the at least one entity within the obtained image detecting module that avoids further image process operation on obtained image data prior to encryption of the obtained image data 906. In an embodiment, module 906 may include optically-detectable visible marker embedded in a wearable object and associated with the at least one entity within the obtained image detecting module that avoids further image process operation on obtained image data prior to encryption of the obtained image data 908. In an embodiment, module 908 may include optically-detectable visible marker embedded in a wearable object and associated with the at least one entity within the obtained image detecting module that is configured to facilitate denial of one or more requests to carry out further image process operation on obtained image data prior to encryption of the obtained image data 910.

Referring again to FIG. 9, e.g., FIG. 9B, as described above, in an embodiment, module 254 may include one or more of privacy beacon associated with the at least one entity within the obtained image detecting module that avoids storage of unencrypted image data in general-access retrievable memory 912, privacy beacon associated with the at least one entity within the obtained image detecting module that avoids transmission of the image data to a location at which the image data is configured to be viewable 914, privacy beacon associated with the at least one entity detecting through execution of one or more processes on the obtained image data module 916, further image process operation unrelated to privacy beacon detection preventing prior to encryption of the obtained image data module 918, and privacy beacon associated with the at least one entity within the obtained image detecting module that stores the image data only in one or more memory locations that are inaccessible to one or more image data process applications 926. In an embodiment, module 918 may include one or more of access of one or more unencrypted image data process applications unrelated to privacy beacon detection denying module 920, access of all unencrypted image data process applications unrelated to privacy beacon detection denying module 922, and access level of unencrypted image data modifying to deny access to one or more unencrypted image data process applications unrelated to privacy beacon detection denying module 924.

Referring again to FIG. 9, e.g., FIG. 9C, in an embodiment, module 254 may include one or more of one or more processes to detect the privacy beacon associated with the at least one entity executing on the obtained image data module 928, obtained image data transmission to encrypting module immediately after the execution of the one or more processes to detect the privacy beacon module 930, privacy beacon associated with the at least one entity within the obtained image detecting through use of a dedicated module 932, and access to unencrypted obtained image data preventing module 934. In an embodiment, module 932 may include one or more of privacy beacon associated with the at least one entity within the obtained image detecting through use of a designated dedicated component module 936, privacy beacon associated with the at least one entity within the obtained image transmitting to a dedicated component module 938, binary response regarding a presence of the privacy beacon associated with the at least one entity within the obtained image generating at the dedicated component module 940, and obtained image data deleting module 942.

Referring again to FIG. 9, e.g., FIG. 9D, in an embodiment, module 254 may include one or more of transforming gathered light data into digital image data through use of an image sensor module 944, one or more digital image privacy beacon detection processes performing on the transformed digital image data module 946, and access to other image capture device module preventing prior to digital image data encryption module 948. In an embodiment, module 946 may include one or more of one or more digital image privacy beacon detection processes that generate a binary result performing on the transformed digital image data module 950 and transformed digital image data deleting after generation of binary result module 952.

Referring again to FIG. 9, e.g., FIG. 9E, in an embodiment, module 254 may include one or more of obtained image data into first optical image data and second optical image data splitting module 954, privacy beacon in the first optical image data detecting through one or more optical image processes module 956, and second optical image data into digital image data converting module 958. In an embodiment, module 954 may include obtained image data into first optical image data and second optical image data splitting through use of at least one optical element configured to refract light module 960. In an embodiment, module 956 may include one or more of privacy beacon in the first optical image data detecting through a particular optical image process module 962, binary output regarding optical image process privacy beacon detection in first optical image data generating module 964, first optical image data optical filtering module 966, and privacy beacon in the filtered first optical image data detecting module 968. In an embodiment, module 958 may include one or more of second optical image data into digital image data converting upon receipt module 970 and converted digital image data transferring for encryption without performance of a process on the unencrypted digital image data module 972.

Referring again to FIG. 9, e.g., FIG. 9F, in an embodiment, module 254 may include one or more of privacy beacon associated with the at least one entity within the obtained optical image detecting module that avoids further image process operation on obtained image data prior to encryption of the obtained image data 974, obtained optical image data receiving module 976, and one or more optical image processing operations for detection of the privacy beacon performing on the obtained optical image data module 978. In an embodiment, module 978 may include one or more of Fourier transform operation performing on the obtained optical image data module 980, optical correlation operation performing on the transformed obtained optical image data and an obtained reference data 982, transform operation performing on the obtained optical image data module 984, optical correlation that correlates the transformed obtained optical image data and an obtained reference data executing module 986, binary result of detection of privacy beacon at least partly based on optical correlation generating module 988, binary result based on one or more optical process operations performed on the obtained optical image data generating module 990, and transfer of the obtained optical image data to an optical-to-digital conversion component after generation of the binary result module 992.

Referring again to FIG. 9, e.g., FIG. 9G, in an embodiment, module 254 may include one or more of obtained image data into first digital image data and second digital image data splitting module 994, privacy beacon in the first digital image data detecting through one or more digital image processes module 996, second digital image data transferring for encryption without other operation module 998, presence of the privacy beacon in the obtained image detecting module 905, and unique identifier at least partly based on the detected privacy beacon obtaining module 907. In an embodiment, module 996 may include one or more of binary output regarding privacy beacon detection in digital image process generating module 901 and privacy beacon in the first digital image data detecting through one or more pattern recognition processes module 903.

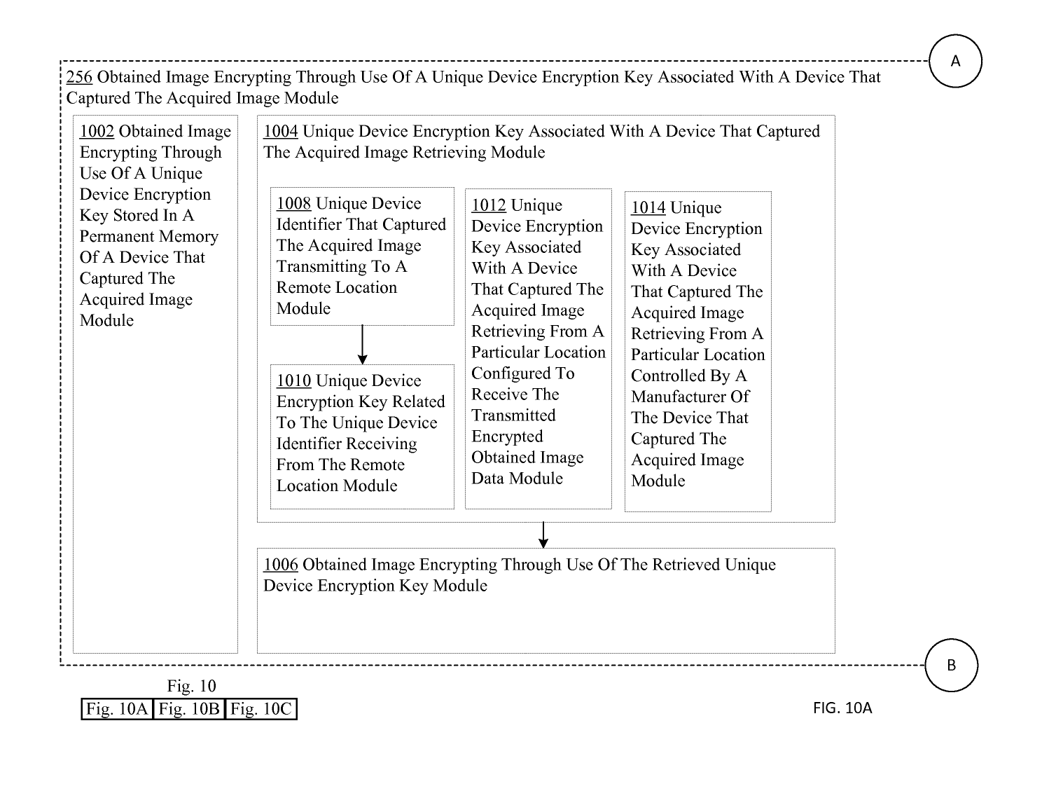

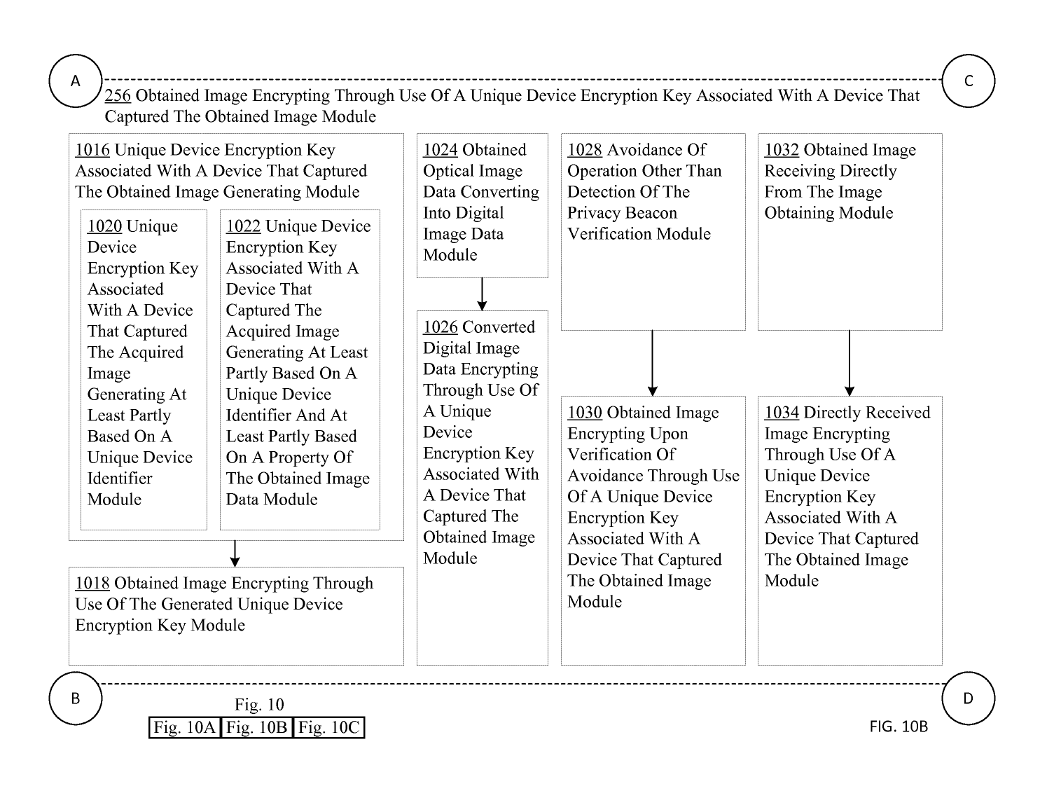

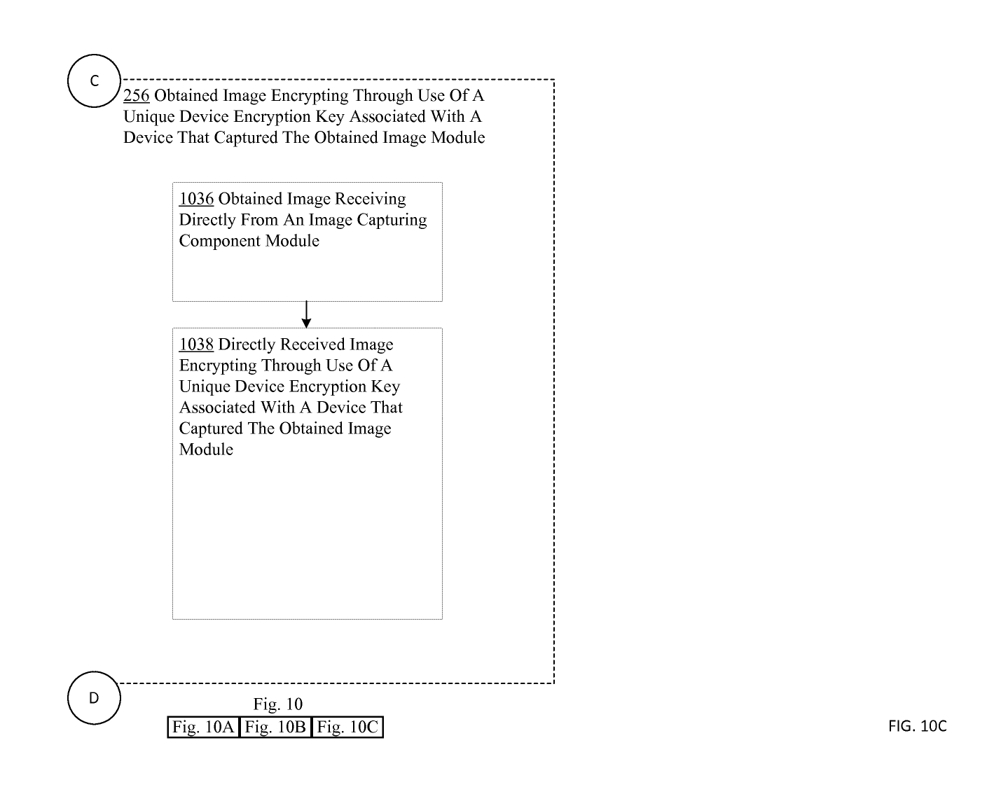

Referring now to FIG. 10, FIG. 10 illustrates an exemplary implementation of acquired image encrypting through use of a unique device encryption key associated with a device that captured the acquired image module 256. As illustrated in FIG. 10, the acquired image encrypting through use of a unique device encryption key associated with a device that captured the acquired image module 256 may include one or more sub-logic modules in various alternative implementations and embodiments. For example, as shown in FIG. 10, e.g., FIG. 10A, in an embodiment, module 256 may include one or more of obtained image encrypting through use of a unique device encryption key stored in a permanent memory of a device that captured the acquired image module 1002, unique device encryption key associated with a device that captured the acquired image retrieving module 1004, and obtained image encrypting through use of the retrieved unique device encryption key module 1006. In an embodiment, module 1004 may include one or more of unique device identifier that captured the acquired image transmitting to a remote location module 1008, unique device encryption key related to the unique device identifier receiving from the remote location module 1010, unique device encryption key associated with a device that captured the acquired image retrieving from a particular location configured to receive the transmitted encrypted obtained image data module 1012, and unique device encryption key associated with a device that captured the acquired image retrieving from a particular location controlled by a manufacturer of the device that captured the acquired image module 1014.

Referring again to FIG. 10, e.g., FIG. 10B, in an embodiment, module 256 may include one or more of unique device encryption key associated with a device that captured the obtained image generating module 1016, obtained image encrypting through use of the generated unique device encryption key module 1018, obtained optical image data converting into digital image data module 1024, converted digital image data encrypting through use of a unique device encryption key associated with a device that captured the obtained image module 1026, avoidance of operation other than detection of the privacy beacon verification module 1028, obtained image encrypting upon verification of avoidance through use of a unique device encryption key associated with a device that captured the obtained image module 1030, obtained image receiving directly from the image obtaining module 1032, and directly received image encrypting through use of a unique device encryption key associated with a device that captured the obtained image module 1034. In an embodiment, module 1016 may include one or more of unique device encryption key associated with a device that captured the acquired image generating at least partly based on a unique device identifier module 1020 and unique device encryption key associated with a device that captured the acquired image generating at least partly based on a unique device identifier and at least partly based on a property of the obtained image data module 1022.

Referring again to FIG. 10, e.g., FIG. 10C, in an embodiment, module 256 may include one or more of obtained image receiving directly from an image capturing component module 1036 and directly received image encrypting through use of a unique device encryption key associated with a device that captured the obtained image module 1038.

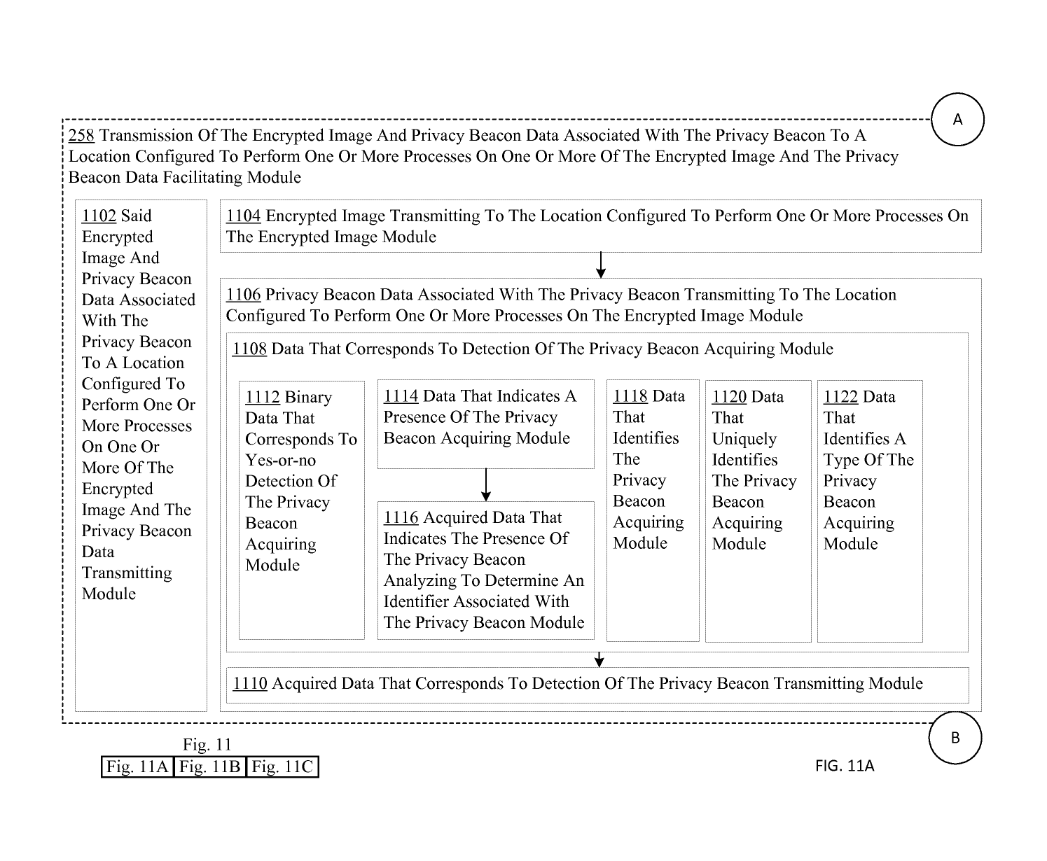

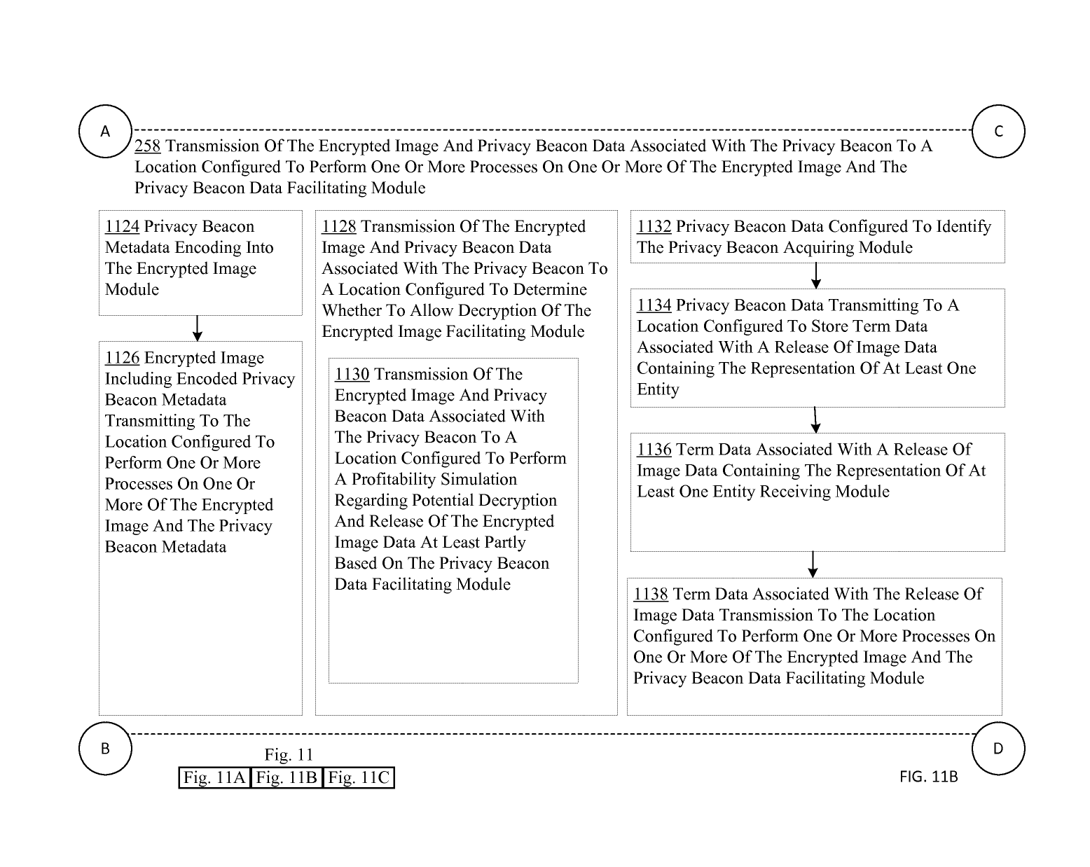

Referring now to FIG. 11, FIG. 11 illustrates an exemplary implementation of transmission of the encrypted image and privacy beacon data associated with the privacy beacon to a location configured to perform one or more processes on one or more of the encrypted image and the privacy beacon data facilitating module 258. As illustrated in FIG. 11, the transmission of the encrypted image and privacy beacon data associated with the privacy beacon to a location configured to perform one or more processes on one or more of the encrypted image and the privacy beacon data facilitating module 258 may include one or more sub-logic modules in various alternative implementations and embodiments. For example, as shown in FIG. 11, e.g., FIG. 11A, in an embodiment, module 258 may include one or more of said encrypted image and privacy beacon data associated with the privacy beacon to a location configured to perform one or more processes on one or more of the encrypted image and the privacy beacon data transmitting module 1102, encrypted image transmitting to the location configured to perform one or more processes on the encrypted image module 1104, and privacy beacon data associated with the privacy beacon transmitting to the location configured to perform one or more processes on the encrypted image module 1106. In an embodiment, module 1106 may include one or more of data that corresponds to detection of the privacy beacon acquiring module 1108 and acquired data that corresponds to detection of the privacy beacon transmitting module 1110. In an embodiment, module 1108 may include one or more of binary data that corresponds to yes-or-no detection of the privacy beacon acquiring module 1112, data that indicates a presence of the privacy beacon acquiring module 1114, acquired data that indicates the presence of the privacy beacon analyzing to determine an identifier associated with the privacy beacon module 1116, data that identifies the privacy beacon acquiring module 1118, data that uniquely identifies the privacy beacon acquiring module 1120, and data that identifies a type of the privacy beacon acquiring module 1122.

Referring again to FIG. 11, e.g., FIG. 11B, in an embodiment, module 258 may include one or more of privacy beacon metadata encoding into the encrypted image module 1124, encrypted image including encoded privacy beacon metadata transmitting to the location configured to perform one or more processes on one or more of the encrypted image and the privacy beacon metadata 1126, transmission of the encrypted image and privacy beacon data associated with the privacy beacon to a location configured to determine whether to allow decryption of the encrypted image facilitating module 1128, privacy beacon data configured to identify the privacy beacon acquiring module 1132, privacy beacon data transmitting to a location configured to store term data associated with a release of image data containing the representation of at least one entity 1134, term data associated with a release of image data containing the representation of at least one entity receiving module 1136, and term data associated with the release of image data transmission to the location configured to perform one or more processes on one or more of the encrypted image and the privacy beacon data facilitating module 1138. In an embodiment, module 1128 may include transmission of the encrypted image and privacy beacon data associated with the privacy beacon to a location configured to perform a profitability simulation regarding potential decryption and release of the encrypted image data at least partly based on the privacy beacon data facilitating module 1130.

Referring again to FIG. 6, e.g., FIG. 6C, in an embodiment, module 258 may include one or more of privacy beacon data processing to generate term data associated with release of the image that includes at least one representation of the feature of the at least one entity module 1140 and transmission of the encrypted image and the generated term data to the location configured to perform one or more processes on one or more of the encrypted image and the privacy beacon data facilitating module 1142.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

It is noted that “indicator” and “indication” can refer to many different things, including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds)), which may appear alone or in any combination of the delineations listed above.

Further, in FIG. 12 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 12-16 as well as the other operations to be described herein may be performed by at least one of a machine, an article of manufacture, or a composition of matter.

Referring now to FIG. 12, FIG. 12 shows operation 1200, e.g., an example operation of computing device 220 operating in an environment 200. In an embodiment, operation 1200 may include operation 1202 depicting acquiring an image, wherein said image includes at least one representation of a feature of at least one entity. For example, FIG. 2, e.g., FIG. 2B, shows image that includes at least one representation of a feature of at least one entity obtaining module 252 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) an image (e.g., a representation of electrons, photons, or other particles that, in a particular arrangement, stimulate a sensory receptor of an entity, either living or computerized), wherein said image (e.g., picture, photo, likeness, print, copy, assemblage, mosaic, cartoon, caricature, diagram, tracing, arrangement, and draft) includes at least one representation (e.g., pixels, photons, other building blocks of an image) of a feature (e.g., a smaller part of the whole, e.g., a word of a sentence, a page of a book, a gear of a device, an arm of a person, a smile of a person, etc.) of at least one entity (e.g., a person, machine, book, screen, text, and the like).

Referring again to FIG. 12, operation 1200 may include operation 1204 depicting detecting a presence of a privacy beacon in the acquired image, wherein further image process operation on image data unrelated to detection of the presence of the privacy beacon is avoided prior to encryption of the acquired image data, said privacy beacon associated with the at least one entity. For example, FIG. 2, e.g., FIG. 2B, shows privacy beacon associated with the at least one entity within the obtained image detecting module that avoids further image process operation on obtained image data prior to encryption of the acquired image data 254 detecting a presence of a privacy beacon (e.g., a marker detectable by some sensor or other action, which may be passive, active, visible or invisible, may operate on the electromagnetic spectrum or in another field, a partial list of which is included below) in the acquired image (e.g., a representation of an external form of a thing, person, or entity), wherein further image process operation (e.g., any type of image processing, e.g., photo manipulation, saving, storing, uploading to social media, emailing, saving to removable storage, and the like) unrelated to (e.g., not designed to be in furtherance of, whether directly or indirectly) the detection of the presence of the privacy beacon (e.g., a marker detectable by some sensor or other action, which may be passive, active, visible or invisible, may operate on the electromagnetic spectrum or in another field, a partial list of which is included below) is avoided (e.g., prevented, bypassed, intercepted, stopped, ignored, put off, delayed, denied, etc.) prior to encryption of the acquired image data, said privacy beacon associated with (e.g., connected to in some manner, e.g., aware of, set into motion by, intending of, etc.) at least one entity (e.g., a person or thing).

Referring again to FIG. 12, operation 1200 may include operation 1206 depicting encrypting the acquired image, through use of a unique device encryption key that is unique to a particular device. For example, FIG. 2, e.g., FIG. 2B, acquired image encrypting through use of a unique device encryption key associated with a device that captured the acquired image module 256 encrypting (e.g., performing one or more processes with the intention of preventing or delaying unauthorized access) the acquired image (e.g., the representation of an external form of a thing, person, or entity), through use of a unique (e.g., no other device shares it) device encryption key (e.g., a piece of information, data, parameter, bound, seed, etc., that at least partially determines the functional output of a cryptographic algorithm or cipher) that is unique to a particular device (e.g., any device capable of capturing images, or that is in communication with any device that is capable of capturing images).

Referring again to FIG. 12, operation 1200 may include operation 1208 depicting facilitating transmission of the encrypted image and privacy beacon data associated with the privacy beacon to a location configured to perform one or more processes on one or more of the encrypted image and the privacy beacon data. For example, FIG. 2, e.g., FIG. 2B, shows transmission of the encrypted image and privacy beacon data associated with the privacy beacon to a location configured to perform one or more processes on one or more of the encrypted image and the privacy beacon data facilitating module 258 facilitating (e.g., taking one or more steps to assist in the furtherance of, whether successful or not, including actions that record steps or create other steps, and actions that ultimately result in an unintended result) transmission of the encrypted image (e.g., the representation of an external form of a thing, person, or entity) and privacy beacon data (e.g., data that is related to, based on, or has some connection to the privacy beacon associated with the entity) associated with the privacy beacon (e.g., a marker detectable by some sensor or other action, which may be passive, active, visible or invisible, may operate on the electromagnetic spectrum or in another field, a partial list of which is included below) to a location (e.g., another computer, a same computer but a different component, or a same, but re-purposed component, a server, an entity controlling a server, a network, a network location, and the like) configured to perform one or more processes (e.g., one or more actions or steps) on (e.g., related to, as input, subject, or object of) one or more of the encrypted image (e.g., the representation of an external form of a thing, person, or entity) and privacy beacon data (e.g., data that is related to, based on, or has some connection to the privacy beacon associated with the entity).

A privacy beacon may include, but is not limited to, one or more of a marker that reflects light in a visible spectrum, a marker that reflects light in a nonvisible spectrum, a marker that emits light in a visible spectrum, a marker that emits light in a nonvisible spectrum, a marker that emits a radio wave, a marker that, when a particular type of electromagnetic wave hits it, emits a particular electromagnetic wave, an RFID tag, a marker that uses near-field communication, a marker that is in the form of a bar code, a marker that is in the form of a bar code and painted on a user's head and that reflects light in a nonvisible spectrum, a marker that uses high frequency low penetration radio waves (e.g., 60 GHz radio waves), a marker that emits a particular thermal signature, a marker that is worn underneath clothing and is detectable by an x-ray-type detector, a marker that creates a magnetic field, a marker that emits a sonic wave, a marker that emits a sonic wave at a frequency that cannot be heard by humans, a marker that is tattooed to a person's bicep and is detectable through clothing, a marker that is a part of a user's cellular telephone device, a marker that is broadcast by a part of a user's cellular telephone device, a marker that is broadcast by a keychain carried by a person, a marker mounted on a drone that maintains a particular proximity to the person, a marker mounted in eyeglasses, a marker mounted in a hat, a marker mounted in an article of clothing, the shape of the person's face is registered as the beacon, a feature of a person registered as the beacon, a marker displayed on a screen, a marker in the form of an LED, a marker embedded on a page, or a book, a string of text or data that serves as a marker, a marker embedded or embossed onto a device, and the like.

FIGS. 13A-13B depict various implementations of operation 1202, depicting acquiring an image, wherein said image includes at least one representation of a feature of at least one entity according to embodiments. Referring now to FIG. 13A, operation 1202 may include operation 1302 depicting capturing the image, wherein said image includes at least one representation of a feature of at least one entity. For example, FIG. 8, e.g., FIG. 8A shows image that includes at least one representation of a feature of at least one entity capturing module 802 capturing (e.g., collecting light, electrons, or other expressible representations of) the image (e.g., the video, still frame, picture, drawing, or other visually-stimulating representation), wherein said image includes at least one representation (e.g., pixels, photons, or other units of) of a feature (e.g., a face) of at least one entity (e.g., a person).

Referring again to FIG. 13A, operation 1302 may include operation 1304 depicting capturing the image through use of an image capture component, wherein said image includes at least one representation of a feature of at least one entity. For example, FIG. 8, e.g., FIG. 8A, shows image acquired through use of an image capture component and that includes at least one representation of a feature of at least one entity capturing module 804 capturing the image (e.g., a still frame of a thirty-second video) through use of an image capture component (e.g., a CMOS sensor), wherein said image includes at least one representation (e.g., 47 flesh-colored pixels) of a feature (e.g., a head-and-shoulders shot) of at least one entity (e.g., a person, e.g., a picture of Brad Pitt buying an egg sandwich).

Referring again to FIG. 13A, operation 1304 may include operation 1306 depicting capturing an image through use of an image capture component, wherein said image includes at least one representation of a feature of a person. For example, FIG. 8, e.g., FIG. 8A, shows image acquired through use of an image capture component and that includes at least one representation of a feature of a person capturing module 806 capturing an image (e.g., a photo of someone walking down the street taken by a person wearing a Google Glass device) through use of an image capture component (e.g., a digital image sensor), wherein said image (e.g., a full body picture of a person walking) includes at least one representation of a feature of a person.

Referring again to FIG. 13A, operation 1202 may include operation 1308 depicting acquiring the image, wherein said image includes at least one representation of a person. For example, FIG. 8, e.g., FIG. 8A, shows image that includes at least one representation of a person obtaining module 808 acquiring the image (e.g., a photo of a person taken by an automated teller machine (“ATM”) camera, wherein said image (e.g., a black-and-white image of a person's face) includes at least one representation (e.g., a grayscale pixilation) of a person.

Referring again to FIG. 13A, operation 1308 may include operation 1310 depicting acquiring the image, wherein said image includes at least one bodily feature of the person. For example, FIG. 8, e.g., FIG. 8A, shows image that includes at least one representation of a body part of a person obtaining module 810 acquiring the image, wherein said image includes at least one bodily feature (e.g., fingerprint, handprint, retina, face, facial characteristic (e.g., distance between eyes, facial symmetry measurement, skin texture analysis, etc.), body analysis, hair analysis, limb analysis) of the person (e.g., the person captured by a vehicle-mounted camera).

Referring again to FIG. 13A, operation 1310 may include operation 1312 depicting acquiring the image, wherein said image includes one or more of a face, eye, hand, handprint, finger, fingerprint, torso, extremity, posterior, and genitalia of a person. For example, FIG. 8, e.g., FIG. 8A, shows image that includes at least one representation of one or more of a face, eye, hand, handprint, finger, fingerprint, torso, extremity, posterior, and genitalia, of a person obtaining module 812 acquiring the image, wherein said image includes one or more of a face, eye, hand, handprint, finger, fingerprint, torso, extremity, posterior, and genitalia of a person (e.g., a person whose image is captured by a store security camera when they walk into a pharmacy.

Referring again to FIG. 13A, operation 1202 may include operation 1314 depicting capturing an image through use of a wearable computer, wherein said image includes at least one representation of the feature of at least one entity. For example, FIG. 8, e.g., FIG. 8A, shows image that includes at least one representation of a feature of at least one entity obtaining from a wearable computer configured to capture one or more images module 814 capturing an image (e.g., a still photo of a person that is having dinner with the wearable computer wearer) through use of a wearable computer (e.g., Google Glass), wherein said image includes at least one representation (e.g., digital image) of the feature (e.g., a head-and-shoulders direct-on view of the face) of at least one entity (e.g., the person having dinner with the wearable computer wearer).

Referring again to FIG. 13A, operation 1202 may include operation 1316 depicting capturing the image through use of a wearable computer, wherein said image includes at least one representation of the feature of at least one entity, and wherein the image is captured without knowledge of the at least one entity. For example, FIG. 8, e.g., FIG. 8A, shows image that includes at least one representation of a feature of at least one entity obtaining from a wearable computer configured to surreptitiously capture one or more images module 816 capturing the image (e.g., a picture of a person sitting at an airport, using a laptop) through use of a wearable computer (e.g., a hat-mounted camera that is linked to a person's cellular telephone device and that relies on the cellular telephone device for at least some processing), wherein said image includes at least one representation (e.g., a digitized image) of the feature of (e.g., the screen of laptop being used by) at least one entity (e.g., the person holding the laptop), and wherein the image is captured without knowledge of the at least one entity (e.g., the person holding the laptop at the airport does not realize that his image has been captured, because the camera is not obviously working (e.g., even if it is visible, it is not apparent that it is on, or it may always be on)).

Referring now to FIG. 13B, operation 1202 may include operation 1318 depicting acquiring an image that includes text, wherein said image includes one or more words that are a feature of the text. For example, FIG. 8, e.g., FIG. 8B, shows image that includes at least one representation of at least one word of at least one text obtaining module 818 acquiring an image (e.g., a screenshot taken of a teller's computer terminal at a bank) that includes text (e.g., account balances and access codes), wherein said image includes one or more words (e.g., “Balance,” “5,000 dollars”) that are a feature of the text (e.g., the text on the screen regarding account balances and access codes).

Referring again to FIG. 13B, operation 1202 may include operation 1320 depicting receiving optical data that contains an image, wherein said image includes at least one representation of a feature of at least one entity. For example, FIG. 8, e.g., FIG. 8B, shows optical image data that includes at least one representation of a feature of at least one entity obtaining module 820 receiving optical data (e.g., light data) that contains an image (e.g., the light data is configured to stimulate the visual cortex of a living human), wherein said image (e.g., a picture of a guy urinating in public on a golf course) includes at least one representation (e.g., a profile view) of a feature (e.g., the person's body) of at least one entity (e.g., the person urinating on the golf course).

Referring again to FIG. 13B, operation 1320 may include operation 1322 depicting receiving optical data that travelled through a lens, wherein said optical data contains an image that includes at least one representation of a feature of at least one entity. For example, FIG. 8, e.g., FIG. 8B, shows optical image data gathered by a lens that includes at least one representation of a feature of at least one entity obtaining module 822 receiving optical data that traveled through a lens (e.g., an image capturing lens. e.g., lens 506 of FIG. 5), wherein said optical data contains an image (e.g., the light data is configured to stimulate the visual cortex of a living human) that includes at least one representation (e.g., photons) of a feature (e.g., a fingerprint) of at least one entity (e.g., a person that holds her fingers up to a camera for a staged photo).

Referring again to FIG. 13B, operation 1202 may include operation 1324 depicting receiving digital image data, wherein said digital image data includes at least one representation of a feature of at least one entity. For example, FIG. 8, e.g., FIG. 8B, shows image that includes at least one representation of a feature of at least one entity obtaining from a digital component module 824 receiving digital image data (e.g., electrons that represent pixels), wherein said digital image data includes at least one representation (e.g., an unobscured picture of a famous woman topless) of a feature (e.g., the famous woman's breasts) of at least one entity (e.g., the famous woman).

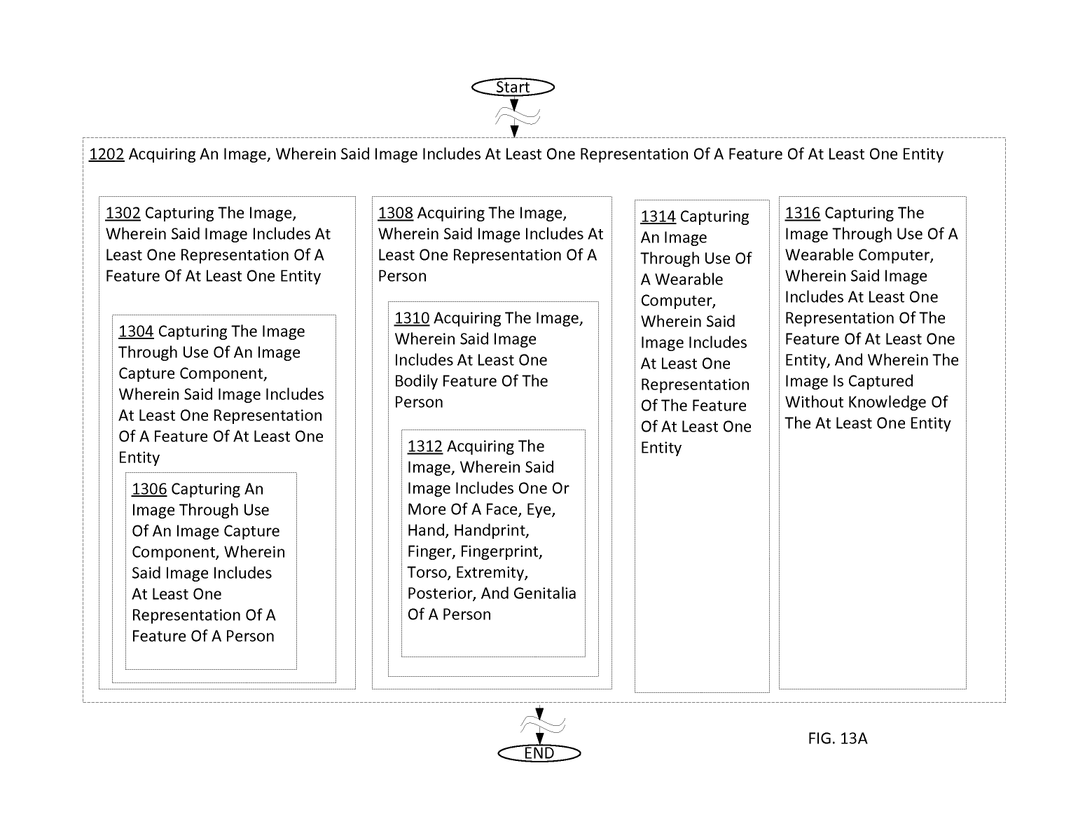

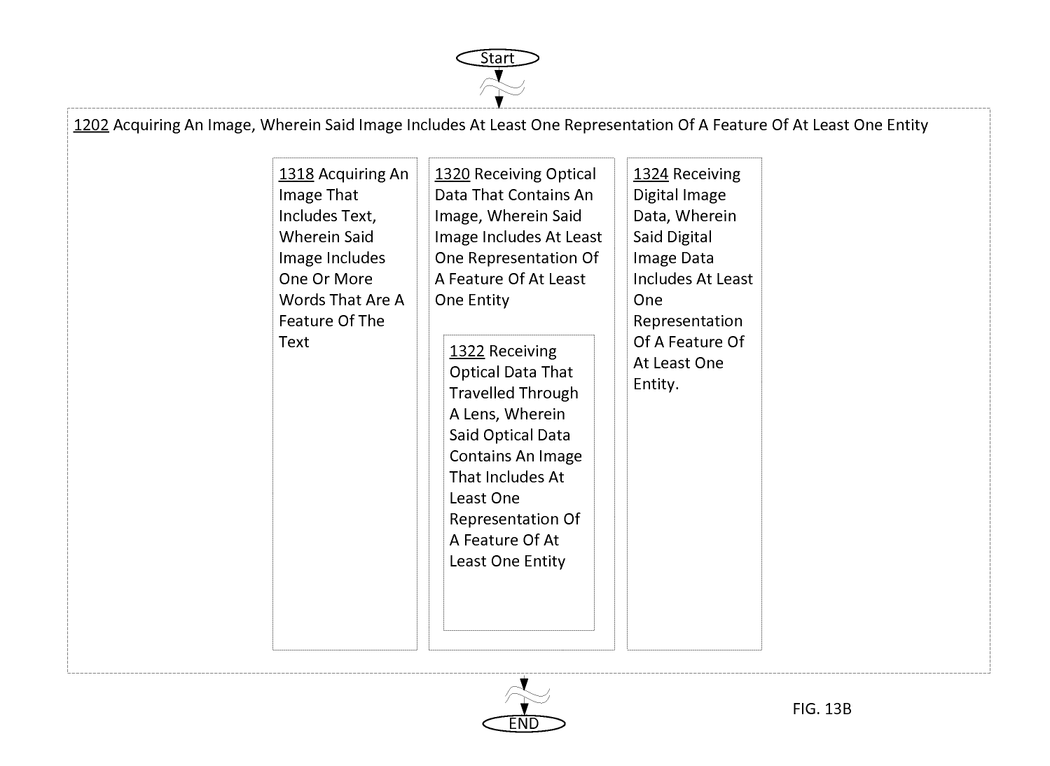

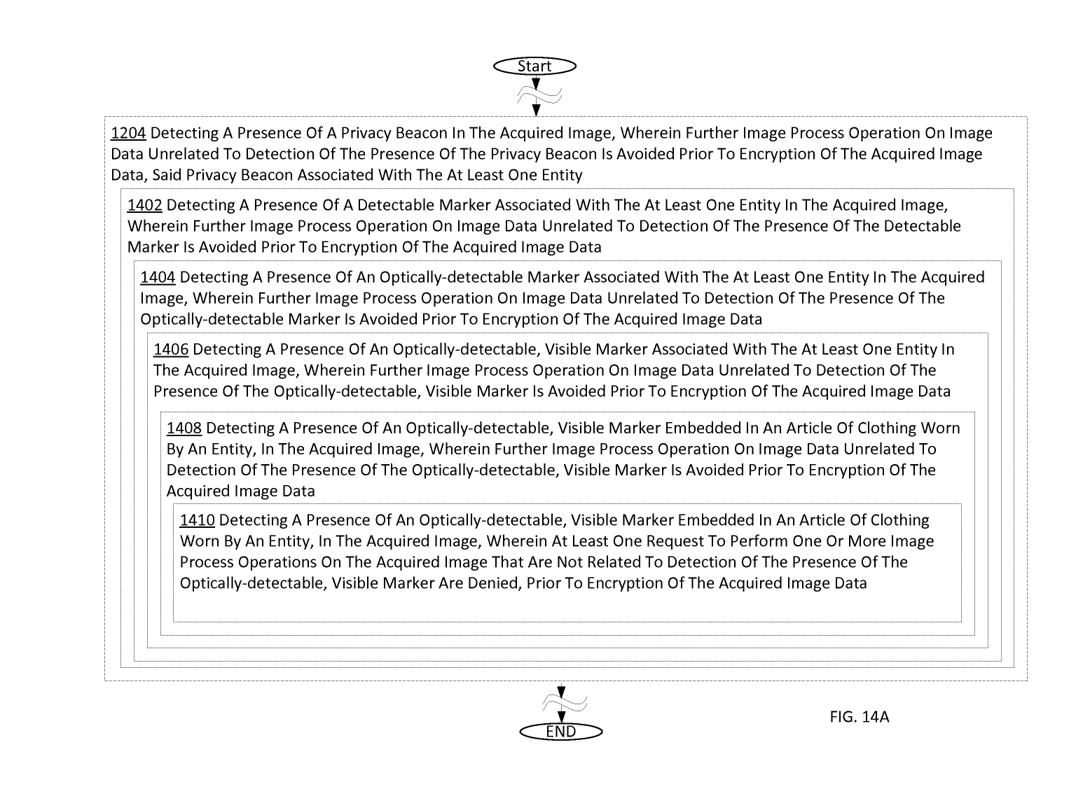

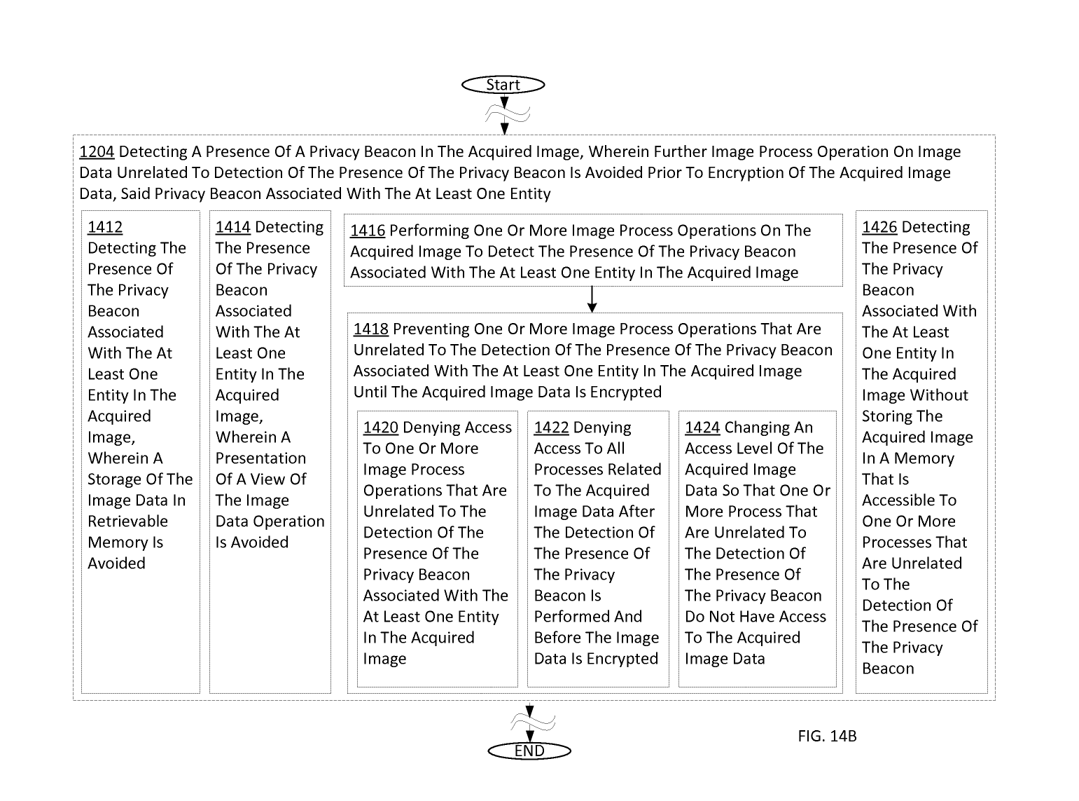

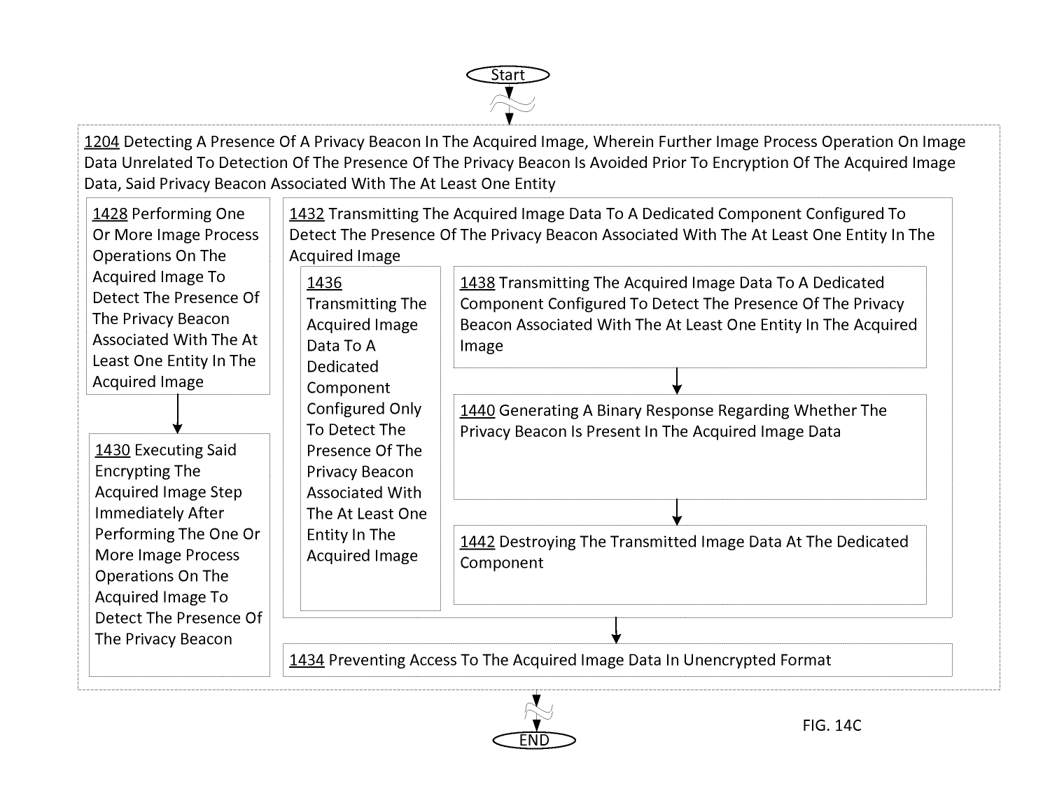

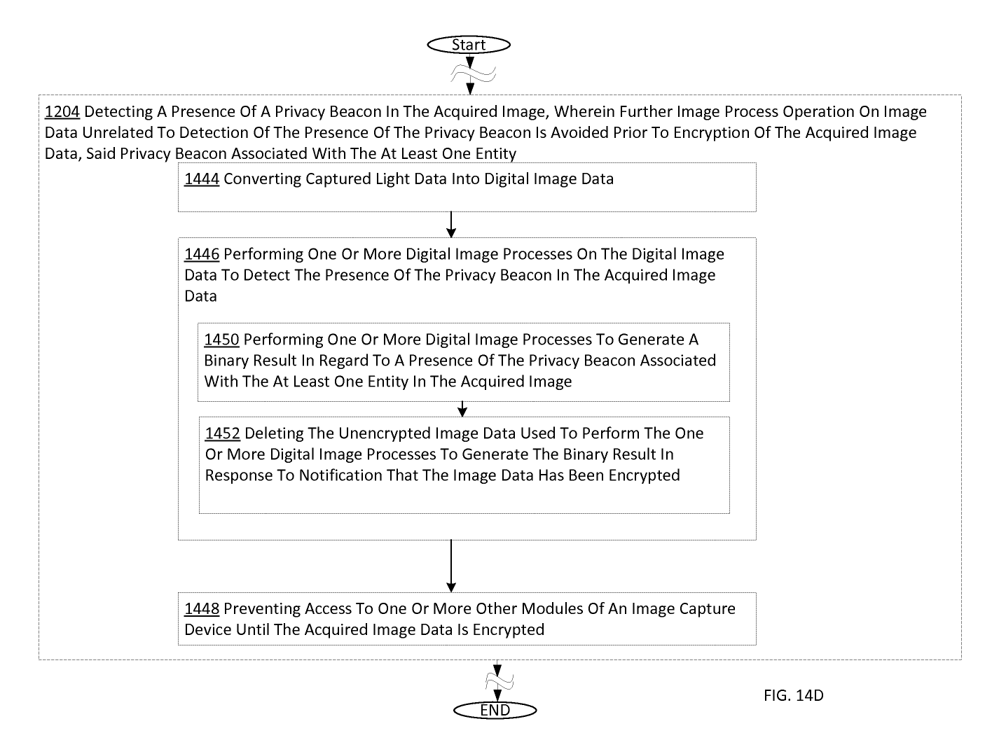

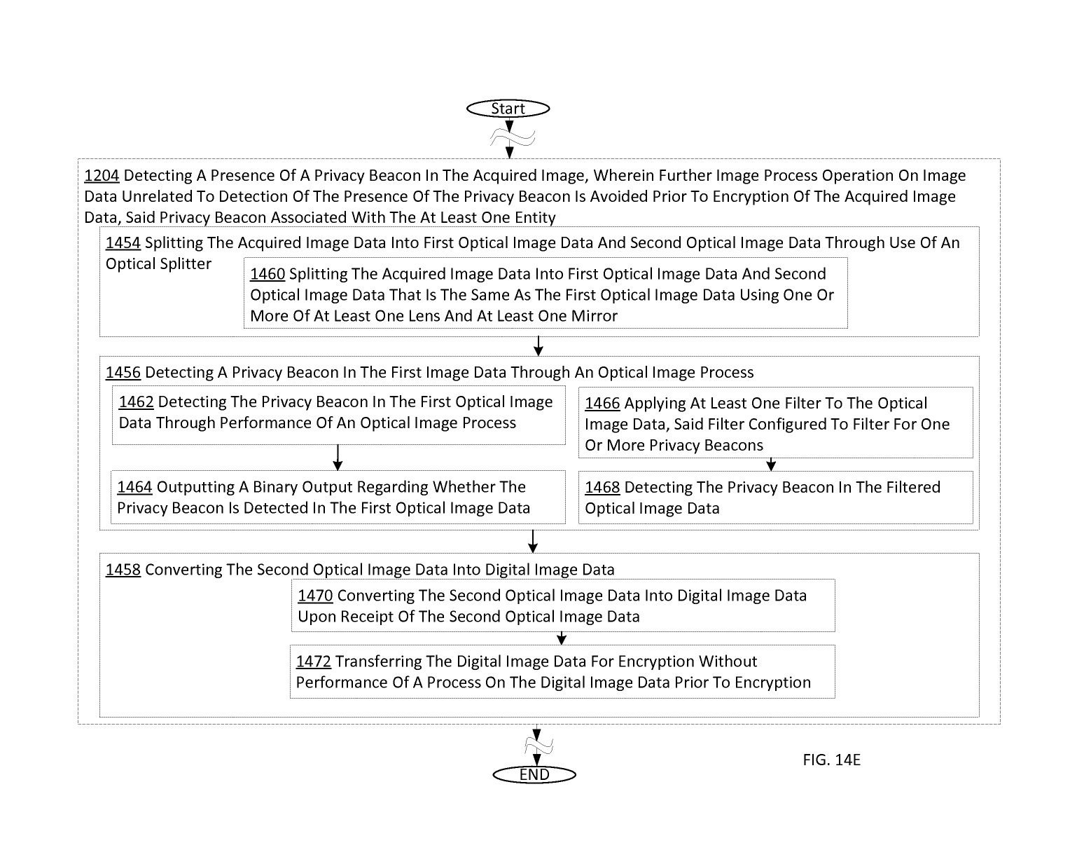

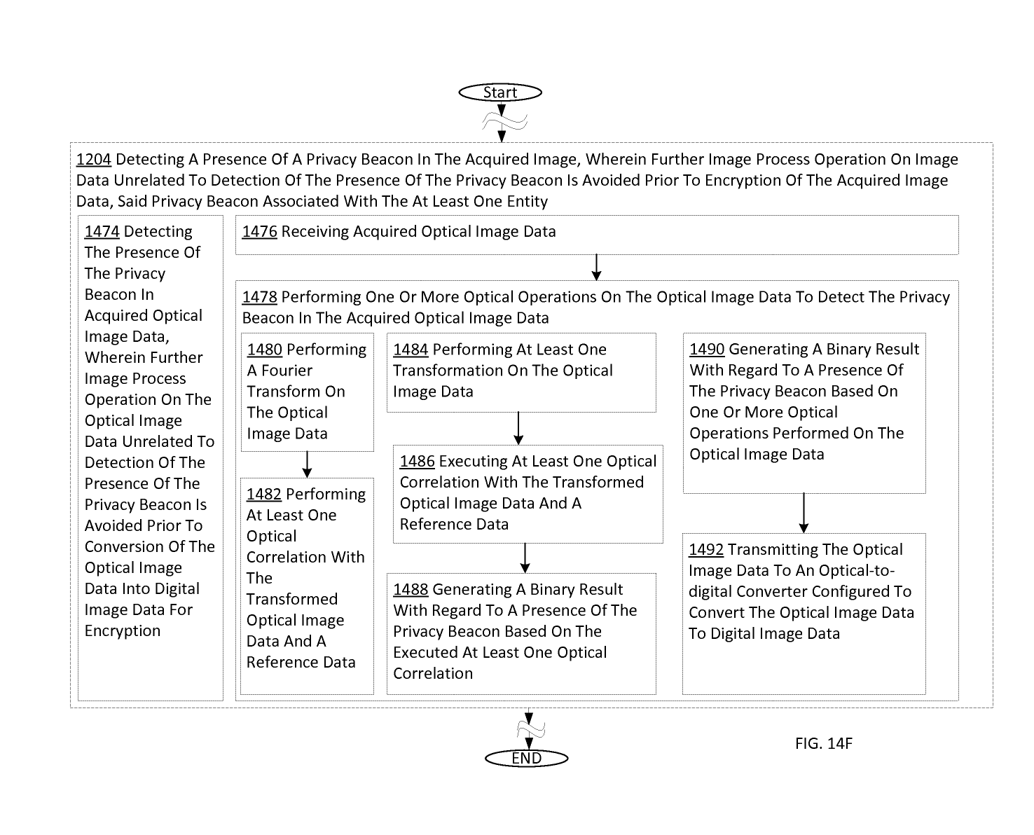

FIGS. 14A-14G depict various implementations of operation 1204, depicting detecting a presence of a privacy beacon in the acquired image, wherein further image process operation on image data unrelated to detection of the presence of the privacy beacon is avoided prior to encryption of the acquired image data, said privacy beacon associated with the at least one entity, according to embodiments. Referring now to FIG. 14A, operation 1204 may include operation 1402 depicting detecting a presence of a detectable marker associated with the at least one entity in the acquired image, wherein further image process operation on image data unrelated to detection of the presence of the detectable marker is avoided prior to encryption of the acquired image data. For example, FIG. 9, e.g., FIG. 9A shows detectable marker associated with the at least one entity within the obtained image detecting module that avoids further image process operation on obtained image data prior to encryption of the acquired image data 902 detecting a presence (e.g., whether the marker appears) of a detectable marker (e.g., a marker mounted on a drone that maintains a particular proximity to the person) associated with the at least one entity (e.g., the indie rock group Matt & Kim) in the acquired image (e.g., a picture of the rock group on stage, playing songs), wherein further image process operation (e.g., uploading the picture to Facebook) on image data unrelated to detection of the presence of the detectable marker (e.g., uploading the picture to Facebook is unrelated to the detection of the drone-based marker) is avoided prior to encryption of the acquired image data.

Referring again to FIG. 14A, operation 1402 may include operation 1404 depicting detecting a presence of an optically-detectable marker associated with the at least one entity in the acquired image, wherein further image process operation on image data unrelated to detection of the presence of the optically-detectable marker is avoided prior to encryption of the acquired image data. For example, FIG. 9, e.g., FIG. 9A, shows optically-detectable marker associated with the at least one entity within the obtained image detecting module that avoids further image process operation on obtained image data prior to encryption of the acquired image data 904 detecting a presence of an optically-detectable (e.g., a marker that reflects light in a visible or a nonvisible spectrum) marker associated with the at least one entity (e.g., an anonymous man walking down K Street in Washington, D.C.) in the acquired image (e.g., an image surreptitiously captured by a person wearing Google Glass and sitting on a park bench on K Street), wherein further image process operation (e.g., photo manipulating (e.g., “photoshopping,” colloquially) a horse head and a pile of money into the picture) unrelated to the detection of the presence of the optically-detectable marker (e.g., the marker that reflects light in the visible or the nonvisible spectrum) is avoided (e.g., the photo manipulation program is prevented from running) prior to encryption of the acquired image data.

Referring again to FIG. 14A, operation 1404 may include operation 1406 depicting detecting a presence of an optically-detectable, visible marker associated with the at least one entity in the acquired image, wherein further image process operation on image data unrelated to detection of the presence of the optically-detectable, visible marker is avoided prior to encryption of the acquired image data. For example, FIG. 9, e.g., FIG. 9A, shows optically-detectable visible marker associated with the at least one entity within the obtained image detecting module that avoids further image process operation on obtained image data prior to encryption of the acquired image data 906 detecting a presence of an optically-detectable, visible marker (e.g., a marker that emits light in a visible spectrum) associated with (e.g., worn by) the at least one entity (e.g., a person at a coffee shop) in the acquired image (e.g., the image captured by the person wearing the wearable computer with an always-on camera), wherein further image process operation (e.g., viewing the image that was captured using retinal projection) on image data unrelated to the detection of the presence of the optically-detectable, visible marker (e.g., the marker that emits light in the visible spectrum) is avoided prior to encryption of the acquired image data).

Referring again to FIG. 14A, operation 1406 may include operation 1408 depicting detecting a presence of an optically-detectable, visible marker embedded in an article of clothing worn by an entity, in the acquired image, wherein further image process operation on image data unrelated to detection of the presence of the optically-detectable, visible marker is avoided prior to encryption of the acquired image data. For example, FIG. 9, e.g., FIG. 9A, shows optically-detectable visible marker embedded in a wearable object and associated with the at least one entity within the obtained image detecting module that avoids further image process operation on obtained image data prior to encryption of the acquired image data 908 detecting a presence of an optically-detectable, visible marker (e.g., a marker shaped in the form of a stop sign that reflects light in a visible spectrum) embedded in an article of clothing (e.g., sewn onto the clothing) worn by an entity (e.g., worn by a person on vacation in Paris, France) in the acquired image (e.g., image data of the vacationer at the Eiffel Tower), wherein further image process operation (e.g., attaching the image data to an email) on image data (e.g., the image data of the vacationer at the Eiffel Tower) unrelated to the detection of the presence of the optically-detectable, visible marker (e.g., the marker shaped in the form of a stop sign that reflects light in a visible spectrum) is avoided prior to encryption of the acquired image data.

Referring again to FIG. 14A, operation 1408 may include operation 1410 depicting detecting a presence of an optically-detectable, visible marker embedded in an article of clothing worn by an entity, in the acquired image, wherein at least one request to perform one or more image process operations on the acquired image that are not related to detection of the presence of the optically-detectable, visible marker are denied, prior to encryption of the acquired image data. For example, FIG. 9, e.g., FIG. 9A, shows optically-detectable visible marker embedded in a wearable object and associated with the at least one entity within the obtained image detecting module that is configured to facilitate denial of one or more requests to carry out further image process operation on obtained image data prior to encryption of the acquired image data 910 detecting a presence of an optically-detectable, visible marker (e.g., a hat with the slogan “Don't Capture Me, Bro!” written in large letters on the hat, which at least one of the letters acts as the marker) embedded in an article of clothing worn by an entity, in the acquired image, wherein at least one request to perform one or more image process operations (e.g., posting the image to a pinboard-style photo sharing website (e.g., Pinterest)) on the acquired image that are not related to detection of the presence of the optically-detectable, visible marker are denied (e.g., either the program is denied from opening, or denied from accessing the image data), prior to encryption of the acquired image data.

Referring now to FIG. 14B, operation 1204 may include operation 1412 depicting detecting the presence of the privacy beacon associated with the at least one entity in the acquired image, wherein a storage of the image data in retrievable memory is avoided. For example, FIG. 9, e.g., FIG. 9B, shows privacy beacon associated with the at least one entity within the obtained image detecting module that avoids storage of unencrypted image data in general-access retrievable memory 912 detecting the presence of the privacy beacon (e.g., a marker that, when a particular type of electromagnetic wave hits it, emits a particular electromagnetic wave) associated with the at least one entity (e.g., the person) in the acquired image (e.g., the image taken by the person wearing the wearable computer), wherein a storage of the image data in retrievable memory (e.g., wearable computer device memory, e.g., device memory 240 of FIG. 2B) is avoided (e.g., the memory controller may prevent writing of the data to the device memory).

Referring again to FIG. 14B, operation 1204 may include operation 1414 depicting detecting the presence of the privacy beacon associated with the at least one entity in the acquired image, wherein a presentation of a view of the image data operation is avoided. For example, FIG. 9, e.g., FIG. 9B, shows privacy beacon associated with the at least one entity within the obtained image detecting module that avoids transmission of the image data to a location at which the image data is configured to be viewable 914 detecting the presence of the privacy beacon (e.g., a marker that emits a radio wave) associated with the at least one entity (e.g., a person in a satellite photo taken by a low-earth orbit satellite) in the acquired image (e.g., the satellite photo), wherein a presentation of a view of the image data operation (e.g., viewing the photo prior to encryption) is avoided (e.g., the “view” function is “grayed out” or disabled).

Referring again to FIG. 14B, operation 1204 may include operation 1416 depicting performing one or more image process operations on the acquired image to detect the presence of the privacy beacon associated with the at least one entity in the acquired image. For example, FIG. 9, e.g., FIG. 9B, shows privacy beacon associated with the at least one entity detecting through execution of one or more processes on the obtained image data module 916 performing one or more image process operations (e.g., pattern recognition, filtering, Fourier transform, etc.) on the acquired image (e.g., a still image from a video taken of a high school athlete playing sports) to detect the presence of the privacy beacon (e.g., a marker that is in the form of a bar code that is sewn into all of the uniforms) associated with the at least one entity (e.g., the high school athlete) in the acquired image (e.g., the still image from the captured video).

Referring again to FIG. 14B, operation 1204 may include operation 1418 depicting preventing one or more image process operations that are unrelated to the detection of the presence of the privacy beacon associated with the at least one entity in the acquired image until the acquired image data is encrypted. For example, FIG. 9, e.g., FIG. 9B, shows further image process operation unrelated to privacy beacon detection preventing prior to encryption of the obtained image data module 918 preventing one or more image process operations (e.g., saving the image to a cloud storage, e.g., Google Picasa) that are unrelated to the detection of the presence of the privacy beacon (e.g., marker that is in the form of a bar code and painted on a user's head and that reflects light in a nonvisible spectrum) associated with the at least one entity (e.g., a person sitting at a fast food restaurant) in the acquired image until the acquired image data is encrypted.

Referring again to FIG. 14B, operation 1418 may include operation 1420 depicting denying access to one or more image process operations that are unrelated to the detection of the presence of the privacy beacon associated with the at least one entity in the acquired image. For example, FIG. 9, e.g., FIG. 9B, shows access of one or more unencrypted image data process applications unrelated to privacy beacon detection denying module 920 denying access to one or more image process operations (e.g., performing facial recognition on the image) that are unrelated to the detection of the presence of the privacy beacon (e.g., a marker that uses high frequency low penetration radio waves (e.g., 60 GHz radio waves)) associated with the at least one entity (e.g., a person walking down the street that was captured by a traffic surveillance camera) in the acquired image.

Referring again to FIG. 14B, operation 1418 may include operation 1422 depicting denying access to all processes related to the acquired image data after the detection of the presence of the privacy beacon is performed and before the image data is encrypted. For example, FIG. 9, e.g., FIG. 9B, shows access of all unencrypted image data process applications (e.g., read, view, save, modify, upload to network, etc.) unrelated to privacy beacon detection denying module 922 denying access to all processes related to the acquired image data after the detection of the presence of the privacy beacon (e.g., a marker that emits a particular thermal signature) is performed and before the image data is encrypted.

Referring again to FIG. 14B, operation 1418 may include operation 1424 depicting changing an access level of the acquired image data so that one or more processes that are unrelated to the detection of the presence of the privacy beacon do not have access to the acquired image data. For example, FIG. 9, e.g., FIG. 9B, shows access level of unencrypted image data modifying to deny access to one or more unencrypted image data process applications unrelated to privacy beacon detection denying module 924 changing an access level (e.g., a value associated with the data that indicates an amount of access required in order for a process to access the data) of the acquired image data (e.g., an image of a person in a corporate office stealing paper clips) so that one or more processes that are unrelated to the detection of the presence of the privacy beacon (e.g., marker that is worn underneath clothing and is detectable by an x-ray-type detector) do not have access to the acquired image data (e.g., the image of a person in a corporate office stealing paper clips).

Referring again to FIG. 14B, operation 1204 may include operation 1426 depicting detecting the presence of the privacy beacon associated with the at least one entity in the acquired image without storing the acquired image in a memory that is accessible to one or more processes that are unrelated to the detection of the presence of the privacy beacon. For example, FIG. 9, e.g., FIG. 9B, shows privacy beacon associated with the at least one entity within the obtained image detecting module that stores the image data only in one or more memory locations that are inaccessible to one or more image data process applications 926 detecting the presence of the privacy beacon (e.g., a marker that creates a magnetic field) associated with the at least one entity in the acquired image (e.g., an image of a person walking their dog on the street) without storing the acquired image in a memory (e.g., a device memory 240, as shown in FIG. 2B) that is accessible to one or more processes that are unrelated to the detection of the presence of the privacy beacon (e.g., the marker that creates a magnetic field).

Referring now to FIG. 14C, operation 1204 may include operation 1428 depicting performing one or more image process operations on the acquired image to detect the presence of the privacy beacon associated with the at least one entity in the acquired image. For example, FIG. 9, e.g., FIG. 9C, shows one or more processes to detect the privacy beacon associated with the at least one entity executing on the obtained image data module 928 performing one or more image process operations (e.g., image feature sharpening) on the acquired image (e.g., an image of a person acquired using a wearable computer, e.g., Google Glass) to detect the presence of the privacy beacon (e.g., a marker that emits a sonic wave) associated with the at least one entity (e.g., the person whose image is acquired) in the acquired image.

Referring again to FIG. 14C, operation 1204 may include operation 1430 depicting executing said encrypting the acquired image step immediately after execution of the one or more image process operations on the acquired image to detect the presence of the privacy beacon. For example, FIG. 9, e.g., FIG. 9C, shows obtained image data transmission to encrypting module immediately after the execution of the one or more processes to detect the privacy beacon module 930 executing said encrypting the acquired image step immediately (e.g., with no intervening processes that execute on a same logical level as “encrypting,” “acquiring” “modifying,” and “saving”) after performance of the one or more image process operations on the acquired image (e.g., an image of a person sitting at a bar drinking whiskey, taken by the bartender who is wearing a wearable computer) to detect the presence of the privacy beacon (e.g., a marker that emits a sonic wave at a frequency that cannot be heard by humans)

Referring again to FIG. 14C, operation 1204 may include operation 1432 depicting transmitting the acquired image data to a dedicated component configured to detect the presence of the privacy beacon associated with the at least one entity in the acquired image. For example, FIG. 9, e.g., FIG. 9C, shows privacy beacon associated with the at least one entity within the obtained image detecting through use of a dedicated module 932 transmitting the acquired image data to a dedicated component (e.g., a detection component on a wearable computer device, e.g., beacon detection module 310 of FIG. 3) configured to detect the presence of the privacy beacon (e.g., a marker that is tattooed to a person's bicep and is detectable through clothing) associated with the at least one entity (e.g., a person whose picture is taken while they are stopped at a stop light by a person using a vehicle-mounted hidden camera) in the acquired image (e.g., the image of the person).

Referring again to FIG. 14C, operation 1204 may include operation 1434 depicting preventing access to the acquired image data in unencrypted format. For example, FIG. 9, e.g., FIG. 9C, shows access to unencrypted obtained image data preventing module 934 preventing (e.g., denying, blocking, excluding, disallowing, suppressing, intercepting, etc.) access to the acquired image data in unencrypted format.

Referring again to FIG. 14C, operation 1432 may include operation 1436 depicting transmitting the acquired image data to a dedicated component configured only to detect the presence of the privacy beacon associated with the at least one entity in the acquired image. For example, FIG. 9, e.g., FIG. 9C, shows privacy beacon associated with the at least one entity within the obtained image detecting through use of a designated dedicated component module 936 transmitting the acquired image data (e.g., optical image data) to a dedicated component (e.g., optical beacon detection module 720 of FIG. 7, e.g., which may be a series of optical elements configured to perform the optical detection) configured only to detect the presence of the privacy beacon (e.g., a marker mounted in eyeglasses) associated with the at least one entity in the acquired image (e.g., an image of a person pumping gas at a gas station taken by a person pumping gas at the other pump, that is wearing a wearable computer with image capturing functionality).

Referring again to FIG. 14C, operation 1432 may include operation 1438 depicting transmitting the acquired image data to a dedicated component configured to detect the presence of the privacy beacon associated with the at least one entity in the acquired image. For example, FIG. 9, e.g., FIG. 9C, shows privacy beacon associated with the at least one entity within the obtained image transmitting to a dedicated component module 938 transmitting the acquired image data (e.g., digital image data) to a dedicated component (e.g., a component that is designed to perform image processing, e.g., beacon detection module 410 of FIG. 4) configured to detect the presence of the privacy beacon (e.g., a marker that is a part of a user's cellular telephone device) associated with the at least one entity in the acquired image (e.g., an image of a person at a grocery store).

Referring again to FIG. 14C, operation 1432 may include operation 1440 depicting generating a binary response regarding whether the privacy beacon is present in the acquired image data. For example, FIG. 9, e.g., FIG. 9C, shows binary response regarding a presence of the privacy beacon associated with the at least one entity within the obtained image generating at the dedicated component module 940 generating a binary response (e.g., a “detected or not detected,” e.g., where “0” is “not detected, and “1” is detected, for example) regarding whether the privacy beacon (e.g., a marker that is broadcast by a part of a user's cellular telephone device) is present in the acquired image data (e.g., in an embodiment, the acquired image data may include additional captured data, e.g., whether a signal emitted by a cellular telephone device is present).

Referring again to FIG. 14C, operation 1432 may include operation 1442 depicting destroying the transmitted image data at the dedicated component. For example, FIG. 9, e.g., FIG. 9C, shows obtained image data deleting module 942 destroying (e.g., deleting, or moving to an area that is inaccessible or partly inaccessible) the transmitted image data at the dedicated component).

Referring now to FIG. 14D, operation 1204 may include operation 1444 depicting converting captured light data into digital image data. For example, FIG. 9, e.g., FIG. 9D, shows transforming gathered light data into digital image data through use of an image sensor module 944 converting captured light data (e.g., photons that represent a captured image) into digital image data (e.g., electrons that represent pixels that correspond to a captured image).

Referring again to FIG. 14D, operation 1204 may include operation 1446 depicting performing one or more digital image processes on the digital image data to detect the presence of the privacy beacon in the acquired image data. For example, FIG. 9, e.g., FIG. 9D, shows one or more digital image privacy beacon detection processes performing on the transformed digital image data module 946 performing one or more digital image processes (e.g., pattern recognition, color adjustment, sharpening, color filtering, alpha value filtering, and the like) on the digital image data (e.g., the pixel data) to detect the presence of the privacy beacon (e.g., a marker mounted on a drone that maintains a particular proximity to the person) in the acquired image data (e.g., an image of two people kissing at a movie theater).

Referring again to FIG. 14D, operation 1204 may include operation 1448 depicting preventing access to one or more other modules of an image capture device until the acquired image data is encrypted. For example, FIG. 9, e.g., FIG. 9D, shows access to other image capture device module preventing prior to digital image data encryption module 948 preventing access to one or more other modules (e.g., an image viewing module, an image manipulation module, an image altering module, an image posting to social media module, and the like) of an image capture device (e.g., a wearable computer) until the acquired image data (e.g., an image of a person ordering food at a food truck that is captured by a person behind them in line that is wearing a wearable computer) is encrypted.

Referring again to FIG. 14D, operation 1446 may include operation 1450 depicting performing one or more digital image processes to generate a binary result in regard to a presence of the privacy beacon associated with the at least one entity in the acquired image. For example, FIG. 9, e.g., FIG. 9D, shows one or more digital image privacy beacon detection processes that generate a binary result performing on the transformed digital image data module 950 performing one or more digital image processes (e.g., rotation of the image, cropping of the image, adjustment of brightness, adjustment of color, image artifact removal, labeling, tagging) to generate a binary result (e.g., a “detected or not detected” result) in regard to a presence of the privacy beacon (e.g., a marker mounted in a hat) associated with the at least one entity (e.g., the person being captured in a still shot of a video) in the acquired image.

Referring again to FIG. 14D, operation 1446 may include operation 1452 depicting deleting the unencrypted image data used to perform the one or more digital image processes to generate the binary result in response to notification that the image data has been encrypted. For example, FIG. 9, e.g., FIG. 9D, shows transformed digital image data deleting after generation of binary result module 952 deleting the unencrypted image data used to perform the one or more digital image processes to generate the binary result (e.g., pattern recognition and color filtering) in response in response to notification (e.g., a signal from an encrypting module, e.g., image data encryption module 420 of FIG. 4) that the image data has been encrypted.

Referring now to FIG. 14E, operation 1204 may include operation 1454 depicting splitting the acquired image data into first optical image data and second optical image data through use of an optical splitter. For example, FIG. 9, e.g., FIG. 9E, shows obtained image data into first optical image data and second optical image data splitting module 954 splitting (e.g., using an optical splitting module, e.g., optical splitting module 505, e.g., one or more mirrors, lenses, and/or prisms) the acquired image data (e.g., data collected by a lens, e.g., lens 506 of FIG. 5) into first optical image data (e.g., the photon/light data) and second optical image data (e.g., the same as the first optical image data) through use of an optical splitter (e.g., an optical splitting module, e.g., optical splitting module 505, e.g., one or more mirrors, lenses, and/or prisms).

Referring again to FIG. 14E, operation 1204 may include operation 1456 depicting detecting a privacy beacon in the first optical image data through an optical image process. For example, FIG. 9, e.g., FIG. 9E, shows privacy beacon in the first optical image data detecting through one or more optical image processes module 956 detecting a privacy beacon (e.g., a marker mounted in an article of clothing) in the first image data through an optical image process (e.g., one or more waveform transformations, followed by an optical correlation, and/or a pattern recognition).

Referring again to FIG. 14E, operation 1204 may include operation 1458 depicting converting the second optical image data into digital image data. For example, FIG. 9, e.g., FIG. 9E, shows second optical image data into digital image data converting module 958 converting the second optical image data (e.g., photons corresponding to an image taken of a person reading a newspaper at a bus stop, using a wearable computer) into digital image data (e.g., electrons corresponding to pixels that correspond to the image of a person reading a newspaper at a bus stop, using a wearable computer).

Referring again to FIG. 14E, operation 1454 may include operation 1460 depicting splitting the acquired image data into first optical image data and second optical image data that is the same as the first optical image data using one or more of at least one lens and at least one mirror. For example, FIG. 9, e.g., FIG. 9E, shows obtained image data into first optical image data and second optical image data splitting through use of at least one optical element configured to refract light module 960 splitting the acquired image data (e.g., an image of a person eating a hamburger at a fast food restaurant) into first optical image data and second optical image data that is the same as the first optical image data using one or more of at least one lens and at least one mirror (e.g., as part of an optical splitting module, e.g., optical splitting module 605.

Referring again to FIG. 14E, operation 1456 may include operation 1462 depicting detecting the privacy beacon in the first optical image data through performance of an optical image process. For example, FIG. 9, e.g., FIG. 9E, shows privacy beacon in the first optical image data detecting through a particular optical image process module 962 detecting the privacy beacon (e.g., a marker that reflects light in a visible spectrum) in the first optical image data through performance of an optical image process (e.g., an optical correlation and/or an optical pattern recognition), e.g., performed by optical transformation module 610 and/or optical beacon detection module 620.

Referring again to FIG. 14E, operation 1456 may include operation 1464 depicting outputting a binary output regarding whether the privacy beacon is detected in the first optical image data. For example, FIG. 9, e.g., FIG. 9E, shows binary output regarding optical image process privacy beacon detection in first optical image data generating module 964 outputting a binary output regarding whether the privacy beacon is detected in the first optical image data (e.g., the optical image data that includes the image of the person eating a hamburger at the fast food restaurant).

Referring again to FIG. 14E, operation 1456 may include operation 1466 depicting applying at least one filter to the optical image data, said filter configured to filter for one or more privacy beacons. For example, FIG. 9, e.g., FIG. 9E, shows first optical image data optical filtering module 966 applying at least one filter (e.g., a filter for a specific band of colors, whether visible (e.g., red) or invisible (e.g., ultraviolet), said filter configured to filter for one or more privacy beacons (e.g., privacy beacons may be detected in a band of colors (e.g., a band of wavelengths of light). An example of this filter application may be seen optical filter 510 of FIG. 5).

Referring again to FIG. 14E, operation 1456 may include operation 1468 depicting detecting the privacy beacon in the filtered optical image data. For example, FIG. 9, e.g., FIG. 9E, shows privacy beacon in the filtered first optical image data detecting module 968 detecting the privacy beacon (e.g., a marker that reflects light in a nonvisible spectrum) in the filtered optical image data.

Referring again to FIG. 14E, operation 1458 may include operation 1470 depicting converting the second optical image data into digital image data upon receipt of the second optical image data. For example, FIG. 9, e.g., FIG. 9E, shows second optical image data into digital image data converting upon receipt module 970 converting the second optical image data (e.g., the same optical image data as the first optical image data, e.g.,

Referring again to FIG. 14E, operation 1458 may include operation 1472 depicting transferring the digital image data for encryption without performance of a process on the digital image data prior to encryption. For example, FIG. 9, e.g., FIG. 9E, shows converted digital image data transferring for encryption without performance of a process on the unencrypted digital image data module 972

Referring now to FIG. 14F, operation 1204 may include operation 1474 depicting detecting the presence of the privacy beacon in acquired optical image data, wherein further image process operation on the optical image data unrelated to detection of the presence of the privacy beacon is avoided prior to conversion of the optical image data into digital image data for encryption. For example, FIG. 9, e.g., FIG. 9F, shows privacy beacon associated with the at least one entity within the obtained optical image detecting module that avoids further image process operation on obtained image data prior to encryption of the obtained image data 974 detecting the presence of the privacy beacon (e.g., a marker that emits light in a nonvisible spectrum) in acquired optical image data, wherein further image process operation on the optical image data (e.g., unrelated filtering operations/lens image sharpening operations) unrelated to detection of the presence of the privacy beacon (e.g., the marker that emits light in the nonvisible spectrum) is avoided prior to conversion of the optical image data into digital image data for encryption.

Referring again to FIG. 14F, operation 1204 may include operation 1476 depicting receiving acquired optical image data. For example, FIG. 9, e.g., FIG. 9F, shows obtained optical image data receiving module 976 receiving acquired optical image data (e.g., light data of an image of two people meeting for drinks).

Referring again to FIG. 14F, operation 1204 may include operation 1478 depicting performing one or more optical operations on the optical image data to detect the privacy beacon in the acquired optical image data. For example, FIG. 9, e.g., FIG. 9F, shows one or more optical image processing operations for detection of the privacy beacon performing on the obtained optical image data module 978 performing one or more optical operations (e.g., image transformation, filtering, etc.) on the optical image data to detect the privacy beacon (e.g., a marker mounted in eyeglasses) in the acquired optical image data (e.g., the light data of the image of two people meeting for drinks).

Referring again to FIG. 14F, operation 1478 may include operation 1480 depicting performing a wave transformation on the optical image data through use of an optical component. For example, FIG. 9, e.g., FIG. 9F, shows Fourier transform operation performing on the obtained optical image data module 980 performing a wave transformation (e.g., one or more Fourier transformations) on the optical image data (e.g., the light data) through use of an optical component (e.g., one or more mirrors, lenses, prisms, and diffraction gratings, etc.).

Referring again to FIG. 14F, operation 1478 may include operation 1482 depicting performing at least one optical correlation with the transformed optical image data and a reference data. For example, FIG. 9, e.g., FIG. 9F, shows optical correlation operation performing on the transformed obtained optical image data and an obtained reference data 982 performing at least one optical correlation (e.g., a function that performs a correlation on a Fourier transform of one or more images) with the transformed optical image data (e.g., a head-and-shoulders picture of a woman) and a reference data (e.g., data that will assist in the detection of the privacy beacon).

Referring again to FIG. 14F, operation 1478 may include operation 1484 depicting performing at least one transformation on the optical image data. For example, FIG. 9, e.g., FIG. 9F, shows transform operation performing on the obtained optical image data module 984 performing at least one transformation (e.g., two Fourier transformations) on the optical image data.

Referring again to FIG. 14F, operation 1478 may include operation 1486 depicting executing at least one optical correlation with the transformed optical image data and a reference data. For example, FIG. 9, e.g., FIG. 9F, shows optical correlation that correlates the transformed obtained optical image data and an obtained reference data executing module 986 executing at least one optical correlation with the transformed optical image data (e.g., a head-and-shoulders picture of a woman) and a reference data (e.g., a data including an exemplary privacy beacon).

Referring again to FIG. 14F, operation 1478 may include operation 1488 depicting generating a binary result with regard to a presence of the privacy beacon based on the executed at least one optical correlation. For example, FIG. 9, e.g., FIG. 9F, shows binary result of detection of privacy beacon at least partly based on optical correlation generating module 988 generating a binary result (e.g., a “yes or no” result) with regard to a presence of the privacy beacon (e.g., a marker mounted on a drone that maintains a particular proximity to the person) based on the executed at least one optical correlation.

Referring again to FIG. 14F, operation 1478 may include operation 1490 depicting generating a binary result with regard to a presence of the privacy beacon based on one or more optical operations performed on the optical image data. For example, FIG. 9, e.g., FIG. 9F, shows binary result based on one or more optical process operations performed on the obtained optical image data generating module 990 generating a binary result (e.g., a “detected” or “not detected” result, which may be represented by a 1 or 0, or by a high-voltage or low-voltage relative to a threshold) with regard to a presence of the privacy beacon (e.g., a marker mounted in eyeglasses) based on one or more optical operations performed on the optical image data (e.g., a surreptitious picture of a woman at a bar).

Referring again to FIG. 14F, operation 1478 may include operation 1492 depicting transmitting the optical image data to an optical-to-digital converter configured to convert the optical image data to digital image data. For example, FIG. 9, e.g., FIG. 9F, shows transfer of the obtained optical image data to an optical-to-digital conversion component after generation of the binary result module 992 transmitting the optical image data (e.g., light data of an image of a celebrity at the beach) to an optical-to-digital converter (e.g., a CMOS sensor, e.g., optical-to-digital converter 640 of FIG. 6, and/or beacon detection control module 670) configured to convert the optical image data (e.g., the light data of an image of a celebrity at the beach) to digital image data (e.g., electron data of one or more pixels that form an image of a celebrity at the beach).

Referring now to FIG. 14G, operation 1204 may include operation 1494 depicting splitting the acquired image data into first digital image data and second digital image data identical to the first digital image data. For example, FIG. 9, e.g., FIG. 9G, shows obtained image data into first digital image data and second digital image data splitting module 994 splitting the acquired image data (e.g., a picture of a prominent politician singing along to Daft Punk) into first digital image data (e.g., a picture of a prominent politician singing along to Daft Punk) and second digital image data (e.g., (e.g., a picture of a prominent politician singing along to Daft Punk) identical to the first digital image data (e.g., a picture of a prominent politician singing along to Daft Punk).

Referring again to FIG. 14G, operation 1204 may include operation 1496 depicting detecting a privacy beacon in the first digital image data through one or more digital image processes. For example, FIG. 9, e.g., FIG. 9G, shows privacy beacon in the first digital image data detecting through one or more digital image processes module 996 detecting a privacy beacon (e.g., a marker that is in the form of a bar code and painted on a user's head and that reflects light in a nonvisible spectrum) in the first digital image data (e.g., a group picture of a bunch of friends going skiing) through one or more digital image processes (e.g., pattern recognition, color filtering, etc.).

Referring again to FIG. 14G, operation 1204 may include operation 1498 depicting transferring the second digital image data for encryption without performance of an operation on the unencrypted digital image data. For example, FIG. 9, e.g., FIG. 9G, shows second digital image data transferring for encryption without other operation module 998 transferring the second digital image data (e.g., the group picture of a bunch of friends going skiing) for encryption without performance of an operation on the unencrypted digital image data (e.g., the image of the group picture of a bunch of friends going skiing).

Referring again to FIG. 14G, operation 1496 may include operation 1401 depicting generating a binary signal with regard to a presence of the privacy beacon in the first digital image data. For example, FIG. 9, e.g., FIG. 9G, shows binary output regarding privacy beacon detection in digital image process generating module 901 generating a binary signal with regard to a presence of the privacy beacon (e.g., a marker that is a part of a user's cellular telephone device) in the first digital image data (e.g., a picture of two people at an amusement park).

Referring again to FIG. 14G, operation 1496 may include operation 1403 depicting performing pattern recognition on the first image data to detect a presence of the privacy beacon in the first image data. For example, FIG. 9, e.g., FIG. 9G, shows privacy beacon in the first digital image data detecting through one or more pattern recognition processes module 903 performing pattern recognition on the first image data (e.g., a still shot from a video recorded of a person riding a bicycle and weaving in and out of traffic) to detect a presence of the privacy beacon (e.g., a marker that is broadcast by a keychain carried by a person) in the first image data (e.g., a still shot from a video recorded of a person riding a bicycle and weaving in and out of traffic).

Referring again to FIG. 9G, operation 1204 may include operation 1405 depicting detecting a presence of the privacy beacon in the acquired image. For example, FIG. 9, e.g., FIG. 9G, shows presence of the privacy beacon in the obtained image detecting module 905 detecting a presence of the privacy beacon (e.g., a marker mounted in eyeglasses) in the acquired image (e.g., an image of a person at graduation).

Referring again to FIG. 9G, operation 1204 may include operation 1407 depicting obtaining a unique identifier corresponding to the detected privacy beacon. For example, FIG. 9, e.g., FIG. 9G, shows unique identifier at least partly based on the detected privacy beacon obtaining module 907 obtaining a unique identifier (e.g., the name of the entity corresponding to the detected privacy beacon and a six digit number, e.g., “Jules Caesar-000001) corresponding to the detected privacy beacon (e.g., a marker mounted in an article of clothing).

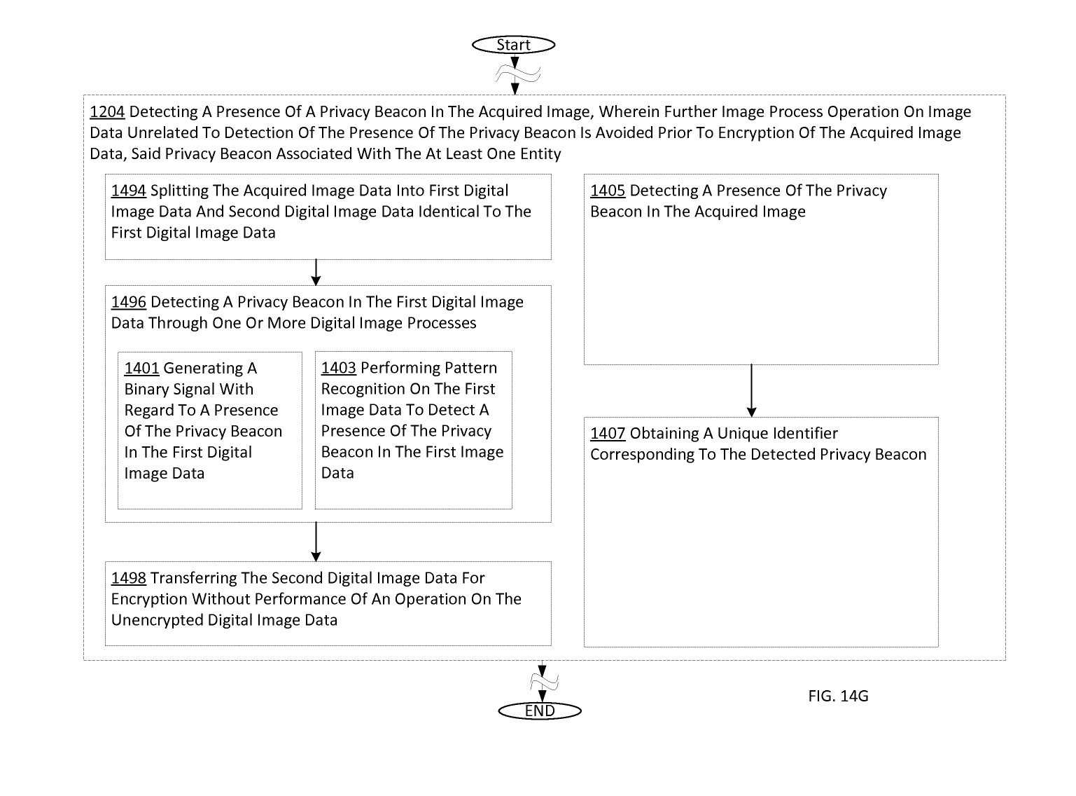

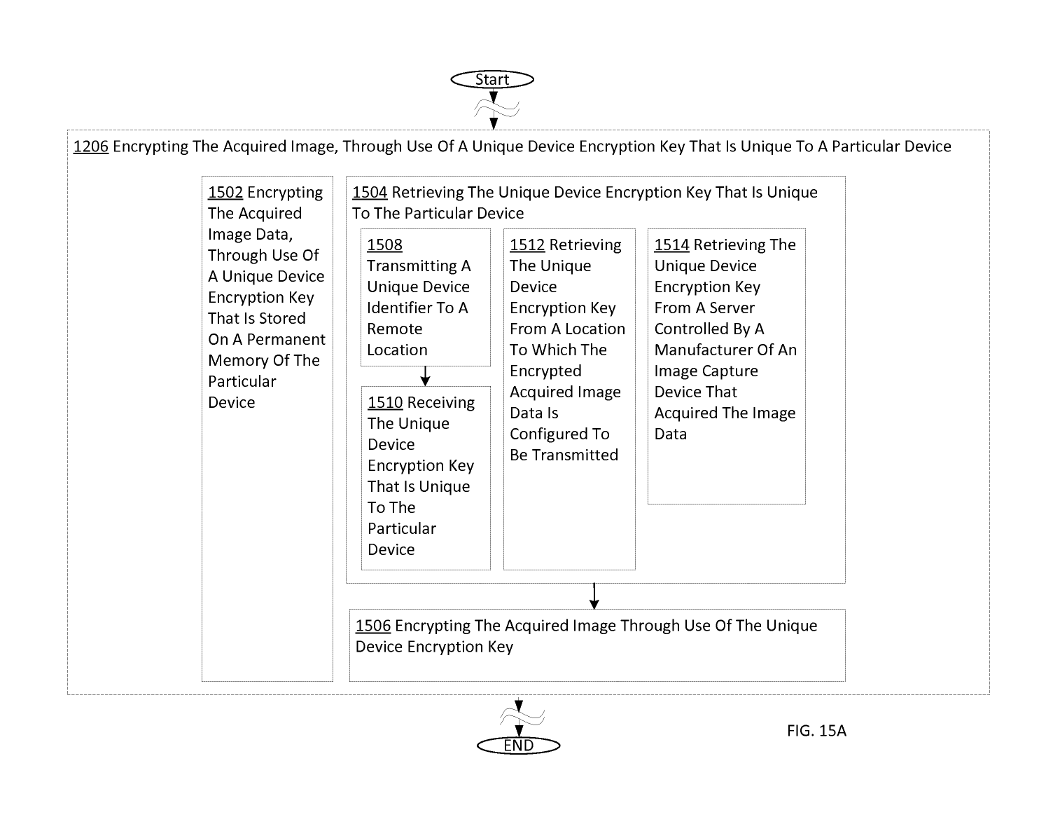

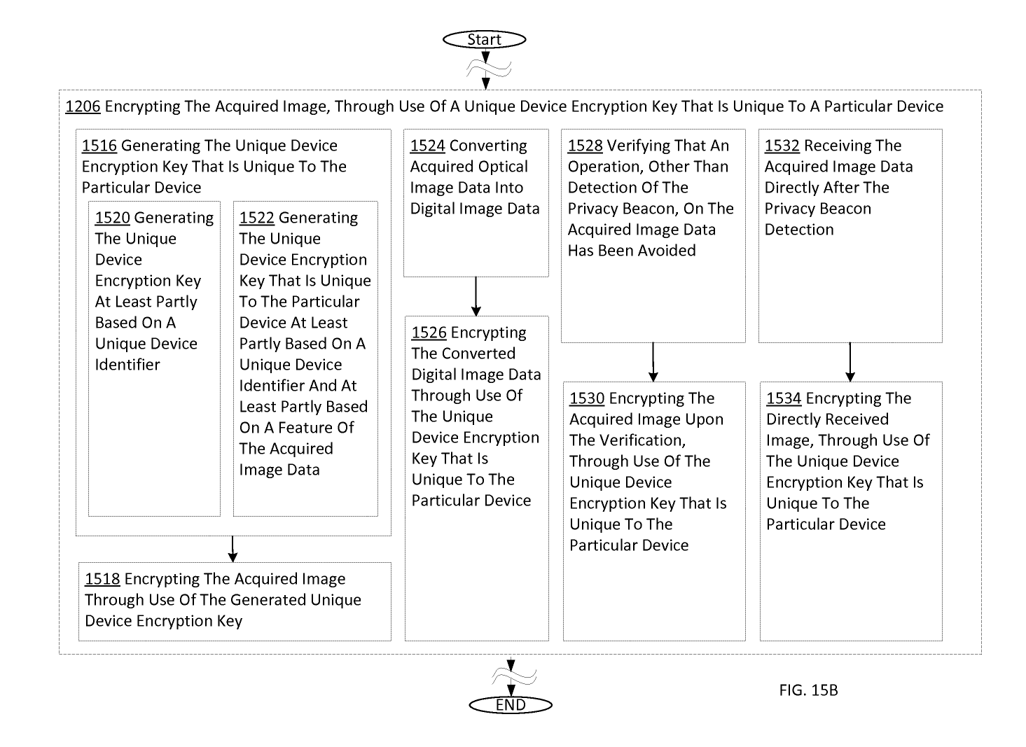

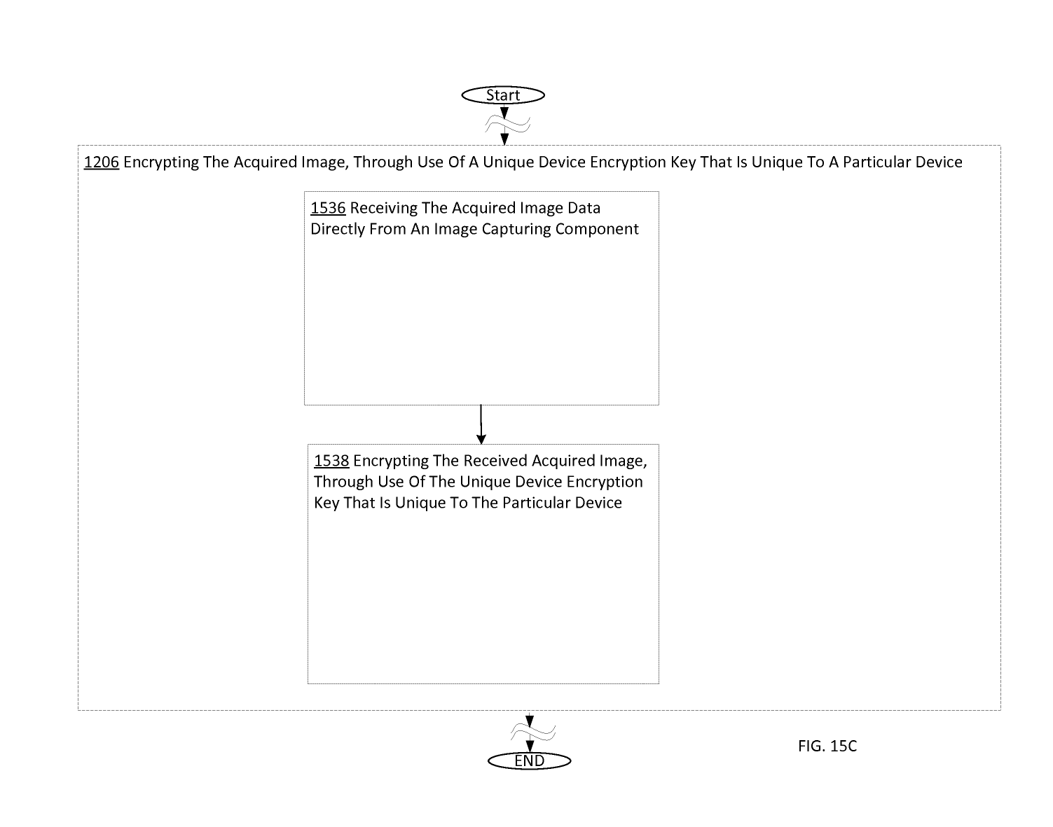

FIGS. 15A-15C depict various implementations of operation 1206, depicting encrypting the acquired image, through use of a unique device encryption key that is unique to a particular device, according to embodiments. Referring now to FIG. 15A, operation 1206 may include operation 1502 depicting encrypting the acquired image data, through use of a unique device encryption key that is stored on a permanent memory of the particular device. For example, FIG. 10, e.g., FIG. 10A shows obtained image encrypting through use of a unique device encryption key stored in a permanent memory of a device that captured the acquired image module 1002

Referring again to FIG. 15A, operation 1206 may include operation 1504 depicting retrieving the unique device encryption key that is unique to the particular device. For example, FIG. 10, e.g., FIG. 10A, shows unique device encryption key associated with a device that captured the acquired image retrieving module 1004

Referring again to FIG. 15A, operation 1206 may include operation 1506 depicting encrypting the acquired image through use of the unique device encryption key. For example, FIG. 10, e.g., FIG. 10A, shows obtained image encrypting through use of the retrieved unique device encryption key module 1006 encrypting the acquired image (e.g., an image of a person sitting at their desk in a corporate environment, surreptitiously recorded by one of their co-workers) through use of the unique device encryption key (e.g., a symmetric authentication key).

Referring again to FIG. 15A, operation 1504 may include operation 1508 depicting transmitting a unique device identifier to a remote location. For example, FIG. 10, e.g., FIG. 10A, shows unique device identifier that captured the acquired image transmitting to a remote location module 1008 transmitting a unique device identifier (e.g., the MAC address of a device, or a device ID assigned by a marketplace, e.g., the Apple Application Store) to a remote location (e.g., a location designed to generate and/or store and track the unique device encryption keys and to distribute them to authorized devices).

Referring again to FIG. 15A, operation 1504 may include operation 1510 depicting receiving the unique device encryption key that is unique to the particular device. For example, FIG. 10, e.g., FIG. 10A, shows unique device encryption key related to the unique device identifier receiving from the remote location module 1010 receiving the unique device encryption key (e.g., a private authentication key) that is unique to the particular device (e.g., a wearable computer, e.g., Google Glass).

Referring again to FIG. 15A, operation 1504 may include operation 1512 depicting retrieving the unique device encryption key from a location to which the encrypted acquired image data is configured to be transmitted. For example, FIG. 10, e.g., FIG. 10A, shows unique device encryption key associated with a device that captured the acquired image retrieving from a particular location configured to receive the transmitted encrypted obtained image data module 1012 retrieving the unique device encryption key (e.g., a PGP-based system key that is tied to a wearable computer device) from a location to which the encrypted acquired image data is configured to be transmitted (e.g., a location that will decide whether to allow decryption and/or distribution of the captured image data, e.g., a picture of two women sunbathing at their private country club pool).

Referring again to FIG. 15A, operation 1504 may include operation 1514 depicting retrieving the unique device encryption key from a server controlled by a manufacturer of an image capture device that acquired the image data. For example, FIG. 10, e.g., FIG. 10A, shows unique device encryption key associated with a device that captured the acquired image retrieving from a particular location controlled by a manufacturer of the device that captured the acquired image module 1014 retrieving the unique device encryption key from a server controlled by a manufacturer (e.g., Google, for Google Glass devices) of an image capture device (e.g., a Google Glass device) that acquired the image data (e.g., a group picture of people that donated to a particular charity).

Referring now to FIG. 15B, operation 1206 may include operation 1516 depicting generating the unique device encryption key that is unique to the particular device. For example, FIG. 10, e.g., FIG. 10B, shows unique device encryption key associated with a device that captured the obtained image generating module 1016 generating the unique device encryption key that is unique to the particular device (e.g., the device that captured the image data, e.g., a wearable computer, e.g., an EyeTap device).

Referring again to FIG. 15B, operation 1206 may include operation 1518 depicting encrypting the acquired image through use of the generated unique device encryption key. For example, FIG. 10, e.g., FIG. 10B, shows obtained image encrypting through use of the generated unique device encryption key module 1018 encrypting the acquired image data (e.g., a picture taken of a person waiting for the bus) through use of the generated unique device encryption key.

Referring again to FIG. 15B, operation 1516 may include operation 1520 depicting generating the unique device encryption key at least partly based on a unique device identifier. For example, FIG. 10, e.g., FIG. 10B, shows unique device encryption key associated with a device that captured the acquired image generating at least partly based on a unique device identifier module 1020 generating the unique device encryption key (e.g., a WEP encryption key) at least partly based on a unique device identifier (e.g., a device login at a marketplace site is used as a “seed” to generate the encryption key).

Referring again to FIG. 15B, operation 1516 may include operation 1522 depicting generating the unique device encryption key that is unique to the particular device at least partly based on a unique device identifier and at least partly based on a feature of the acquired image data. For example, FIG. 10, e.g., FIG. 10B, shows a unique device encryption key associated with a device that captured the acquired image generating at least partly based on a unique device identifier and at least partly based on a property of the obtained image data module 1022 generating the unique device encryption key (e.g., a WPA key) that is unique to the particular device (e.g., a wearable computer, e.g., Google Glass), at least partly based on a unique device identifier (e.g., a unique number assigned to the device at the time of manufacture) and at least partly based on a feature of the acquired image data (e.g., a number of pixels in the captured image data that have a red color range of between 200 and 250).

Referring again to FIG. 15B, operation 1206 may include operation 1524 depicting converting acquired optical image data into digital image data. For example, FIG. 10, e.g., FIG. 10B, shows obtained optical image data converting into digital image data module 1024 converting acquired optical image data (e.g., light data of an image, e.g., a celebrity doing charity work at a soup kitchen) into digital image data (e.g., one or more pixels or other electronic representations).

Referring again to FIG. 15B, operation 1206 may include operation 1526 depicting encrypting the converted digital image data through use of the unique device encryption key that is unique to the particular device. For example, FIG. 10, e.g., FIG. 10B, shows converted digital image data encrypting through use of a unique device encryption key associated with a device that captured the obtained image module 1026 encrypting the converted digital image data through use of the unique device encryption key (e.g., an asymmetric key) that is unique to the particular device (e.g., a wearable computer, e.g., an Oculus Rift device).

Referring again to FIG. 15B, operation 1206 may include operation 1528 depicting verifying that an operation, other than detection of the privacy beacon, on the acquired image data has been avoided. For example, FIG. 10, e.g., FIG. 10B, shows avoidance of operation other than detection of the privacy beacon verification module 1028 verifying that an operation, other than detection of the privacy beacon (e.g., a marker that is tattooed to a person's bicep and is detectable through clothing), on the acquired image data (e.g., a picture of a star of a reality television show at a local bar, taken by another patron of the bar who has a wearable computer) has been avoided (e.g., by examining one or more processes carried out by the device, or by examining the data flow of the image data).

Referring again to FIG. 15B, operation 1206 may include operation 1530 depicting encrypting the acquired image upon the verification, through use of the unique device encryption key that is unique to the particular device. For example, FIG. 10, e.g., FIG. 10B, shows obtained image encrypting upon verification of avoidance through use of a unique device encryption key associated with a device that captured the obtained image module 1030 encrypting the acquired image upon the verification, through use of the unique device encryption key (e.g., a WEP encryption key) that is unique to the particular device (e.g., the wearable computer).

Referring again to FIG. 15B, operation 1206 may include operation 1532 depicting receiving the acquired image data directly after the privacy beacon detection. For example, FIG. 10, e.g., FIG. 10B, shows obtained image receiving directly from the image obtaining module 1032 receiving the acquired image data (e.g., a picture of a person running a 10K race) directly after the privacy beacon (e.g., the shape of the person's face is registered as the beacon).

Referring again to FIG. 15B, operation 1206 may include operation 1534 depicting encrypting the directly received image, through use of the unique device encryption key that is unique to the particular device. For example, FIG. 10, e.g., FIG. 10B, shows directly received image encrypting through use of a unique device encryption key associated with a device that captured the obtained image module 1034 encrypting the directly received image (e.g., the picture of the person running the 10K race), through use of the unique device encryption key that is unique to the particular device (e.g., the wearable computer, e.g., the Sensics SmartGoggles worn by another runner).

Referring now to FIG. 15C, operation 1206 may include operation 1536 depicting receiving the acquired image data directly from an image capturing component. For example, FIG. 10, e.g., FIG. 10B, shows obtained image receiving directly from an image capturing component module 1036 receiving the acquired image data (e.g., a cheating husband having dinner with his intern) directly from an image capturing component (e.g., a CCD sensor and/or a lens, e.g., an image capturing component 406 of FIG. 4).

Referring again to FIG. 15C, operation 1206 may include operation 1538 depicting encrypting the received acquired image, through use of the unique device encryption key that is unique to the particular device. For example, FIG. 10, e.g., FIG. 10C, shows directly received image encrypting through use of a unique device encryption key associated with a device that captured the obtained image module 1038 encrypting the received acquired image (e.g., the cheating husband having dinner with his intern), through use of the unique device encryption key that is unique to the particular device (e.g., a wearable computer, e.g., a smart watch that is equipped with a discreet camera).

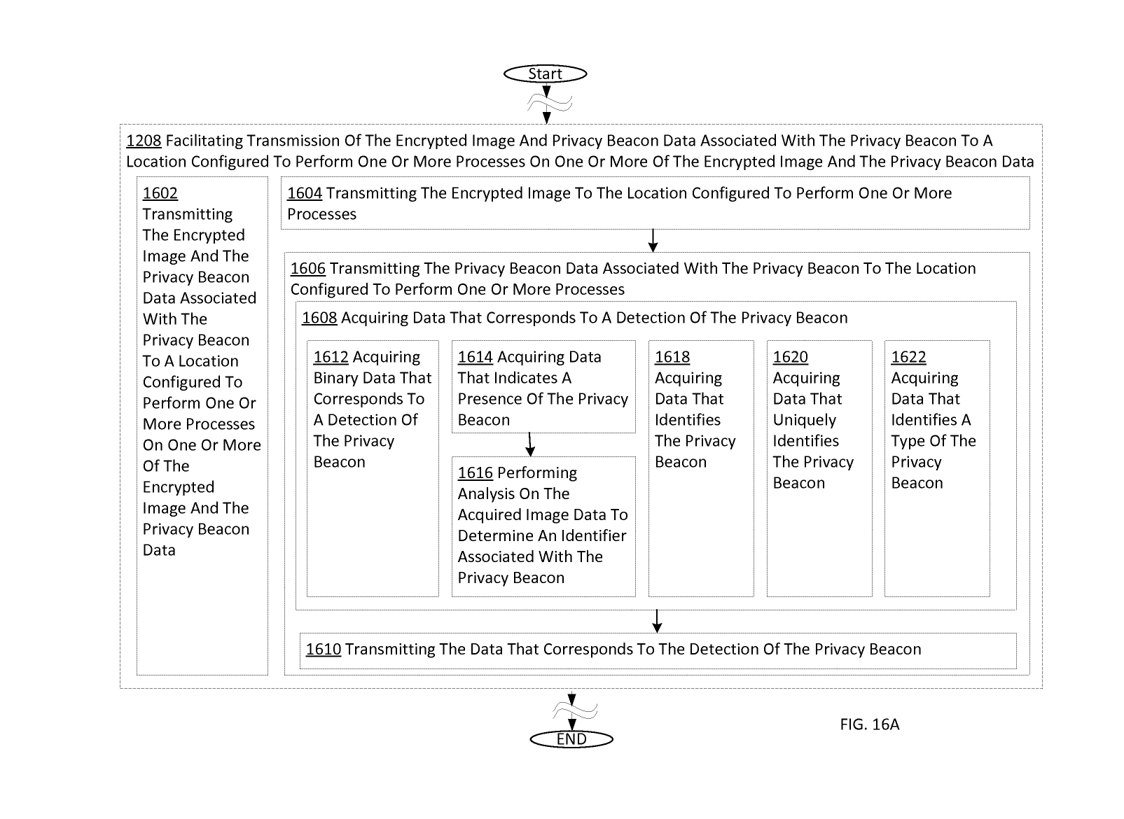

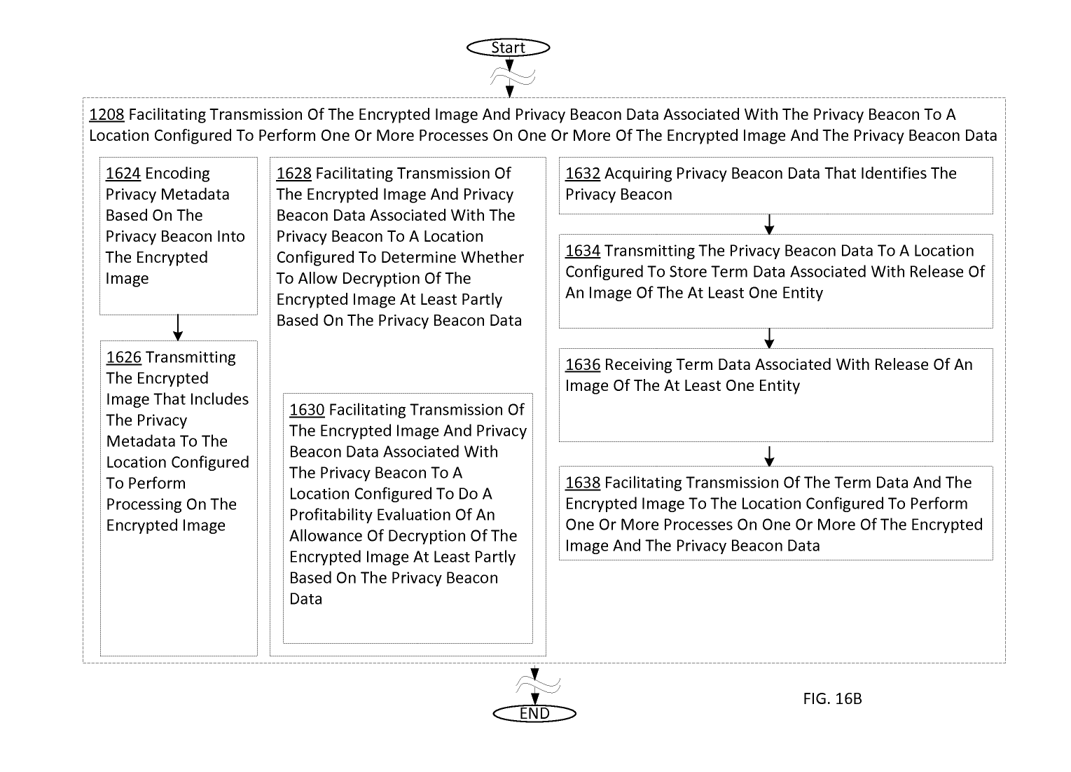

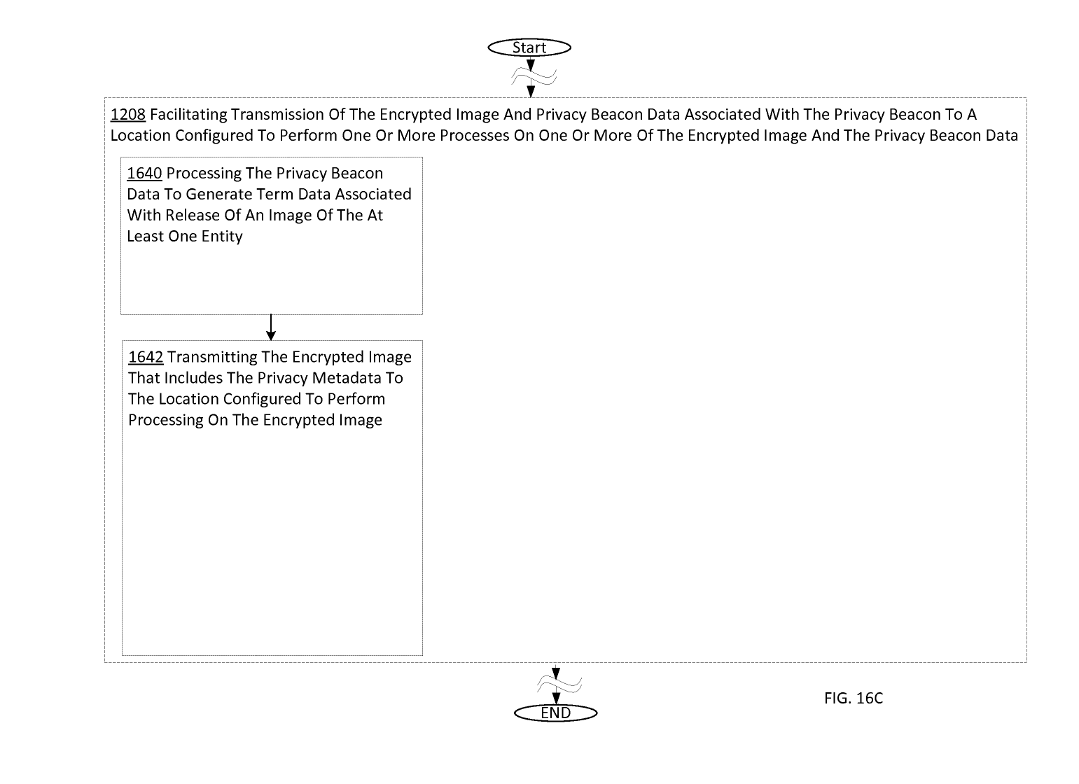

FIGS. 16A-16C depict various implementations of operation 1208, depicting facilitating transmission of the encrypted image and privacy beacon data associated with the privacy beacon to a location configured to perform one or more processes on one or more of the encrypted image and the privacy beacon data, according to embodiments. Referring now to FIG. 16A, operation 1208 may include operation 1602 depicting transmitting the encrypted image and the privacy beacon data associated with the privacy beacon to a location configured to perform one or more processes on one or more of the encrypted image and the privacy beacon data. For example, FIG. 11, e.g., FIG. 11A shows said encrypted image and privacy beacon data associated with the privacy beacon to a location configured to perform one or more processes on one or more of the encrypted image and the privacy beacon data transmitting module 1102 transmitting the encrypted image (e.g., an image taken of a person eating a cheeseburger at a restaurant) and privacy beacon data (e.g., metadata identifying the privacy beacon, which may be detectable from the beacon itself) associated with the privacy beacon to a location configured to perform one or more processes (e.g., a potential advertising revenue calculation of use of the image data) on one or more of the encrypted image (e.g., the image taken of a person eating a cheeseburger at a restaurant) and the privacy beacon data (e.g., metadata identifying the privacy beacon).

Referring again to FIG. 16A, operation 1208 may include operation 1604 depicting transmitting the encrypted image to the location configured to perform one or more processes. For example, FIG. 11, e.g., FIG. 11A, encrypted image transmitting to the location configured to perform one or more processes on the encrypted image module 1104 transmitting the encrypted image (e.g., an encrypted image data of a spokesman for a large chain of sub sandwich shops eating at a greasy hamburger joint) to the location configured to perform one or more processes (e.g., to perform facial image recognition and potential valuation of the person/persons recognized).

Referring again to FIG. 16A, operation 1208 may include operation 1606 depicting transmitting the privacy beacon data associated with the privacy beacon to the location configured to perform one or more processes. For example, FIG. 11, e.g., FIG. 11A, shows privacy beacon data associated with the privacy beacon transmitting to the location configured to perform one or more processes on the encrypted image module 1106 transmitting the privacy beacon data (e.g., data indicating that a privacy beacon exists, which will be further identified at the transmission location, e.g., binary data, or in another embodiment, metadata that identifies the privacy beacon uniquely or semi-uniquely (e.g., a class of privacy beacon) which may be determined by a feature of the detected beacon (e.g., shape, wavelength, color, etc.) associated with the privacy beacon (e.g., marker that reflects light in a nonvisible spectrum) to the location configured to perform one or more processes (e.g., to perform facial image recognition and potential valuation of the person/persons recognized).

Referring again to FIG. 16A, operation 1606 may include operation 1608 depicting acquiring data that corresponds to a detection of the privacy beacon. For example, FIG. 11, e.g., FIG. 11A, shows data that corresponds to detection of the privacy beacon acquiring module 1108 acquiring data (e.g., privacy beacon metadata that identifies a particular class of privacy beacon, e.g., “privacy beacon of a celebrity with net worth greater than $1M,” or “privacy beacon of a citizen that paid 2.95 per month for this service”) that corresponds to a detection of the privacy beacon (e.g., marker that is in the form of a bar code and painted on a user's head and that reflects light in a nonvisible spectrum).

Referring again to FIG. 16A, operation 1606 may include operation 1610, which may flow from operation 1608, depicting transmitting the data that corresponds to the detection of the privacy beacon. For example, FIG. 11, e.g., FIG. 11A, shows acquired data that corresponds to detection of the privacy beacon transmitting module 1110 transmitting the data (e.g., the privacy beacon metadata that identifies a particular class of privacy beacon) that corresponds to the detection of the privacy beacon (e.g., marker that is in the form of a bar code and painted on a user's head and that reflects light in a nonvisible spectrum)

Referring again to FIG. 16A, operation 1608 may include operation 1612 depicting acquiring binary data that corresponds to a detection of the privacy beacon. For example, FIG. 11, e.g., FIG. 11A, shows binary data that corresponds to yes-or-no detection of the privacy beacon acquiring module 1112 acquiring binary data (e.g., “detected” or “not detected” data of the privacy beacon) that corresponds to a detection of the privacy beacon (e.g., a marker mounted in eyeglasses).

Referring again to FIG. 16A, operation 1608 may include operation 1614 depicting acquiring data that indicates a presence of the privacy beacon. For example, FIG. 11, e.g., FIG. 11A, shows data indicating a presence of the privacy beacon acquiring module 1114 acquiring data (e.g., a hardware flag that is set by the optical detection of the beacon) that indicates a presence of the privacy beacon (e.g., a marker that emits light in a nonvisible spectrum).

Referring again to FIG. 16A, operation 1608 may include operation 1616, which may flow from operation 1614, depicting performing analysis on the acquired image data to determine an identifier associated with the privacy beacon. For example, FIG. 11, e.g., FIG. 11A, shows acquired data that indicates the presence of the privacy beacon analyzing to determine an identifier associated with the privacy beacon module 1116 performing analysis (e.g., pattern detection, color evaluation, steganography, etc.) on the acquired image data to determine an identifier (e.g., a name of the beacon, e.g., “Jules Caesar's Beacon,” or “beacon-user-0126346”) associated with the privacy beacon (e.g., the marker that emits light in a nonvisible spectrum).

Referring again to FIG. 16A, operation 1608 may include operation 1618 depicting acquiring data that identifies the privacy beacon. For example, FIG. 11, e.g., FIG. 11A, shows data that identifies the privacy beacon acquiring module 1118 acquiring data (e.g., retrieving from a privacy beacon type database) that identifies the privacy beacon (e.g., distinguishing between a “don't post to Facebook” beacon and a “don't post publicly” beacon and a “don't store locally or remotely” type beacon, e.g., in an embodiment where there are different classifications of beacons).

Referring again to FIG. 16A, operation 1608 may include operation 1620 depicting acquiring data that uniquely identifies the privacy beacon. For example, FIG. 11, e.g., FIG. 11A, shows data that uniquely identifies the privacy beacon acquiring module 1120 acquiring data (e.g., a privacy beacon identifier, e.g., “privacy beacon #352308u60A”) that uniquely identifies the privacy beacon (e.g., the identifier also indicates that the beacon has been detected, otherwise the values are just “00000000000”).

Referring again to FIG. 16A, operation 1608 may include operation 1622 depicting acquiring data that identifies a type of the privacy beacon. For example, FIG. 11, e.g., FIG. 11A, shows data that identifies a type of the privacy beacon acquiring module 1122 acquiring data that identifies a type of the privacy beacon (e.g., distinguishing between a “don't post to Facebook” beacon and a “don't post publicly” beacon and a “don't store locally or remotely” type beacon, e.g., in an embodiment where there are different classifications of beacons), or that identifies a class of person, e.g., “celebrity,” “politician,” “not a public figure,” or, in an embodiment, between “registered in a screen actors' database” and “not registered in a screen actors' database).

Referring now to FIG. 16B, operation 1208 may include operation 1624 depicting encoding privacy metadata based on the privacy beacon into the encrypted image. For example, FIG. 11, e.g., FIG. 11B, shows privacy beacon metadata encoding into the encrypted image module 1124 encoding privacy metadata (e.g., electronic data that corresponds to whether the beacon was detected, and, in an embodiment, identifier data or type data of the beacon) based on the privacy beacon (e.g., a marker that is a part of a user's cellular telephone device) into the encrypted image (e.g., the encrypted image data of an image of a band playing at a concert).

Referring again to FIG. 16B, operation 1208 may include operation 1626 depicting transmitting the encrypted image that includes the privacy metadata to the location configured to perform processing on the encrypted image. For example, FIG. 11, e.g., FIG. 11B, shows encrypted image including encoded privacy beacon metadata transmitting to the location configured to perform one or more processes on one or more of the encrypted image and the privacy beacon metadata 1126 transmitting the encrypted image data (e.g., the encrypted image data of an image of a band playing at a concert) that includes the privacy metadata (e.g., electronic data that corresponds to whether the beacon was detected, and, in an embodiment, identifier data or type data of the beacon) to the location configured to perform processing on the encrypted image (e.g., the encrypted image data of an image of a band playing at a concert).

Referring again to FIG. 16B, operation 1208 may include operation 1628 depicting facilitating transmission of the encrypted image and privacy beacon data associated with the privacy beacon to a location configured to determine whether to allow decryption of the encrypted image at least partly based on the privacy beacon data. For example, FIG. 11, e.g., FIG. 11B, shows transmission of the encrypted image and privacy beacon data associated with the privacy beacon to a location configured to determine whether to allow decryption of the encrypted image facilitating module 1128 facilitating transmission of the encrypted image (e.g., an image of a fitness expert running in the park) and privacy beacon data (e.g., data indicating whether the privacy beacon was detected) associated with the privacy beacon (e.g., a marker mounted on a drone that maintains a particular proximity to the person) to a location (e.g., a remote server, e.g., server 4000 as shown in FIG. 1) configured to determine whether to allow decryption of the encrypted image (e.g., the image of the fitness expert running in the park) at least partly based on the privacy beacon data (e.g., the data indicating whether the privacy beacon was detected).

Referring again to FIG. 16B, operation 1628 may include operation 1630 depicting facilitating transmission of the encrypted image and privacy beacon data associated with the privacy beacon to a location configured to do a profitability evaluation of an allowance of decryption of the encrypted image at least partly based on the privacy beacon data. For example, FIG. 11, e.g., FIG. 11B, shows transmission of the encrypted image and privacy beacon data associated with the privacy beacon to a location configured to perform a profitability simulation regarding potential decryption and release of the encrypted image data at least partly based on the privacy beacon data facilitating module 1130 facilitating transmission of the encrypted image (e.g., an image of three friends sharing a round of shots at the bar that is taken by the bartender surreptitiously through use of a wearable computer for use as evidence in case one of the three friends gets into a car accident on the way home) and privacy beacon data (e.g., metadata indicating that the privacy beacon was found and identifying the privacy beacon) associated with the privacy beacon (e.g., a marker that emits a particular thermal signature) to a location (e.g., a server, e.g., server 4000 of FIG. 1) configured to do a profitability evaluation (e.g., an evaluation of how much advertising and web site traffic revenue might be driven through use of this image, versus what potential damages might be incurred by releasing the image) of an allowance of decryption of the encrypted image (e.g., an image of three friends sharing a round of shots at the bar that is taken by the bartender surreptitiously through use of a wearable computer for use as evidence in case one of the three friends gets into a car accident on the way home) at least partly based on the privacy beacon data (e.g., metadata indicating that the privacy beacon was found and identifying the privacy beacon).

Referring again to FIG. 16B, operation 1208 may include operation 1632 depicting acquiring privacy beacon data that identifies the privacy beacon. For example, FIG. 11, e.g., FIG. 11B, shows privacy beacon data configured to identify the privacy beacon acquiring module 1132 acquiring privacy beacon data (e.g., a privacy beacon identifier, e.g., “privacy beacon TK-421”) that identifies the privacy beacon (e.g., a marker that reflects light in a nonvisible spectrum).

Referring again to FIG. 16B, operation 1208 may include operation 1634 depicting transmitting the privacy beacon data to a location configured to store term data associated with release of an image of the at least one entity. For example, FIG. 11, e.g., FIG. 11B, shows privacy beacon data transmitting to a location configured to store term data associated with a release of image data containing the representation of at least one entity 1134 transmitting the privacy beacon data (e.g., the privacy beacon identifier, e.g., “privacy beacon TK-421”) to a location (e.g., a terms of service management server operated by the entity that provides the privacy beacons, which is recognized by the capturing device by the format of the beacon, e.g., “TK” identifies the server, and “421” the user) configured to store term data (e.g., a terms of service associated with the user whose image was captured along with the privacy beacon, e.g., an exemplary terms of service is outlined above with respect to FIG. 1) associated with release (e.g., decryption and freedom to access to the capturing device) of an image of the at least one entity (e.g., a picture of three friends with a celebrity).

Referring again to FIG. 16B, operation 1208 may include operation 1636 depicting receiving term data associated with the release of the image of the at least one entity. For example, FIG. 11, e.g., FIG. 11B, shows term data associated with a release of image data containing the representation of at least one entity receiving module 1136 receiving term data (e.g., the terms of service associated with the user whose image was captured along with the privacy beacon, e.g., an exemplary terms of service is outlined above with respect to FIG. 1) associated with release (e.g., decryption and freedom to access to the capturing device) of the image of the at least one entity (e.g., a picture of three friends with a celebrity).

Referring again to FIG. 16B, operation 1208 may include operation 1638 depicting facilitating transmission of the term data and the encrypted image to the location configured to perform one or more processes on one or more of the encrypted image and the privacy beacon data. For example, FIG. 11, e.g., FIG. 11B, shows term data associated with the release of image data transmission to the location configured to perform one or more processes on one or more of the encrypted image and the privacy beacon data facilitating module 1138 facilitating transmission of the term data (e.g., the terms of service associated with the user whose image was captured along with the privacy beacon, e.g., an exemplary terms of service is outlined above with respect to FIG. 1) and the encrypted image (e.g., image data corresponding to the picture of three friends with a celebrity) to the location configured to perform one or more processes (e.g., verification of the people in the picture, and a potential damages analysis of releasing the picture) on one or more of the encrypted image (e.g., the image data corresponding to the picture of three friends with the celebrity) and the privacy beacon data (e.g., the full terms of service that were retrieved by the device and now transmitted to the location configured to perform the verification and potential damages analysis).

Referring now to FIG. 16C, operation 1208 may include operation 1640 depicting processing the privacy beacon data to generate term data associated with release of an image of the at least one entity. For example, FIG. 11, e.g., FIG. 11C, shows privacy beacon data processing to generate term data associated with release of the image that includes at least one representation of the feature of the at least one entity module 1140 processing the privacy beacon data (e.g., data identifying a type of the privacy beacon, e.g., “a user worth over $1 million,” “a movie star,” or “a guy who paid ten bucks for this service,”) to generate term data (e.g., pre-existing term data stored on the device that corresponds to different types of beacons and which type should be used) associated with release of an image of the at least one entity (e.g., the person whose image was taken).

Referring again to FIG. 16C, operation 1208 may include operation 1642 depicting transmitting the encrypted image and the generated term data to a location configured to perform one or more processes on one or more of the encrypted image and the privacy beacon data. For example, FIG. 11, e.g., FIG. 11C, shows transmission of the encrypted image and the generated term data to the location configured to perform one or more processes on one or more of the encrypted image and the privacy beacon data facilitating module 1142 transmitting the encrypted image and the generated term data to a location configured to perform one or more processes on one or more of the encrypted image (e.g., a picture of a drunken guy walking out of a bar and getting into a vehicle) and the privacy beacon data (e.g., e.g., data identifying a type of the privacy beacon, e.g., “a user worth over $1 million,” “a movie star,” or “a guy who paid ten bucks for this service”).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.)

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
acquiring an image, wherein said image includes at least one representation of a feature of at least one entity;
detecting a presence of a privacy beacon in the acquired image, wherein further image process operation on image data unrelated to detection of the presence of the privacy beacon is avoided prior to encryption of the acquired image data, said privacy beacon associated with the at least one entity;
encrypting the acquired image, through use of a unique device encryption key that is unique to a particular device; and
facilitating transmission of the encrypted image and privacy beacon data associated with the privacy beacon to a location configured to perform one or more processes on one or more of the encrypted image and the privacy beacon data.

2. (canceled)

3. (canceled)

4. (canceled)

5. (canceled)

6. (canceled)

7. (canceled)

8. The computationally-implemented method of claim 1, wherein said acquiring an image, wherein said image includes at least one representation of a feature of at least one entity comprises:
capturing an image through use of a wearable computer, wherein said image includes at least one representation of the feature of at least one entity.

9. The computationally-implemented method of claim 1, wherein said acquiring an image, wherein said image includes at least one representation of a feature of at least one entity comprises:
capturing the image through use of a wearable computer, wherein said image includes at least one representation of the feature of at least one entity, and wherein the image is captured without knowledge of the at least one entity.

10. The computationally-implemented method of claim 1, wherein said acquiring an image, wherein said image includes at least one representation of a feature of at least one entity comprises:
acquiring an image that includes text, wherein said image includes one or more words that are a feature of the text.

11. The computationally-implemented method of claim 1, wherein said acquiring an image, wherein said image includes at least one representation of a feature of at least one entity comprises:
receiving optical data that contains an image, wherein said image includes at least one representation of a feature of at least one entity.

12. (canceled)

13. (canceled)

14. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
detecting a presence of a detectable marker associated with the at least one entity in the acquired image, wherein further image process operation on image data unrelated to detection of the presence of the detectable marker is avoided prior to encryption of the acquired image data.

15. The computationally-implemented method of claim 14, wherein said detecting a presence of a detectable marker associated with the at least one entity in the acquired image, wherein further image process operation on image data unrelated to detection of the presence of the detectable marker is avoided prior to encryption of the acquired image data comprises:
detecting a presence of an optically-detectable marker associated with the at least one entity in the acquired image, wherein further image process operation on image data unrelated to detection of the presence of the optically-detectable marker is avoided prior to encryption of the acquired image data.

16. (canceled)

17. (canceled)

18. (canceled)

19. (canceled)

20. (canceled)

21. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
performing one or more image process operations on the acquired image to detect the presence of the privacy beacon associated with the at least one entity in the acquired image; and
preventing one or more image process operations that are unrelated to the detection of the presence of the privacy beacon associated with the at least one entity in the acquired image until the acquired image data is encrypted.

22. The computationally-implemented method of claim 21, wherein said preventing one or more image process operations that are unrelated to the detection of the presence of the privacy beacon associated with the at least one entity in the acquired image until the acquired image data is encrypted comprises:
denying access to one or more image process operations that are unrelated to the detection of the presence of the privacy beacon associated with the at least one entity in the acquired image.

23. (canceled)

24. (canceled)

25. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
detecting the presence of the privacy beacon associated with the at least one entity in the acquired image without storing the acquired image in a memory that is accessible to one or more processes that are unrelated to the detection of the presence of the privacy beacon.

26. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
performing one or more image process operations on the acquired image to detect the presence of the privacy beacon associated with the at least one entity in the acquired image; and
executing said encrypting the acquired image step immediately after execution of the one or more image process operations on the acquired image to detect the presence of the privacy beacon.

27. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
transmitting the acquired image data to a dedicated component configured to detect the presence of the privacy beacon associated with the at least one entity in the acquired image; and
preventing access to the acquired image data in unencrypted format.

28. (canceled)

29. The computationally-implemented method of claim 27, wherein said transmitting the acquired image data to a dedicated component configured to detect the presence of the privacy beacon associated with the at least one entity in the acquired image comprises:
transmitting the acquired image data to a dedicated component configured to detect the presence of the privacy beacon associated with the at least one entity in the acquired image;
generating a binary response regarding whether the privacy beacon is present in the acquired image data; and
destroying the transmitted image data at the dedicated component.

30. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
converting captured light data into digital image data;
performing one or more digital image processes on the digital image data to detect the presence of the privacy beacon in the acquired image data; and
preventing access to one or more other modules of an image capture device until the acquired image data is encrypted.

31. The computationally-implemented method of claim 30, wherein said performing one or more digital image processes on the digital image data to detect the presence of the privacy beacon in the acquired image data comprises:
performing one or more digital image processes to generate a binary result in regard to a presence of the privacy beacon associated with the at least one entity in the acquired image; and
deleting the unencrypted image data used to perform the one or more digital image processes to generate the binary result in response to notification that the image data has been encrypted.

32. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
splitting the acquired image data into first optical image data and second optical image data through use of an optical splitter;
detecting a privacy beacon in the first optical image data through an optical image process; and
converting the second optical image data into digital image data.

33. (canceled)

34. (canceled)

35. The computationally-implemented method of claim 32, wherein said detecting a privacy beacon in the first optical image data through an optical image process comprises:
applying at least one filter to the optical image data, said filter configured to filter for one or more privacy beacons; and
detecting the privacy beacon in the filtered optical image data.

36. The computationally-implemented method of claim 32, wherein said converting the second optical image data into digital image data comprises:
converting the second optical image data into digital image data upon receipt of the second optical image data; and
transferring the digital image data for encryption without performance of a process on the digital image data prior to encryption.

37. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
detecting the presence of the privacy beacon in acquired optical image data, wherein further image process operation on the optical image data unrelated to detection of the presence of the privacy beacon is avoided prior to conversion of the optical image data into digital image data for encryption.

38. The computationally-implemented method of claim 1, wherein said detecting a presence of a privacy beacon in the acquired image, wherein further image process operation on image data unrelated to detection of the presence of the privacy beacon is avoided prior to encryption of the acquired image data, said privacy beacon associated with the at least one entity comprises:
receiving acquired optical image data; and
performing one or more optical operations on the optical image data to detect the privacy beacon in the acquired optical image data.

39. The computationally-implemented method of claim 38, wherein said performing one or more optical operations on the optical image data to detect the privacy beacon in the acquired optical image data comprises:
performing a wave transformation on the optical image data through use of an optical component; and
performing at least one optical correlation with the transformed optical image data and a reference data.

40. The computationally-implemented method of claim 38, wherein said performing one or more optical operations on the optical image data to detect the privacy beacon in the acquired optical image data comprises:
performing at least one transformation on the optical image data;
executing at least one optical correlation with the transformed optical image data and a reference data; and
generating a binary result with regard to a presence of the privacy beacon based on the executed at least one optical correlation.

41. The computationally-implemented method of claim 38, wherein said performing one or more optical operations on the optical image data to detect the privacy beacon in the acquired optical image data comprises:
generating a binary result with regard to a presence of the privacy beacon based on one or more optical operations performed on the optical image data; and
transmitting the optical image data to an optical-to-digital converter configured to convert the optical image data to digital image data.

42. (canceled)

43. (canceled)

44. (canceled)

45. (canceled)

46. The computationally-implemented method of claim 1, wherein said encrypting the acquired image, through use of a unique device encryption key that is unique to a particular device comprises:
encrypting the acquired image data, through use of a unique device encryption key that is stored on a permanent memory of the particular device.

47. The computationally-implemented method of claim 1, wherein said encrypting the acquired image, through use of a unique device encryption key that is unique to a particular device comprises:
retrieving the unique device encryption key that is unique to the particular device; and
encrypting the acquired image through use of the unique device encryption key.

48. (canceled)

49. (canceled)

50. (canceled)

51. The computationally-implemented method of claim 1, wherein said encrypting the acquired image, through use of a unique device encryption key that is unique to a particular device comprises:
generating the unique device encryption key that is unique to the particular device; and
encrypting the acquired image through use of the generated unique device encryption key.

52. The computationally-implemented method of claim 51, wherein said generating the unique device encryption key that is unique to the particular device comprises:
generating the unique device encryption key at least partly based on a unique device identifier.

53. (canceled)

54. (canceled)

55. (canceled)

56. The computationally-implemented method of claim 1, wherein said encrypting the acquired image, through use of a unique device encryption key that is unique to a particular device comprises:
receiving the acquired image data directly after the privacy beacon detection; and
encrypting the directly received image, through use of the unique device encryption key that is unique to the particular device.

57. The computationally-implemented method of claim 1, wherein said encrypting the acquired image, through use of a unique device encryption key that is unique to a particular device comprises:
receiving the acquired image data directly from an image capturing component; and
encrypting the received acquired image, through use of the unique device encryption key that is unique to the particular device.

58. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
transmitting the encrypted image and the privacy beacon data associated with the privacy beacon to a location configured to perform one or more processes on one or more of the encrypted image and the privacy beacon data.

59. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
transmitting the encrypted image to the location configured to perform one or more processes; and
transmitting the privacy beacon data associated with the privacy beacon to the location configured to perform one or more processes.

60. The computationally-implemented method of claim 59, wherein said transmitting the privacy beacon data associated with the privacy beacon to the location configured to perform one or more processes comprises:
acquiring data that corresponds to a detection of the privacy beacon; and
transmitting the data that corresponds to the detection of the privacy beacon.

61. The computationally-implemented method of claim 60, wherein said acquiring data that corresponds to a detection of the privacy beacon comprises:
acquiring binary data that corresponds to a detection of the privacy beacon.

62. The computationally-implemented method of claim 60, wherein said acquiring data that corresponds to a detection of the privacy beacon comprises:
acquiring data that indicates a presence of the privacy beacon; and
performing analysis on the acquired image data to determine an identifier associated with the privacy beacon.

63. The computationally-implemented method of claim 60, wherein said acquiring data that corresponds to a detection of the privacy beacon comprises:
acquiring data that identifies the privacy beacon.

64. (canceled)

65. (canceled)

66. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
encoding privacy metadata based on the privacy beacon into the encrypted image; and
transmitting the encrypted image that includes the privacy metadata to the location configured to perform processing on the encrypted image.

67. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
facilitating transmission of the encrypted image and privacy beacon data associated with the privacy beacon to a location configured to determine whether to allow decryption of the encrypted image at least partly based on the privacy beacon data.

68. (canceled)

69. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
acquiring privacy beacon data that identifies the privacy beacon;
transmitting the privacy beacon data to a location configured to store term data associated with release of an image of the at least one entity;
receiving term data associated with the release of the image of the at least one entity; and
facilitating transmission of the term data and the encrypted image to the location configured to perform one or more processes on one or more of the encrypted image and the privacy beacon data.

70. The computationally-implemented method of claim 1, wherein said facilitating transmission of the encrypted image and privacy beacon data associated with the privacy beacon to a location configured to perform one or more processes on one or more of the encrypted image and the privacy beacon data comprises:
processing the privacy beacon data to generate term data associated with release of an image of the at least one entity; and
transmitting the encrypted image and the generated term data to a location configured to perform one or more processes on one or more of the encrypted image and the privacy beacon data.

71. (canceled)

72. A computationally-implemented system, comprising
circuitry for acquiring an image, wherein said image includes at least one representation of a feature of at least one entity;
circuitry for detecting a presence of a privacy beacon in the acquired image, wherein further image process operation on image data unrelated to detection of the presence of the privacy beacon is avoided prior to encryption of the acquired image data, said privacy beacon associated with the at least one entity;
circuitry for encrypting the acquired image, through use of a unique device encryption key that is unique to a particular device; and
circuitry for facilitating transmission of the encrypted image and privacy beacon data associated with the privacy beacon to a location configured to perform one or more processes on one or more of the encrypted image and the privacy beacon data.

73-143. (canceled)
